(19) United States
(12) Patent Application Publication
(10) Pub. No.: US 2026/0141027 A1
(43) Pub. Date: May 21, 2026

(54) HOSTING AND MINING PROGRAMMATIC AND NON-PROGRAMMATIC DATA PIPELINES

(71) Applicant: StackAdapt Inc., Toronto (CA)

(72) Inventors: Afish MAHESANIYA, Toronto (CA); Yang HAN, Toronto (CA); Tim LIU, Toronto (CA)

(73) Assignee: StackAdapt Inc., Toronto (CA)

(21) Appl. No.: 19/394,246

(22) Filed: Nov. 19, 2025

Related U.S. Application Data
(60) Provisional application No. 63/722,818, filed on Nov. 20, 2024.

(51) Int. Cl. G06F 18/2113; G06F 18/213; G06F 18/22; G06F 40/30

(52) U.S. Cl. CPC G06F 18/2113; G06F 18/213; G06F 18/22; G06F 40/30

(57) ABSTRACT

Systems and methods are described herein for determining identifying features across messages communicated in a network. In examples, a system can be configured to receive first activity data associated with a first set of messages involving a first channel and extract feature vectors for each message. The system can receive second activity data associated with a second set of messages associated with a second channel, extract feature vectors for each message of the second set of messages, and compare a first feature vector from the first set of feature vectors with a second feature vector from the second set of feature vectors. A correlation value can be determined based on the comparison of the first feature vector with the second feature vector and the system can provide display data to the first device or the second device based on the correlation value satisfying a device or user correlation threshold.

### CROSS-REFERENCE TO RELATED APPLICATION

This application claims priority to and the benefit of U.S. Provisional Application No. 63/722,818, entitled “Hosting and Mining Programmatic and Non-Programmatic Data Pipelines,” filed Nov. 20, 2024, which is incorporated by reference in its entirety.

### TECHNICAL FIELD

This application relates generally to systems and methods for determining identifying features across messages communicated in a network, and more specifically, to determining identifying features based on network activity.

### BACKGROUND

Devices that monitor network traffic (monitoring devices) can analyze messages passed across a network and assign identifiers to each message. These identifiers can be assigned based on the monitoring device identifying similarities within the contents of the messages or similarities in the origin and destination of the messages, and determining that subsets of the messages correspond to a group of devices. But it can be difficult for monitoring devices to correlate devices within the group of devices with unique user identifiers. For example, the monitoring device can determine that devices connected to, and exchanging messages from, a home network or public network are associated with multiple unique user identifiers but can experience difficulty when attempting to determine correlations between the network activity of specific devices and unique user identifiers. This can, in turn, make it difficult implement one or more additional operation such as identifying network traffic that correspond to activity involving specific users when, for example, filtering for network activity involving users that can be involved in cybersecurity incidents.

### SUMMARY

In view of the above-noted challenges posed when monitoring network traffic, there is a desire for systems and methods that are capable of determining identifying features across messages communicated in a network, such as a signal from a non-programmatic channel for a user and a signal from a programmatic channel for that same user.

Embodiments described herein may relate to a system for programmatic and non-programmatic communication that may include one or more processors that may be configured to: receive first activity data associated with a first set of messages communicated by a first device via a first channel, and second activity data associated with a second set of messages communicated by a second device via a second channel, wherein the first channel represents a programmatic channel and the second channel represents a non-programmatic channel; extract a first set of feature vectors for each message of the first set of messages based on one or more first attributes of each message; extract a second set of feature vectors for each message of the second set of messages based on one or more second attributes of each message, the one or more second attributes including a user identifier associated with each message of the second set of messages; generate a correlation value based upon comparing a first feature vector from the first set of feature vectors with a second feature vector from the second set of feature vectors, the correlation value indicating a probability that a first message corresponding to the first feature vector is associated with a second message corresponding to the second feature vector; and generate and transmit display data for display via a graphical user interface (GUI) of at least one of the first device or the second device based on the correlation value satisfying a user correlation threshold.

In some aspects, the one or more processors may be further configured to: determine that the correlation value satisfies the user correlation threshold. The user correlation threshold indicates that the first device and the second device are associated with a user corresponding to the user identifier.

In some aspects, messages communicated over at least one of the first channel or the second channel includes identifying information associated with a user.

In some aspects, the one or more processors may be configured to receive the first activity data during a first period of time. The one or more processors may be configured to receive the second activity data during a second period of time.

In some aspects, the one or more processors may be further configured to determine that the first message was transmitted by the first device before the second message was transmitted by the second device. The one or more processors may be configured to compare the first feature vector with the second feature vector in response to determining that the first message was transmitted by the first device before the second message was transmitted by the second device.

In some aspects, when comparing the first feature vector to the second feature vector, the one or more processors may be configured to: determine one or more correlations between the first message and the second message based upon comparing a first set of first feature values of the first feature vector with a second set of second feature values of the second feature vector; and determine at least one match between the first set of first feature values and the second set of second feature values.

In some aspects, the one or more processors may be further configured to determine a context for the first message based on the one or more first attributes of the first message; and generate the display data for the GUI based on the context for the first message.

Embodiments described herein may relate to a computer-implemented method for programmatic and non-programmatic communication that may include: receiving, by one or more processors, first activity data associated with a first set of messages communicated by a first device via a first channel, and second activity data associated with a second set of messages communicated by a second device via a second channel, wherein the first channel represents a programmatic channel and the second channel represents a non-programmatic channel; extracting, by the one or more processors, a first set of feature vectors for each message of the first set of messages based on one or more first attributes of each message; extracting, by the one or more processors, a second set of feature vectors for each message of the second set of messages based on one or more second attributes of each message, the one or more second attributes including a user identifier associated with each message of the second set of messages; generating, by the one or more processors, a correlation value based upon comparing a first feature vector from the first set of feature vectors with a second feature vector from the second set of feature vectors, the correlation value indicating a probability that a first message corresponding to the first feature vector is associated with a second message corresponding to the second feature vector; and generating and transmitting, by the one or more processors, display data for display via a graphical user interface (GUI) of at least one of the first device or the second device based on the correlation value satisfying a user correlation threshold.

In some aspects, the computer-implemented method may include determining that the correlation value satisfies the user correlation threshold. The user correlation threshold indicates that the first device and the second device are associated with a user corresponding to the user identifier.

In some aspects, messages communicated over the first channel or the second channel includes identifying information associated with a user.

In some aspects, the one or more processors may receive the first activity data during a first period of time, and may receive the second activity data during a second period of time.

In some aspects, the computer-implemented method may include: determining, by the one or more processors, that the first message was transmitted by the first device before the second message was transmitted by the second device. The one or more processors may compare the first feature vector with the second feature vector in response to the one or more processors determining that the first message was transmitted before the second message.

In some aspects, comparing the first feature vector to the second feature vector includes: determining, by the one or more processors, one or more correlations between the first message and the second message based upon a first set of first feature values of the first feature vector with a second set of second feature values of the second feature vector; and determining, by the one or more processors, at least one match between the first set of first feature values and the second set of second feature values.

In some aspects, the computer-implemented method may include: determining, by the one or more processors, a context for the first message based on the one or more first attributes of the first message; and generating, by the one or more processors, the display data for the GUI based on the context for the first message.

Embodiments described herein may relate to a non-transitory, computer-readable medium storing instructions thereon for programmatic and non-programmatic communication that, when executed by one or more processors, cause the one or more processors to: receive first activity data associated with a first set of messages communicated by a first device via a first channel, wherein the first channel represents a programmatic channel and the second channel represents a non-programmatic channel, and second activity data associated with a second set of messages communicated by a second device via a second channel; extract a first set of feature vectors for each message of the first set of messages based on one or more first attributes of each message; extract a second set of feature vectors for each message of the second set of messages based on one or more second attributes of each message, the one or more second attributes including a user identifier associated with each message of the second set of messages; generate a correlation value based upon comparing a first feature vector from the first set of feature vectors with a second feature vector from the second set of feature vectors, the correlation value indicating a probability that a first message corresponding to the first feature vector is associated with a second message corresponding to the second feature vector; and generate and transmit display data for display via a graphical user interface (GUI) of at least one of the first device or the second device based on the correlation value satisfying a user correlation threshold.

In some aspects, the instructions further cause the one or more processors to determine that the correlation value satisfies the user correlation threshold. The user correlation threshold indicates that the first device and the second device are associated with a user corresponding to the user identifier.

In some aspects, messages communicated over the first channel or the second channel include identifying information associated with a user.

In some aspects, the instructions cause the one or more processors to receive the first activity data during a first period of time, and receive the second activity data during a second period of time.

In some aspects, the instructions further cause the one or more processors to: determine that the first message was transmitted by the first device before the second message was transmitted by the second device. The one or more processors compare the first feature vector with the second feature vector in response to determining that the first message was transmitted before the second message.

In some aspects, the instructions cause the one or more processors to: determine one or more correlations between the first message and the second message based upon comparing a first set of first feature values of the first feature vector with a second set of second feature values of the second feature vector; and determine at least one match between the first set of first feature values and the second set of second feature values.

Embodiments may include a computer-implemented method for user-state orchestration based on event triggers, the method including: receiving, by a computer, event data of an event from a source system, the event data indicating one or more transition conditions; parsing, by the computer, the event data to extract contextual metadata including a user identifier, an event type, and a timestamp; applying, by the computer, a rule set to the contextual metadata of the event data by comparing one or more values of the contextual metadata against one or more condition threshold values indicated in the rule set to determine whether the event satisfies a transition condition for transitioning a record associated with the user identifier to a target state; generating, by the computer, a matched condition result for the event indicating the user identifier of the contextual metadata and at least one value of the one or more values of the contextual metadata that satisfies the transition condition defined in the rule set; identifying, by the computer, the target state by selecting a state definition from a plurality of state definitions associated with the at least one value indicated by the matched condition result as satisfying the transition condition; and transitioning, by the computer, the record from a first state to the target state; and executing, by the computer, one or more operations associated with the target state using the record associated with the user identifier.

In some aspects, the techniques described herein relate to a method, wherein the event includes a data upload, an enrichment operation, or a signal received from a third-party integration.

In some aspects, the techniques described herein relate to a method, wherein the target state is determined based on a rule set including a conditional operator, a data source identifier, and a comparison value.

In some aspects, the techniques described herein relate to a method, wherein the first state is a seed state, and wherein transitioning the record includes promoting the record from the seed state to the target state based on a matched condition.

In some aspects, the techniques described herein relate to a method, wherein initiating the one or more operations includes sending a message via a programmatic channel or a non-programmatic channel.

In some aspects, the techniques described herein relate to a method, wherein an orchestration engine of the computer applies a frequency control logic for excluding a redundant entry into the target state.

In some aspects, the techniques described herein relate to a method, wherein an orchestration engine of the computer executes a conditional branching based on event metadata received from a source pod.

In some aspects, the techniques described herein relate to a method, wherein the event includes a user data upload containing job title attributes.

In some aspects, the techniques described herein relate to a method, wherein the computer references an uploaded attribute to determine a condition for transitioning the record to the target state.

In some aspects, the techniques described herein relate to a method, wherein an orchestration engine of the computer executes an event-triggering operation for detecting an event-trigger based on an enrichment event received from a data enrichment service device.

In some aspects, the techniques described herein relate to a method, wherein an orchestration engine of the computer executes an event-triggering operation for detecting an event-trigger based on one or more external signals received from a contextual signal source device.

In some aspects, the techniques described herein relate to a method, wherein an orchestration engine of the computer executes an event-triggering operation for at least one of a programmatic delivery channel or a non-programmatic delivery channel.

Embodiments may include a computer-implemented method for generating personalized composite records for cross-source events using behavioral events and structured catalog data, the method including: receiving, by a computer, a behavioral event from a third-party computing device via one or more networks; retrieving, by the computer, a structured entity record from a catalog database; evaluating, by the computer, one or more matching rules between the behavioral event and the structured entity record; and generating, by the computer, a composite record including the behavioral event and the structured entity record.

In some aspects, the techniques described herein relate to a method, wherein the behavioral event includes a product view, a cart addition, or a purchase action received via a pixel integration.

In some aspects, the techniques described herein relate to a method, wherein the structured entity record includes a product identifier, a product image URL, and a product category.

In some aspects, the techniques described herein relate to a method, wherein evaluating the matching rules includes applying a rule engine configured to correlate event attributes with catalog metadata.

In some aspects, the techniques described herein relate to a method, wherein the composite record includes a timestamp, a user identifier, and a reference to the matched entity.

In some aspects, the techniques described herein relate to a method, wherein the catalog database supports schema-less storage of product attributes in a key-value format.

In some aspects, the techniques described herein relate to a method, wherein the composite record is used to generate a personalized recommendation for a user.

In some aspects, the techniques described herein relate to a method, wherein the behavioral event is received from a pixel-based integration with an ecommerce platform.

In some aspects, the techniques described herein relate to a method, wherein the structured entity record includes a product catalog entry retrieved from a remote feed.

In some aspects, the techniques described herein relate to a method, wherein the computer executes a catalog joining operation using a schema-less mapping of product attributes.

In some aspects, the techniques described herein relate to a method, wherein the catalog includes non-product entities including course catalogs or service listings.

In some aspects, the techniques described herein relate to a method, wherein the composite record is used to identify trending entities based on real-time behavioral signals.

Embodiments may include a computer-implemented method of automating operation orchestration using state transitions, the method including: generating, by a computer, a record associated with a user identifier in a state store, the record being initialized in a seed state and associated with one or more rule groups indicated by a seed state definition of the seed state; determining, by the computer, that the record satisfies a transition condition defined in at a rule group of the seed state definition by comparing one or more values of contextual metadata associated with the record against one or more condition thresholds defined in the rule group; selecting, by the computer, from a plurality of state definitions a next state corresponding to a next state definition including the rule group having the one or more condition thresholds of the transition condition satisfied by the one or more values of the contextual metadata; transitioning, by the computer, the record from the seed state to the next state; and executing, by the computer, the one or more executable operations associated with the next state using the record associated with the user identifier.

In some aspects, the techniques described herein relate to a method, wherein the seed state is defined by at least one rule group including a plurality of conditions associated with user attributes.

In some aspects, the techniques described herein relate to a method, wherein the next state is selected based on a time delay, a matched condition, or a user action.

In some aspects, the techniques described herein relate to a method, wherein executing the one or more operations includes updating a user profile, sending a message, or modifying a segment membership.

In some aspects, the techniques described herein relate to a method, wherein the computer performs a state promotion based on streaming event data from one or more data stream devices hosting one or more data streams.

In some aspects, the techniques described herein relate to a method, wherein an orchestration engine of the computer applies a rule evaluation logic for determining an eligibility for a state transition.

In some aspects, the techniques described herein relate to a method, wherein an orchestration engine of the computer executes a state transition operation for at least one of a programmatic delivery channel or a non-programmatic delivery channel.

In some aspects, the techniques described herein relate to a method, wherein a rule group for a state transition includes one or more conditions referencing tags generated from user activity.

In some aspects, the techniques described herein relate to a method, wherein the computer evaluates a set of compound conditions using cached matched data.

In some aspects, the techniques described herein relate to a method, wherein the computer executes a segment refresh operation based on identifying a set of matched conditions.

In some aspects, the techniques described herein relate to a method, wherein the computer publishes one or more segment membership updates to a segment update stream at a segment update stream device.

In some aspects, the techniques described herein relate to a method, wherein the computer converts one or more segment memberships into one or more programmatic audience definitions.

Embodiments may include a computer-implemented method of enriching user data using linked attributes, the method including: receiving, by a computer, a record including a user identifier; retrieving, by the computer, one or more attributes linked to the user identifier from a third-party data store; evaluating, by the computer, one or more linkage conditions associated with the retrieved attributes; and generating, by the computer, a composite record including the user identifier and the linked attributes, wherein the composite record includes provenance metadata indicating a source system and a retrieval timestamp.

In some aspects, the techniques described herein relate to a method, wherein the user identifier includes an email address, a hashed identifier, or a derived user identifier.

In some aspects, the techniques described herein relate to a method, wherein the linked attributes include a job title, a company name, and a behavioral indicator.

In some aspects, the techniques described herein relate to a method, wherein evaluating the linkage conditions includes applying a recency threshold and a confidence score.

In some aspects, the techniques described herein relate to a method, wherein the composite record is stored in a segment store configured to support TTL-based expiry.

In some aspects, the techniques described herein relate to a method, wherein the computer executes an enrichment operation for generating the composite record asynchronously via a batch pipeline triggered by a data upload.

In some aspects, the techniques described herein relate to a method, wherein the computer executes an enrichment engine supports for linking a plurality of attributes from a plurality of enrichment stores via a common identifier.

In some aspects, the techniques described herein relate to a method, further including storing, by the computer, the composite record in a segment store for use by a personalization engine or audience segmentation engine.

In some aspects, the techniques described herein relate to a method, wherein the computer executes an enrichment operation for generating the composite record in response to a user data upload to a data hub.

In some aspects, the techniques described herein relate to a method, wherein the computer links the user identifier to a UID associated with licensed third-party attributes.

In some aspects, the techniques described herein relate to a method, wherein the linked attributes include a job function, a company name, and a behavioral indicator.

In some aspects, the techniques described herein relate to a method, wherein the computer applies a time-bound linkage rule to determine attribute eligibility for generating the composite record.

In some aspects, the techniques described herein relate to a method, wherein the computer executes an enrichment engine publishes one or more enrichment events to a message queue device.

Embodiments may include a computer-implemented method of generating personalized creatives using user-contextual inputs, the method including: receiving, by a computer executing a personalization engine, a set of contextual inputs including user-specific signals, situational signals, and global signals; evaluating, by the computer, a set of personalization rules to determine whether the contextual inputs satisfy a sufficiency threshold for personalization; generating, by the computer, a personalization label based on the sufficiency threshold; selecting, by the computer, one or more creative components based on the contextual inputs and the personalization label; rendering, by the computer executing a rendering engine, a personalized creative including the selected creative components, wherein the computer executes a fallback logic operation in response to determining that the personalization label is not present; and transmitting, by the computer, the personalized creative to a content delivery system for display via a programmatic or non-programmatic channel, wherein the computer suppresses a bidding operation in response to determining that the personalization label is not present.

In some aspects, the techniques described herein relate to a method, wherein the user-specific signals include a job title, a company name, and a recent product view.

In some aspects, the techniques described herein relate to a method, wherein the situational signals include a weather condition, a time-of-day value, and a geographic location.

In some aspects, the techniques described herein relate to a method, wherein the global signals include a market trend indicator and a campaign performance metric.

In some aspects, the techniques described herein relate to a method, wherein the fallback logic includes selecting a default creative component from a predefined set stored in a creative asset datastore.

In some aspects, the techniques described herein relate to a method, wherein the personalization label is generated by evaluating a rule set including the sufficiency threshold for the set of contextual inputs.

In some aspects, the techniques described herein relate to a method, wherein the delivery interface suppresses the bidding by omitting a bid request when the personalization label is not present.

In some aspects, the techniques described herein relate to a method, further including storing, by the computer, delivery metadata and performance metrics associated with the personalized creative in an analytics datastore.

In some aspects, the techniques described herein relate to a method, wherein the personalization engine applies a rule set including user-specific, situational, and global conditions.

In some aspects, the techniques described herein relate to a method, wherein the global signals include market trend indicators retrieved from external feeds.

In some aspects, the techniques described herein relate to a method, wherein the fallback logic includes suppressing delivery of the personalized creative in response to determining the set of contextual inputs fail to satisfy the sufficiency threshold.

In some aspects, the techniques described herein relate to a method, wherein the delivery interface applies bid suppression logic based on personalization eligibility.

In some aspects, the techniques described herein relate to a method, wherein the personalization engine selects creative components using a machine learning model trained on engagement outcomes.

### BRIEF DESCRIPTION OF THE DRAWINGS

Non-limiting embodiments of the present disclosure are described by way of example with reference to the accompanying figures, which are schematic and are not drawn to scale. Unless indicated as representing the background art, the figures represent aspects of the disclosure.

FIG. 1 illustrates various components of an example environment of a system for determining identifying features across messages communicated in a network, according to an embodiment.

FIG. 2 illustrates a flow diagram of a process executed by an analytics server, according to an embodiment.

FIGS. 3A-3F are a diagram of an implementation of systems and methods involved in determining identifying features across messages communicated in a network, according to an embodiment.

FIG. 4 shows operations and dataflow of a system performing a process for developing and hosting a customer data platform (CDP), according to an embodiment.

FIG. 5A and FIG. 5B show operations and dataflow in processes for orchestrating or managing outbound contact events to end-users via programmatic or non-programmatic contact channels for contact campaigns, according to an embodiment.

FIG. 6 shows operations and dataflow of a system performing operations of a state management engine for orchestrating or managing outbound contact events to end-users via programmatic or non-programmatic contact channels for contact campaigns, according to an embodiment.

FIG. 7 shows a dataflow amongst system components performing a process for hosting and performing operations of an email communications service, according to an embodiment.

FIG. 8 shows operations and dataflow of a system performing a process for an identity service, according to an embodiment.

FIG. 9 shows operations and dataflow of a system performing audience segmenting and audience builder operations, according to an embodiment.

FIGS. 10A-10B show an example computing environment of hardware and software components implementing operations to establish, host, query, and update a CDP, according to an embodiment.

FIG. 11 shows components of a system for user-personalization and data enrichment using state-based operations using state-transition event triggers, according to embodiments.

FIG. 12 shows dataflow amongst components of a system, according to embodiments.

FIG. 13 shows operations of a computer-implemented method for user-state orchestration based on event triggers, according to embodiments.

FIG. 14 shows dataflow amongst components of a system, according to embodiments.

FIG. 15 shows dataflow amongst components of a system performing a feed refresh operation, according to embodiments.

FIG. 16 shows dataflow amongst components of a system performing a feed deletion operation, according to embodiments.

FIG. 17 shows dataflow amongst components of a system performing a feed synchronization operation, according to embodiments.

FIG. 18 is a diagram that shows the operations of a method for the lifecycle of a sync function.

FIG. 19 shows operations of a computer-implemented method for generating personalized composite records for cross-source events using behavioral events and structured catalog data, according to embodiments.

FIG. 20 shows dataflow amongst components of a system, according to embodiments.

FIG. 21 is a diagram that shows internal states of a system for promoting a user between steps of a rule group.

FIG. 22 illustrates a system comprising a modular orchestration architecture for transitioning records between discrete states based on grouped rule conditions and event triggers, according to embodiments.

FIG. 23 shows operations of a computer-implemented method of automating state-based operational orchestration using state transitions, according to embodiments.

FIG. 24 illustrates a system for generating enriched user records by linking attributes from multiple data sources to a user identifier, according to embodiments.

FIG. 25 shows operations of a computer-implemented method for enriching user data using linked attributes, according to embodiments.

FIG. 26 shows dataflow amongst components of a system for combinational personalization of content delivery and dynamic creative optimization (DCO), according to embodiments.

FIG. 27 shows dataflow amongst components of a system for content personalization, according to embodiments.

FIG. 28 shows dataflow amongst components of a system for combinational personalization and dynamic creative optimization (DCO), according to embodiments.

FIG. 29 shows operations of a computer-implemented method of generating personalized creatives using user-contextual inputs, according to embodiments.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein-and additional applications of the principles of the subject matter illustrated herein-that would occur to one skilled in the relevant art and having possession of this disclosure, are to be considered within the scope of the subject matter disclosed herein. Other embodiments can be used and/or other changes can be made without departing from the spirit or scope of the present disclosure. The illustrative embodiments described in the detailed description are not meant to be limiting of the subject matter presented.

Embodiments include computing components for a dynamic landscape of digital contacting end-users and gathering data for end-users, via programmatic contact channels and non-programmatic channels. Computing components for integrating, or benefitting from, the programmatic and non-programmatic contact channels may include a Customer Data Platform (CDP) database of end-user information, audience segmentation or targeting tools, personalization services, contact orchestration software workflows, and an email execution software service. This integration is facilitated using a derived user identifier (DUID) or other form of unified unique identifier, which the system references to facilitate targeted and personalized communication. The orchestration software functions within the computing system architecture facilitates contact campaigns that implement outbound contacts and data-gathering interactions with end-users via programmatic and non-programmatic contact channels. The email execution service enhances user engagement by delivering personalized content based on collected input data (or “signals”), further enriching the data gathered for system customers.

In the present disclosure, systems and methods are disclosed that involve determining identifying features across messages communicated in a network. In some embodiments, systems implementing the techniques described herein can include one or more processors that are configured to receive first activity data associated with a first set of messages involving a first channel; extract feature vectors for each message; receive second activity data associated with a second set of messages associated with a second channel; and extract feature vectors for each message of the second set of messages. The system can be configured to compare a first feature vector from the first set of feature vectors with a second feature vector from the second set of feature vectors to determine a correlation value, and provide display data to the first device or the second device based on the correlation value satisfying a correlation threshold.

By virtue of the implementation of the systems and methods described herein, determinations as to the identity of a user controlling a given device even when identifying information (e.g., user identifiers stored by cookies and/or the like) are unavailable. Further, actions (such as, for example, remedial actions) can be targeted to specific devices as opposed to groups of devices (e.g., behind a router) executed based on the determined identity. This is an improvement over conventional systems and methods that do not allow for correlations between users and specific devices when, for example, device identifiers of such devices are obscured by virtue of communication via network devices such as home or public routers. Further, implementation of the systems and methods described herein can allow for one or more operations to be performed such as identifying network traffic that corresponds to activity involving specific users when, for example, filtering for network activity involving users that can be involved in cybersecurity incidents.

Embodiments may implement universal event-based orchestration triggers, in which computing components are configured to receive event data from heterogeneous sources and initiate orchestration operations based on matched conditions. The orchestration engine supports universal event-based triggering, allowing records to enter orchestration sequences in response to any qualifying event, including data uploads, enrichment operations, and external signals. The system applies rule evaluation logic to determine whether the event satisfies a transition condition and promotes the record to a next state accordingly. This architecture enables extensible, event-driven automation across programmatic and non-programmatic channels without requiring predefined trigger types.

Embodiments may implement cross-source event and entity catalog data-joining, in which computing components are configured to correlate behavioral event data with structured entity metadata to generate composite records. The system receives behavioral signals from external platforms and joins them with catalog records using rule-based logic and schema-less mapping. The resulting composite records may include contextual metadata, entity identifiers, and user identifiers, and may be used for real-time personalization, analytics, and segmentation. This architecture enables dynamic fusion of unstructured behavioral data with structured product catalogs, solving the problem of cross-source correlation.

Embodiments may implement state-based orchestration for state-transitions of data records associated with users using various transition rule sets, in which computing components are configured to transition records between discrete states based on grouped rule conditions and event triggers. The orchestration engine defines a seed state and evaluates rule groups to determine eligibility for promotion to a next state. Each state may include associated actions, conditional branching logic, and frequency control parameters. The system supports fault-tolerant execution, time-based delays, and context propagation across orchestration steps. This architecture enables scalable orchestration across heterogeneous data sources and delivery channels.

Embodiments may implement user data enrichment operations via multi-source attribute fusion, in which computing components are configured to generate enriched user records by linking attributes from multiple data sources to a user identifier. The system receives uploaded data, retrieves enrichment attributes from licensed datasets, and constructs composite profiles using a UID-based linkage pipeline. The enrichment engine applies privacy-compliant logic, including time-bound linkage rules and suppression of sensitive attributes. The resulting profiles may include demographic, behavioral, and contextual metadata, and may be used for personalization, segmentation, and analytics.

Embodiments may implement combinational personalization and dynamic creative optimization (DCO) operations, in which computing components are configured to select and generate personalized creatives based on a combination of contextual signals. The personalization engine receives user-specific, situational, and global signals, evaluates personalization rules, and selects creative components accordingly. The rendering engine resolves creative placeholders using selected content and applies fallback logic when contextual inputs are unavailable. The system supports bid suppression, optimization strategies, and delivery across programmatic and non-programmatic channels. This architecture enables real-time personalization using dynamic contextual inputs.

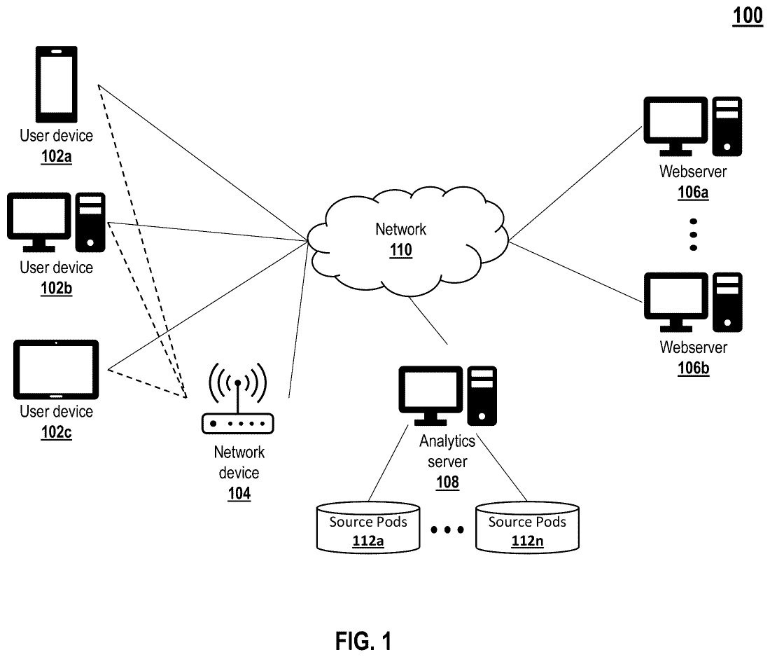

FIG. 1 is a non-limiting example of an environment of a system 100 for determining identifying features across messages communicated in a network. The environment of the system 100 includes user devices 102a-102c (generally referred to as user devices 102), a network device 104, webservers 106a-106n (generally referred to as webservers 106), source pods 112a-112n (generally referred to as source pods 112), an analytics server 108, and a network 110. The analytics server 108 and the webservers 106 can be communicative coupled to the user devices 102 via the network 110 and/or via the network device 104. It will be understood that the environment of the system 100 is not confined to the components described herein and can include additional or other components not shown for brevity, which are to be considered within the scope of the embodiments described herein.

The above-mentioned components can be connected to each other through a network 110. Examples of the network 110 can include, but are not limited to, private or public LAN, WLAN, MAN, WAN, and the Internet. The network 110 can include both wired and wireless communications according to one or more standards and/or via one or more transport mediums. Communication over the network 110 can be performed in accordance with various communication protocols such as Transmission Control Protocol and Internet Protocol (TCP/IP), User Datagram Protocol (UDP), and IEEE communication protocols. In another example, the network 110 can also include communications over a cellular network, including, e.g., a GSM (Global System for Mobile Communications), CDMA (Code Division Multiple Access), and/or EDGE (Enhanced Data for Global Evolution) network.

The user devices 102 can represent any computing device comprising a processor and a non-transitory, machine-readable storage medium capable of cooperating to execute instructions and perform one or more of the operations and processes described herein. Non-limiting examples of user devices 102 include workstation computers, laptop computers, phones, tablet computers, server computers, virtual machines hosted by a computing device, and/or the like. During operation, various users (e.g., individuals engaging with the user devices 102 to navigate to and interact with websites, and/or the like) can use the user devices 102 to access websites hosted by the webservers 106. In some embodiments, the user devices 102 can be operated by one or more types of end-users. For example, the user devices 102 can be operated by individuals, groups of individuals (e.g., employees), and/or the like.

The network device 104 can represent any computing device comprising a processor and a non-transitory, machine-readable storage medium capable of cooperating to execute instructions and perform one or more of the operations and processes described herein. In some embodiments, the network device 104 can be the same as, or similar to, one or more devices of the network 110. For example, the network device 104 can include one or more processors and non-transitory, machine-readable storage mediums that are configured to establish communication between the user devices 102 and devices accessible via the network 110 such as the webservers 106 and/or the analytics server 108.

The webservers 106 can include one or more computing devices comprising a processor and non-transitory, machine-readable storage capable of cooperating to execute instructions and perform one or more of the operations and processes described herein. The webservers 106 can also comprise computing devices such as, for example, servers managing, hosting, or otherwise involved in the operation of a database. For ease of description, FIG. 1 refers to all the components that can be included as webservers 106. In some embodiments, the webservers 106 are associated with an organization that provides one or more goods and/or services via an online marketplace such as, for example, organizations involved in hosting mobile applications, social media platforms, and other online platforms.

Source pods 112 are computing systems configured to generate, evaluate, and transmit condition data and trigger events to analytics server 108. Each source pod 112 may correspond to a distinct data origin, including external platforms, internal services, or third-party integrations. Source pods 112 operate as condition producers within system 100 and may be configured to support both push-based and pull-based condition evaluation workflows.

Each source pod 112 comprises one or more software modules executing on a hardware computing environment. The hardware environment may include a processor, memory, and network interface, and may be implemented using virtual machines, containerized services, or dedicated server infrastructure. The software modules may include a condition evaluation engine, a context enrichment module, and a message dispatch service. The condition evaluation engine applies logical rules to incoming data streams or evaluation requests. The context enrichment module attaches metadata fields required for downstream routing and orchestration. The message dispatch service formats and transmits condition update messages to analytics server 108 or to a shared event stream.

In some embodiments, source pods 112 are configured to evaluate one or more conditions associated with user activity or system events and transmit matched conditions and contextual metadata to analytics server 108. Each source pod 112 may receive event data from devices of the system 100 (e.g., webservers 106) for a corresponding data domain of a web-based or cloud-based service or system, such as ecommerce platforms, email systems, or segment stores, and apply condition evaluation logic to determine whether the event satisfies a predefined rule or threshold.

Source pods 112 may compute or receive a trigger event identifier for each event, which is transmitted to analytics server 108 for deduplication and orchestration routing. The trigger event identifier may be derived from a hash of the event payload or explicitly assigned by the originating system. Contextual metadata associated with the event, such as event_id, cart_id, or workflow_start time, may be included in the transmission to support downstream condition evaluation and branching logic.

Source pods 112 may be configured to operate in a stateless or stateful manner. In stateless configurations, source pods 112 evaluate conditions based solely on the data provided in the evaluation request. In stateful configurations, source pods 112 maintain internal caches or databases to support historical condition evaluation, deduplication, or frequency control. The internal state may be stored in a local key-value store or synchronized with a distributed data layer.

Each source pod 112 may expose a shared API interface that defines a uniform protocol for condition evaluation and event transmission. This interface enables consistent behavior across heterogeneous data domains and simplifies integration with analytics server 108. For example, a source pod 112 configured to evaluate email activity may transmit matched conditions using the same protocol as a source pod 112 configured to evaluate ecommerce events, despite differences in underlying data structures.

In some embodiments, source pods 112 expose an API endpoint that receives evaluation requests from analytics server 108. The API may accept parameters including a condition identifier, user identifier, and contextual attributes. The response may include a matched condition result, a timestamp, and one or more context fields. Alternatively, source pods 112 may publish matched condition messages to a message queue or event stream using a publish-subscribe protocol.

Source pods 112 may be deployed across multiple availability zones or regions to support fault tolerance and low-latency condition evaluation. The system may include a pod registry or service discovery mechanism to route evaluation requests to the appropriate source pod instance based on condition type, data source, or geographic proximity.

In one example, source pods 112 receive condition evaluation requests from a workflow builder and respond with matched conditions and contextual data. For instance, a source pod may receive a request to evaluate whether a user has initiated a checkout event on a commerce platform. The source pod evaluates the condition using dynamic data such as the workflow entry time or event-specific metadata (e.g., order total) and returns a matched condition along with the relevant event identifier. This enables analytics server 108 to perform trigger-split operations and route users through conditional paths based on real-time behavioral signals. Source pods 112 may also provide context fields such as product identifiers or cart IDs, which are retained at the workflow instance level for downstream condition evaluation.

In another example, source pods 112 operate as ingestion endpoints for structured product catalog data. Upon receiving a refresh directive via a notification service (e.g., push-based notification messaging service) and/or a queuing service (e.g., poll-based queue messaging service), a source pod 112 initiates a sync operation to update the products table with the latest feed data. The sync lifecycle is managed through a state machine that schedules, queues, and dispatches sync jobs to workers. Source pods 112 support flexible schema mapping by storing product attributes in a JSON key-value format, allowing the system to accommodate diverse catalog structures across verticals. This enables analytics server 108 to correlate behavioral events with product metadata for real-time personalization and analytics.

In some embodiments, source pods 112 may be implemented as containerized services or microservices deployed within a distributed orchestration platform, such as Kubernetes, Red Hat OpenShift, or similar systems. Each source pod 112 may encapsulate a distinct condition evaluation service, configured to receive event data, evaluate one or more conditions, and transmit matched conditions and contextual metadata to analytics server 108. The use of containerized pods enables horizontal scaling, fault isolation, and modular deployment of condition evaluation logic across heterogeneous data domains. For example, a first source pod 112a may evaluate conditions related to commerce events, while a second source pod 112b may evaluate conditions related to email activity, each operating independently but conforming to a shared API specification.

The analytics server 108 can be any computing device comprising a processor and non-transitory, machine-readable storage capable of cooperating to execute instructions and perform one or more of the operations and processes described herein. The analytics server 108 can comprise computing devices such as, for example, servers managing, hosting, or otherwise involved in the operation of a database, such as a CDP. Non-limiting examples of such computing devices can include workstation computers, laptop computers, server computers, and the like. In some embodiments, the analytics server 108 can be included and/or implemented by one or more of the webservers 106. In some embodiments, the analytics server 108 can be associated with a service provider that processes messages communicated via a network device 104 and/or a network 110.

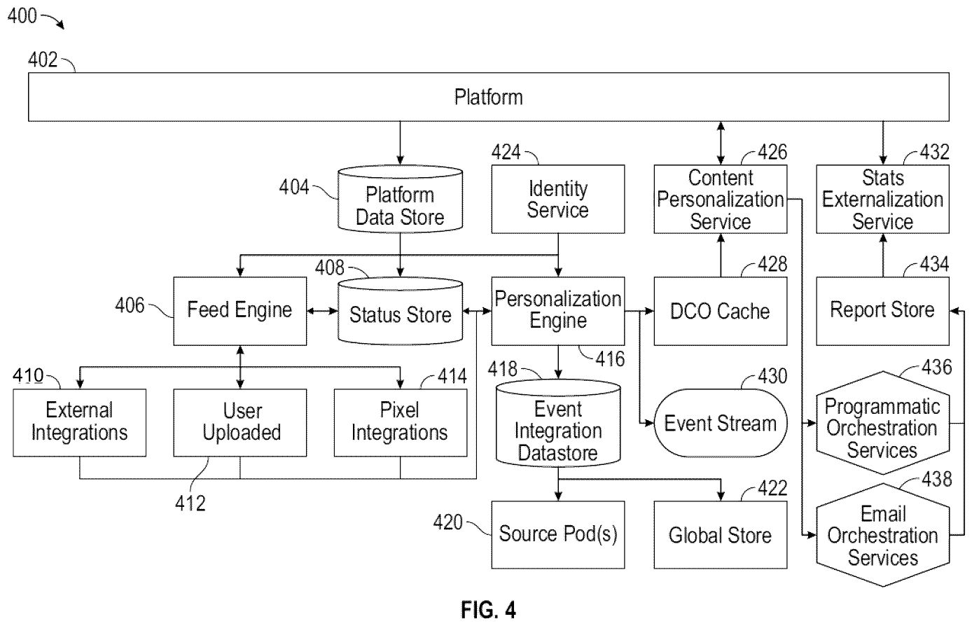

In embodiments, the analytics server 108 includes the database hosting the CDP, which includes hardware and software components of network-accessible database. The CDP may serve as the repository for data essential to downstream applications and services. The CDP may include various types of data points, such as user identifiers or user-related information, event identifiers or event-related identifiers, and entity identifiers or event-related information. FIG. 4 shows operations and dataflow in a system 400 performing functions for developing and hosting the CDP operations.

The user data captures personal information, such as names, email addresses, and other descriptive attributes. Additionally, the CDP aggregates probabilistic insights derived from user actions, including interests in specific brands and estimations of lifetime value.

The event data may complement the user data, documenting the myriad actions users undertake across both programmatic and non-programmatic channels. This encompasses a wide range of interactions, from web-based advertisement or element engagements to website visits, and purchase transactions. Each event is logged with details, such as the actions taken, the associated entity (e.g., product or webpage), and relevant metadata (e.g., timestamps and geolocation information).

The entity data represents non-user-specific data with which users interact, such as products or content items. For instance, if a user views a product, the user is identified, the action of viewing is recorded as an event, and the product itself becomes the entity.

From a storage perspective, the CDP consists of multiple data sources, such as sources applications, services, or pods that are responsible for housing and organizing the data. A source pod, for example, contains multiple services that are responsible for fetching data from external sources, internalizing that data within the context of the source pod, and make this data available to internal computing services of the contact campaign tracking and planning ecosystem. The CDP provides a comprehensive view of user data, capturing personal information, behavioral patterns, and interactions. Embodiments beneficially enable system components to track user activities effectively and help customers of the system to generate actionable insights for personalized contact campaigns for contacting the users.

The analytics server 108 may execute processes for personalization capabilities, which includes software functions for leveraging the vast array of data housed within the CDP. While not confined to any particular channel, personalization heavily relies on CDP data to operate efficiently. Personalization may include Dynamic Creative Optimization (DCO) within the programmatic space, and content personalization for email campaigns. These personalization functions may include, including tailored landing pages and personalized content delivery across various non-programmatic channels.

The personalization operations of the analytics server 108 utilizes user and event data accumulated within the CDP. This data can be accessed directly or combined with a catalog feed, providing dynamic content management and decoupling from specific events to enhance flexibility for diverse use cases. For instance, in the realm of ecommerce websites or services, the catalog houses product data, enabling dynamic fetching and updates to personalize content based on factors such as real-time pricing or inventory levels. The personalization operations beneficially leverage the various types of CDP data, offering a customer-users to enhance end-user engagement across both programmatic and non-programmatic channels.

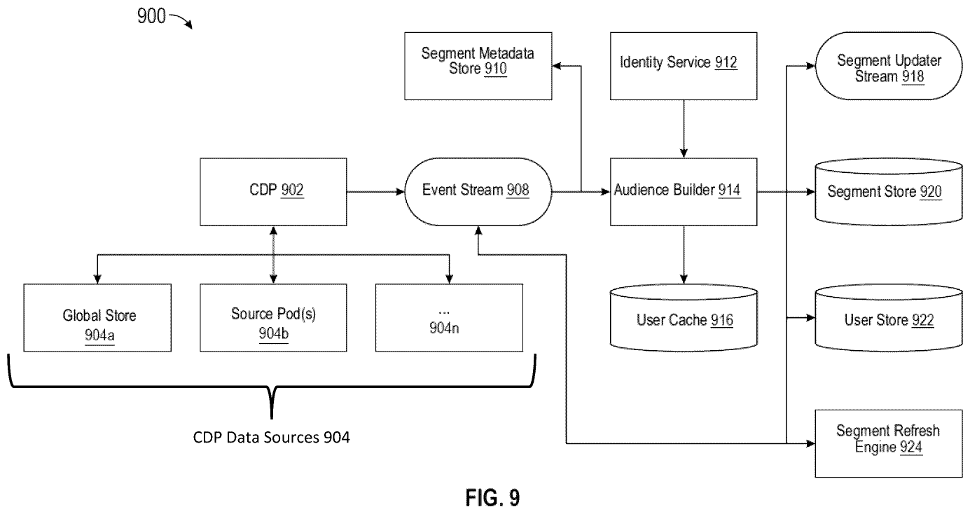

The analytics server 108 may execute audience builder software for generating targeted audiences or audience segmenting. The audience builder software plays a central role in utilizing the data stored within the database of the system 100, such as the CDP. The audience builder offers flexible query capabilities, enabling customer-users (e.g., content campaign administrators, advertisers) to create customized audiences of end-users tailored to specific needs of the customer-user. Th audience builder tool empowers the customer-user to construct complex audience segments of end-users based on various types of data types, parameters, or criteria, including user attributes, event-specific data, and the seamless integration of signals from both programmatic and non-programmatic channels. The audience builder operations may facilitate a comprehensive understanding of audience dynamics (e.g., demographics, interests), providing insights into audience size, attributes, and forecasted performance. This multifaceted functionality equips customer-users (e.g., content campaign administrators, advertisers) with the software tools for audience targeting. An example system 900 executing one or more audience builder operations is shown in FIG. 9.

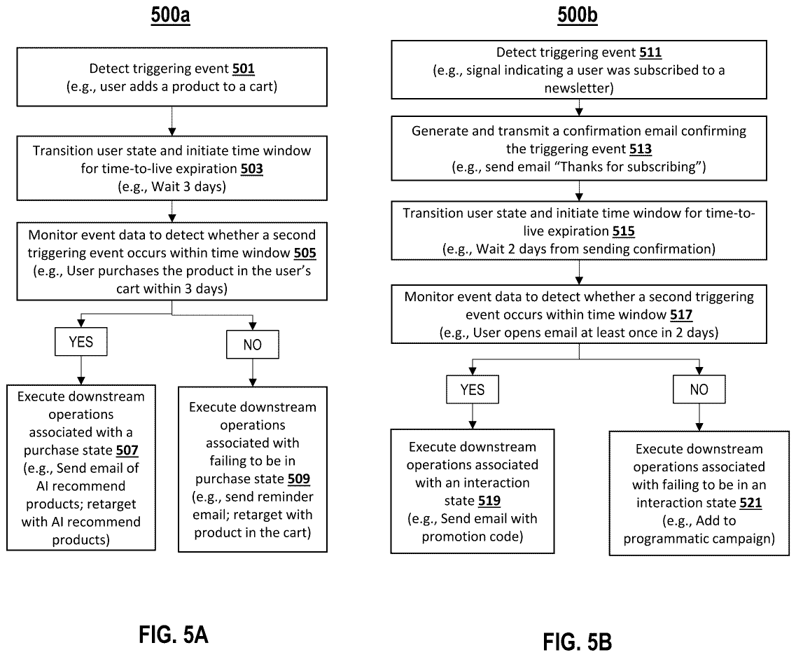

The analytics server 108 may execute software programming for an orchestration workflow service. The orchestration workflow executes software functions for integrating complementary capabilities within non-programmatic contact channels. This orchestration workflow service enables seamless execution across both programmatic and non-programmatic channels within a unified framework, for orchestrating or otherwise managing a user contact campaign. By accessing and interacting with the functions of the orchestration workflow service, a customer-user (e.g., campaign generators, advertisers) may leverage various data sources, including the CDP, audiences crafted via the audience builder, and a variety of programmatic and non-programmatic signals collected by the system 100. This data empowers advertisers to execute sophisticated actions such as email campaigns (non-programmatic execution) and retargeting efforts (programmatic), among others. Additionally, customer-users can manipulate existing entities on the system 100, such as audiences and lists, within the confines of the orchestration workflow. Furthermore, personalization capabilities are seamlessly integrated, enhancing the efficacy of the overall orchestration process. FIGS. 5A-5B show operations and data flow in processes 500a-500b for orchestrating or managing outbound contact events to end-users via programmatic or non-programmatic channels.

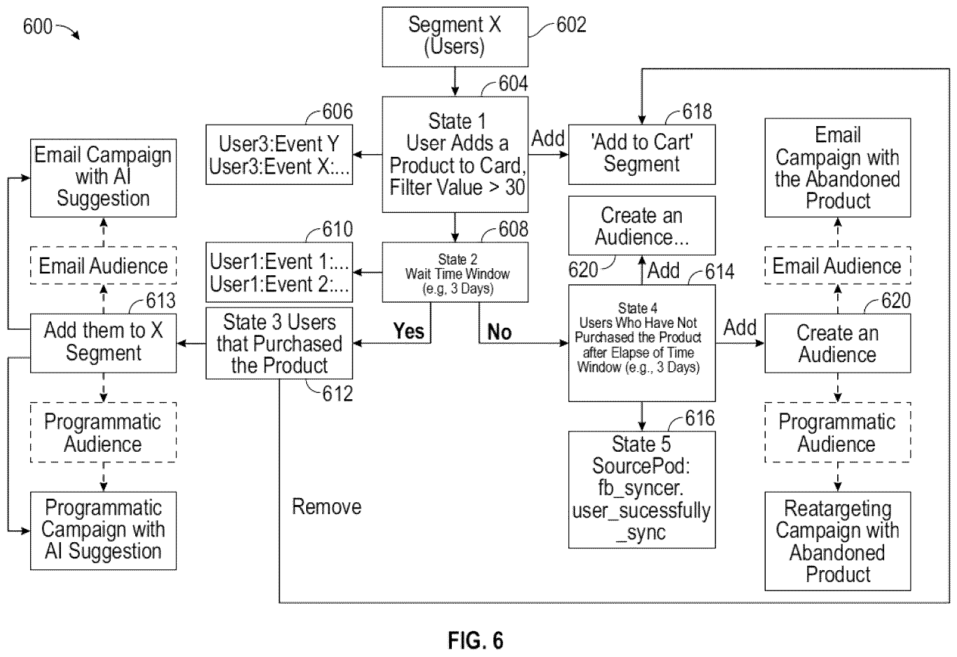

The orchestration workflow service of the analytics server 108 comprises software functions or machine-learning architecture, which may include a state management engine. This new engine, akin to a state machine, operates based on events transitioning through various states. Each state is characterized by qualifying criteria and associated actions triggered when new events progress into the state. The qualifying criteria are encapsulated within rule groups, comprising multiple distinct rules. Each rule delineates a data source, conditional operator, and requisite value(s) for comparison. Depending on the criteria defined within the rule group, one or more rules may match, facilitating the transition of the event into the current state. Concurrently, if actions are linked to the state, they are executed accordingly. Actions serve as versatile entities, facilitating specific data modifications or the initiation of programmatic or non-programmatic events. This capability may consolidate programmatic and non-programmatic contacts within a unified workflow of the system 100. FIG. 6 shows dataflow in a process 600 for executing operations of a state management engine, according to an embodiment.

The analytics server 108 may execute software programming of an email communications service for managing outbound email communications, which may include email marketing or email execution service, for orchestrating campaign events via programmatic and non-programmatic channels. The email execution operations seamlessly integrate with the personalization capabilities to achieve a common objective of delivering personalized content to end-users.

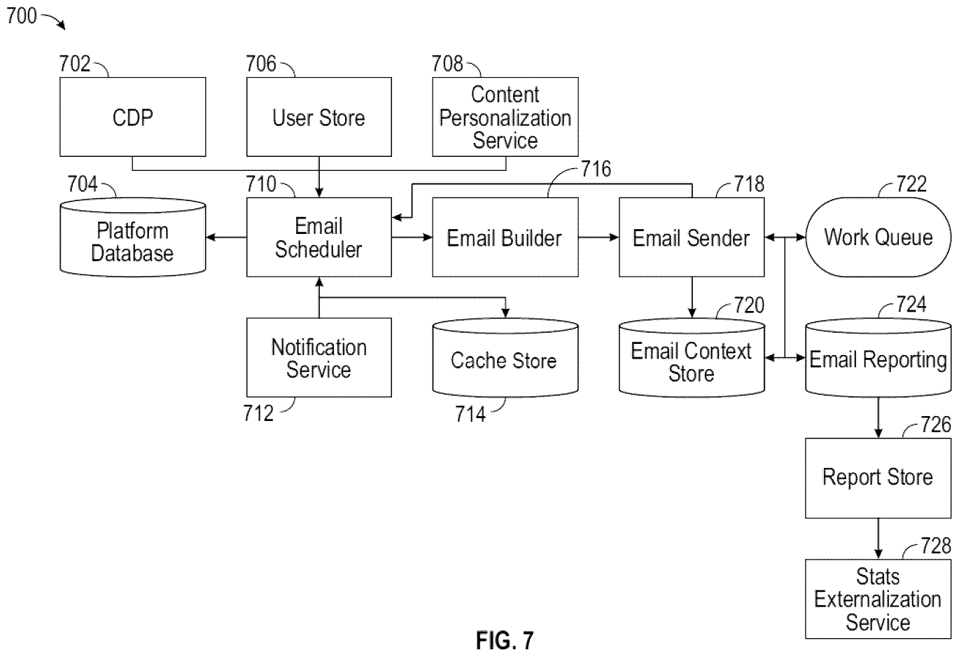

The email communications service of the analytics server 108 serves as a communication channel within the orchestration workflow, acting both as an integrated software component and a standalone software component. The email communications service provides foundational capabilities commonly offered. The analytics server 108 may leverage programmatic data points for filtering purposes, refining audience targeting with precision. The analytics server 108 may generate or mine insights into tracked end-to-end customer journey interactions using various types of engagement data in the CDP. The analytics server 108 may enhance audience segmentation and targets users with relevant emails, beneficially improving effectiveness. FIG. 7 shows a dataflow amongst components of a system 700 performing operations for hosting and performing operations of an email communications service, according to an embodiment.

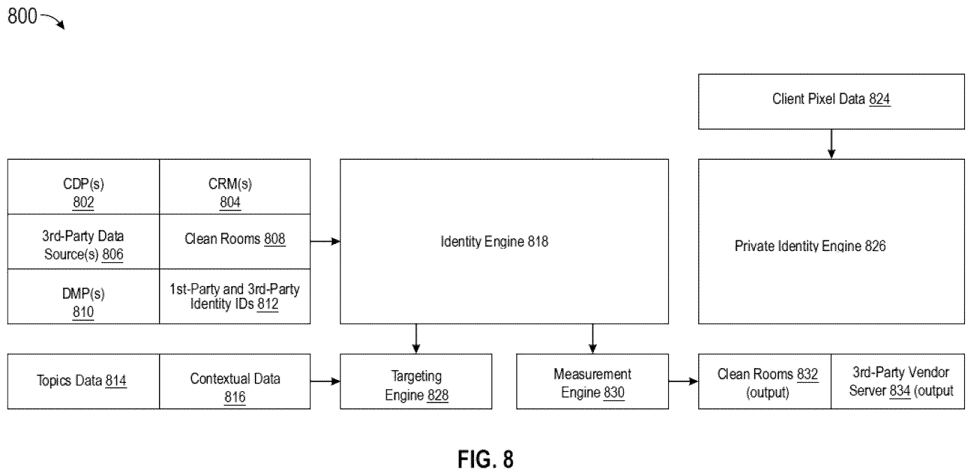

The analytics server 108 may execute software programming of an identity service. The identity service may seamlessly integrate programmatic and non-programmatic data under a unified framework, which may include an identity engine. The identity engine may generate, query, maintain, and/or update an identity data structure (e.g., database table, key-value store) containing mappings or linkages between heterogenous user identifiers from disparate data sources to a unified data identifier for the particular users. The identity engine may store the user identifiers into the identity data structure (in one or more databases) that correlate with the unified identifiers of individual customers. FIG. 8 shows a dataflow amongst components of a system 800 performing operations for an identity service, according to an embodiment.

In some embodiments, the analytics server 108 receives trigger events from one or more source pods 112 and evaluates whether a user satisfies a condition for entry into a programmatic sequence. Each trigger event is associated with a unique trigger event identifier, which the analytics server 108 uses to deduplicate incoming events and prevent redundant instantiation of programmatic sequences. The trigger event identifier may be computed from a hash of the event payload or explicitly provided by the source pods 112.

The analytics server 108 applies frequency control logic to determine whether a user has exceeded a configured entry limit for a given programmatic sequence. The frequency control logic may query a fast-access key-value store using a composite key comprising the user identifier, user identifier type, and programmatic sequence identifier. The result of the query is used to determine whether the user is eligible for re-entry based on a rolling time window or a no-repeat configuration.

The analytics server 108 evaluates trigger conditions using contextual data associated with the trigger event. For example, the analytics server 108 may evaluate whether a purchase event received from the source pods 112 satisfies a threshold condition (e.g., order total exceeds a specified amount). If the condition is satisfied, the analytics server 108 promotes the user to the next step in the programmatic sequence. If the condition is not satisfied, the analytics server 108 may route the user to an alternate path or terminate the sequence.

The analytics server 108 supports conditional branching based on trigger event properties through a trigger-split operation. In this operation, the analytics server 108 evaluates one or more filters associated with the trigger event and selects a path based on the outcome of the evaluation. The filters may include logical combinations of conditions (e.g., AND/OR) and may reference attributes such as event type, source system, or contextual metadata.

The analytics server 108 may also process negative triggers by combining a positive trigger with a wait-for-condition step. For example, to evaluate whether a user has not opened an email within a specified time window, the analytics server 108 may instantiate a wait-for-condition step following an email send event and monitor for the absence of an open event. If the condition is not met within the configured time window, the analytics server 108 promotes the user along a timeout path.

In some embodiments, analytics server 108 receives refresh directives from a product catalog management service and initiates synchronization operations to update a products table from one or more external feeds. The refresh directive may be transmitted via a message queue, using software routines for the notification service and/or the queuing service, and may include metadata such as feed identifier and sync frequency. Upon receiving the directive, analytics server 108 triggers a sync operation that retrieves product data from the specified feed and updates the products table accordingly.

The analytics server 108 manages the lifecycle of sync operations using a state machine. Syncs are created in a scheduled state with a designated execution time. When the scheduled time arrives, analytics server 108 places the sync into a queue and assigns it to a worker for execution. The worker retrieves product data from the external feed and updates the products table in accordance with the schema and mapping defined for the feed.

The analytics server 108 stores product metadata in a flexible schema that includes required fields such as product identifier, title, image URL, and click URL, as well as a JSON field containing custom attributes. The custom attributes field supports a flat key-value map that enables storage of heterogeneous product data across different verticals and catalog formats. This schema-less approach allows analytics server 108 to query and join product data with behavioral event streams without enforcing a rigid attribute structure.

The analytics server 108 correlates behavioral events received from source pods 112 with product metadata stored in the products table. For example, a checkout event from a commerce platform may include a product identifier that matches an entry in the products table. Analytics server 108 retrieves the corresponding product metadata and fuses it with the behavioral event to generate a composite user narrative. This fusion enables real-time personalization and analytics based on both structured and unstructured data.

In some embodiments, the analytics server 108 executes and receives refresh instructions from a product catalog management service and initiates synchronization operations to update a products table from one or more external feeds from other devices of the system 100. The refresh instruction may be received via a message queue of a messaging service (e.g., notification service, queuing service) and may include metadata such as feed identifier and sync frequency. Upon receiving the refresh instruction, the analytics server 108 triggers and executes a sync operation that retrieves product data from the specified data feed and updates the products table accordingly.

The analytics server 108 manages the lifecycle of sync operations using a state machine. Syncs are created in a scheduled state with a designated execution time. When the scheduled time arrives, analytics server 108 places the sync into a queue and assigns it to a worker for execution. The worker retrieves product data from the external feed and updates the products table in accordance with the schema and mapping defined for the feed.

The analytics server 108 stores product metadata in a flexible schema that includes required fields such as product identifier, title, image URL, and click URL, as well as a JSON field containing custom attributes. The custom attributes field supports a flat key-value map that enables storage of heterogeneous product data across different verticals and catalog formats. This schema-less approach allows analytics server 108 to query and join product data with behavioral event streams without enforcing a rigid attribute structure.

The analytics server 108 correlates behavioral events received from source pods 112 with product metadata stored in the products table. For example, a checkout event from a device of the system hosting a commerce platform (e.g., webservers 106) may include a product identifier that matches an entry in the products table. The analytics server 108 retrieves the corresponding product metadata and fuses it with the behavioral event to generate a composite user narrative. This fusion enables real-time personalization and analytics based on both structured and unstructured data.

In some embodiments, analytics server 108 evaluates grouped rules associated with a segment definition and determines whether a user satisfies the conditions for segment membership. Each rule group may include one or more conditions, and each condition may be linked to a source pod 112 that provides matched user data. Analytics server 108 receives matched condition updates from source pods 112 via an event stream and updates the user store accordingly.

The analytics server 108 maintains a user store keyed by hashed email address, which caches matched conditions for each user. This cache reduces the frequency of queries to source pods 112 and supports compound condition evaluation. For example, if a rule group includes conditions C₁ and C₂, and the analytics server 108 receives an update indicating that C₁ is matched, then the analytics server 108 may use cached data to determine whether C₂ is also matched without querying the source pods 112.

The analytics server 108 initiates segment refresh operations by querying source pods 112 for matched users associated with each condition in a segment. The refresh operation may be performed in batch mode or iteratively. In batch mode, the analytics server 108 retrieves all matched users for each condition and evaluates segment membership. In iterative mode, the analytics server 108 queries one condition at a time and filters subsequent queries based on previously matched users. This approach reduces database load and improves efficiency for segments with multiple conditions.

The analytics server 108 publishes segment membership updates to a segment update event stream. Each update includes the segment identifier and the user identifier. Downstream systems may consume these updates to trigger additional actions or synchronize user data. The analytics server 108 also supports conversion of segments to programmatic audiences by invoking an external resolution service. The conversion is performed selectively to avoid redundant processing for segments that have been recently converted.

The analytics server 108 manages segment metadata using a lightweight database that stores refresh status, audience size, and last update timestamps. This metadata supports visibility into the refresh pipeline and prevents redundant processing of shared conditions. The analytics server 108 uses TTL-based expiry to remove inactive segments and conditions from user profiles, ensuring that segment membership reflects current user behavior.

In some embodiments, analytics server 108 executes enrichment operations to generate composite user records by linking attributes from multiple data sources to a user identifier. Each enrichment operation begins with a record comprising a user identifier, such as a hashed email address, device identifier, or derived user identifier (DUID). The analytics server 108 queries one or more third-party data stores to retrieve attributes linked to the user identifier. These attributes may include demographic data (e.g., job title, company name), behavioral indicators (e.g., purchase intent), or contextual metadata (e.g., location, industry vertical).

The analytics server 108 evaluates linking conditions to determine whether the retrieved attributes satisfy criteria for inclusion in the composite record. Linking conditions may include recency thresholds, confidence scores, or source-specific validation rules. For example, the analytics server 108 may require that a job title attribute be sourced from a licensed dataset updated within the past 30 days and associated with a verified domain. If the linking conditions are satisfied, the analytics server 108 generates a composite record comprising the user identifier and the linked attributes.

The analytics server 108 stores the composite record in a segment store or user store, which supports TTL-based expiry and metadata tracking. Each record includes provenance metadata indicating the source system, retrieval timestamp, and linkage confidence. This metadata enables downstream systems to audit enrichment operations and apply filtering logic based on data origin or freshness.

In some embodiments, the analytics server 108 performs enrichment operations asynchronously via a batch pipeline. The pipeline may be triggered by a data upload, segment refresh, or external directive. The analytics server 108 partitions the input records by user identifier type and dispatches enrichment jobs to workers configured for specific data sources. Each worker retrieves linked attributes, evaluates linking conditions, and returns enriched records to the analytics server 108 for storage and indexing.

The analytics server 108 supports attribute fusion across heterogeneous data schemas by normalizing linked attributes into a flexible key-value format. For example, attributes retrieved from a B2B dataset may include fields such as “company_size” and “industry_code,” while attributes from a consumer dataset may include “household_income” and “purchase_intent.” The analytics server 108 stores these attributes in a unified schema that enables downstream systems to query and filter enriched records without enforcing rigid structural constraints.

In some embodiments, the analytics server 108 exposes an enrichment API that allows external systems to submit user identifiers and receive enriched records. The API supports synchronous and asynchronous modes and includes parameters for specifying data sources, attribute types, and linkage thresholds. The analytics server 108 may also publish enrichment events to a message queue or event stream, enabling real-time integration with personalization engines, audience builders, and orchestration workflows.

In some embodiments, analytics server 108 executes personalization operations that select and generate personalized creatives based on a combination of contextual inputs. These contextual inputs may include user-specific signals (e.g., behavioral history, segment membership), situational signals (e.g., time of day, weather conditions), and global signals (e.g., market trends, campaign performance metrics). The analytics server 108 retrieves contextual inputs from internal data stores and external services, and evaluates one or more conditions to determine which creative components to select for rendering.

The analytics server 108 maintains a creative template repository comprising creative definitions with placeholder fields. Each placeholder field is associated with a set of candidate values and selection logic. Upon receiving a personalization request, the analytics server 108 resolves each placeholder using the contextual inputs and selection logic. For example, a placeholder for “headline” may be resolved using a user's recent browsing activity, while a placeholder for “image” may be resolved using current weather conditions in the user's location.

The analytics server 108 supports fallback logic for resolving placeholders when contextual inputs are unavailable or do not satisfy selection conditions. Fallback logic may include default values, randomized selections, or suppression of the creative component. For example, if a user-specific signal is missing, the analytics server 108 may select a generic headline or omit the headline field entirely. This fallback mechanism enables robust personalization even in cases of partial data availability.

In some embodiments, analytics server 108 executes a content delivery interface that executes bid suppression logic to prevent delivery of creatives to users who are unlikely to engage. Bid suppression logic may evaluate historical engagement data, frequency caps, or exclusion lists. If suppression conditions are met, the analytics server 108 may skip creative rendering or redirect the user to an alternate experience. This improves system efficiency and reduces wasted impressions.

The analytics server 108 may execute optimization strategies to select the most effective creative variant for each user. Optimization strategies may include rule-based selection, A/B testing, or machine learning models trained on engagement outcomes. The analytics server 108 tracks performance metrics for each creative variant and updates selection logic based on observed outcomes. For example, if a particular image variant yields higher click-through rates for users in a specific segment, the analytics server 108 may increase its selection probability for future requests.

In some embodiments, analytics server 108 renders the personalized creative and transmits it to a downstream system for delivery. The rendered creative may be formatted for display in programmatic channels (e.g., display ads, native placements) or non-programmatic channels (e.g., email, SMS). The analytics server 108 may also store the rendered creative in a cache or log for auditing and analytics purposes.

The analytics server 108 supports real-time personalization by executing creative resolution operations within a bounded latency window. To achieve this, the analytics server 108 may precompute candidate values for frequently used placeholders, cache contextual inputs, and parallelize evaluation logic. This enables the system to deliver personalized creatives at the time of ad serving or email generation without introducing perceptible delay.

In some embodiments, the analytics server 108 executes software functions of the identity engine for constructing and maintaining the unified identity database or other data structure (e.g., key-value store, database table, computer file) that links the various user identifiers the unified identifiers. The various types of user identifiers may include, for example, hashed email addresses, login credentials, or platform-specific user IDs of third-party systems, IP addresses, device fingerprints, and mobile ad identifiers (MAIDs), among others. In operation, the analytics server 108 receives input data that includes user identifiers from the source pods 112 and determines the unified identifiers associated with each user identifier according to the identity data structure. Optionally, the analytics server 108 exposes an identity resolution API that accepts one or more user identifiers and returns a resolved unified user profile indicated by the identity data structure.

The analytics server 108 may also generate a unified interaction view by aggregating behavioral events across linked identifiers. For example, events associated with a MAID, IP address, and hashed email may be grouped into a single timeline representing the user's cross-channel journey. This view enables customer-facing systems to visualize user behavior across programmatic and non-programmatic channels, even when individual identifiers are fragmented.

In some implementations, the analytics server 108 integrates with third-party identity providers to enrich the identity data structure with various types of data associated with the identifiers of the identity data structure. For example, the analytics server 108 may receive audience data provider ID mappings, IP-based enrichment from a data enrichment service, or B2B profile data from an audience segmentation provider. These integrations are configured to operate within privacy and contractual constraints and may be selectively enabled based on business requirements.

In some embodiments, the above-mentioned components can be connected to each other through the network 110. Examples of the network 110 can include, but are not limited to, private or public local-area-networks (LAN), wireless LAN (WLAN) networks, metropolitan area networks (MAN), wide-area networks (WAN), and the Internet. The network 110 can include wired and/or wireless communications according to one or more standards and/or via one or more transport mediums. The communication over the network 110 can be performed in accordance with various communication protocols such as Transmission Control Protocol and Internet Protocol (TCP/IP), User Datagram Protocol (UDP), and IEEE communication protocols. In another example, the network 110 can also include communications over a cellular network, including, e.g., a GSM (Global System for Mobile Communications), CDMA (Code Division Multiple Access), and EDGE (Enhanced Data for Global Evolution) network.

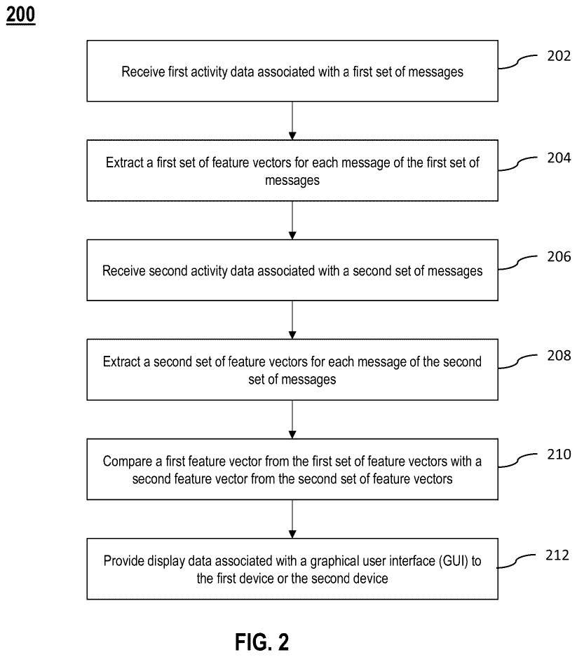

FIG. 2 illustrates a flow diagram of a process 200 executed by an analytics server, according to an embodiment. The process 200 includes operations 202-212. However, other embodiments can include additional or alternative operations or can omit one or more operations altogether. The process 200 is described as being executed at least in part by an analytics server that is the same as, or similar to, the analytics server 108 described in FIG. 1. However, one or more operations of process 200 can also be executed by any number of computing devices operating in the distributed computing system described in FIG. 1. For instance, one or more computing devices (e.g., computing devices that can be the same as, or similar to, the user devices 102, the network device 104, the webservers 106, and/or the network 110) can perform some or all of the operations described in FIG. 2 alone or in cooperation with one or more other computing devices of FIG. 1. Using the methods and systems described herein, such as the process 200, the analytics server can determine identifying features across messages communicated in a network.

At operation 202, the analytics server receives first activity data associated with a first set of messages. For example, the analytics server can receive the first activity data based on the communication of the first set of messages across one or more networks (e.g., networks that are the same as, or similar to, the networks configured to be established by the network device 104 of FIG. 1 and/or the network 110 of FIG. 1). In some embodiments, the first set of messages can be communicated between one or more user devices (e.g., that are the same as, or similar to, the user device 102 of FIG. 1) and one or more webservers (e.g., that are the same as, or similar to, the webservers 106 of FIG. 1). For example, the first set of messages can be communicated between the user devices and the webservers as individuals controlling the respective user devices provide input to the user devices when interacting with resources hosted by the webservers.

In examples, the webservers can track one or more aspects of the interactions between the user devices and the webservers and generate the first activity data. For example, the webservers can identify one or more fields that are selected (e.g., on a webpage and/or the like hosted by the web server) based on the first set of messages communicated to the webservers by the user devices. In this example, the webservers can generate the activity data such that the activity data includes information about the selection (e.g., what portion of a webpage was selected, a time at which the selection occurred, one or more subsequent selections that are related to a given selection, and/or the like). Additionally, or alternatively, the webservers can include the one or more messages (or information derived from the one or more messages) in the first activity data. Once generated, the webservers can provide (e.g., transmit) the first activity data to the analytics server. It will be understood that the webservers can generate the first activity data based on interactions involving individual users operating user devices, individual users operating multiple user devices, and/or multiple users operating multiple user devices.

In some embodiments, the user devices that communicate the first set of messages communicate the messages via a network device (e.g., that is the same as, or similar to, the network device 104 of FIG. 1), and the analytics server can generate the first activity data based on an address associated with the network device. In an example, where a user has access to multiple user devices that communicate over the network via a network device (e.g., a router that is configured to establish a home or public network and allow for communication via network address translation (NAT) and/or the like), the web server that receives the messages may not have access to the device identifiers for the user devices involved in such communication. In this example, the web server can generate the first activity data and include the public internet protocol (IP) address when generating the first activity data. In this way, the web server can capture programmatic data regarding the interaction between the user device and the web server when non-programmatic data is unavailable or incorrect (e.g., when a user is using a user device where non-programmatic data is stored thereon in association with a different user).

In some embodiments, the first set of messages can be associated with a first channel involved in communicating programmatic data. For example, the first set of messages can be associated with a first channel that is configured to be monitored by the analytics server. In this example, each message of the first set of messages can be associated with the communication of programmatic data that is collected and processed by the analytics server as described herein. This programmatic data can include one or more of: demographic data associated with the age, gender, income, education, and/or the like of a user operating a user device; behavioral data associated with the online behavior of the user, such as the websites visited, content engaged with, actions taken, and/or the like; interest data associated with interests and preferences of the user operating a given user device such as topics of interest, products they are considering purchasing, and/or the like; location data associated with the location of the user device, such as their country, region, city, zip code, and/or IP address; device data associated with the user device such as the type of device (e.g., smartphone, tablet, or desktop), operating system, device identifier (e.g., MAC address and/or the like), browser fingerprint, and/or the like; contextual data associated with a context in which the user is interacting with the server such as the website or app they are interacting with, content viewed, and the time of day; third-party data that associated with user interactions as monitored by third-party sources such as data management platforms (DMPs) or data aggregators, and/or the like. In some embodiments, the messages communicated via the first channel can be configured to include or not include a user identifier. For example, the messages communicated via the first channel can include one or more fields that include or do not include a field to store a user identifier. In examples, the messages communicated via the first channel can include eon one or more fields that do include a field to store a user identifier but include a user identifier that corresponds to a user that is not in control of the user device when the first message is generated. Examples of user identifiers can include, for example, a uniform resource identifier (e.g., corresponding to an email address and/or the like), user identifiers, globally unique identifiers, and/or the like. In some embodiments, these user identifiers can be associated with non-programmatic data involved in one or more interactions between the user devices and the webservers as described herein.

In some embodiments, the analytics server can implement a customer data platform (CDP). For example, the analytics server can implement a customer data platform that captures customer information based on the communication of the messages between the user devices and the webservers. The customer information can include, for example, demographic information, end user data associated with one or more aspects of the users and/or the user devices controlled by the users, interaction data generated based on interactions between the user devices and the webservers.

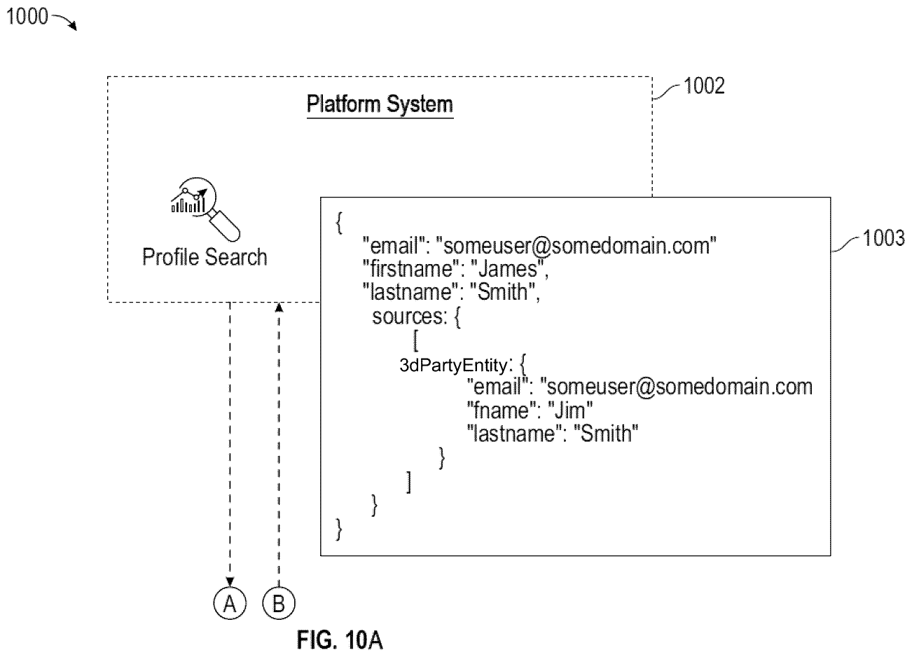

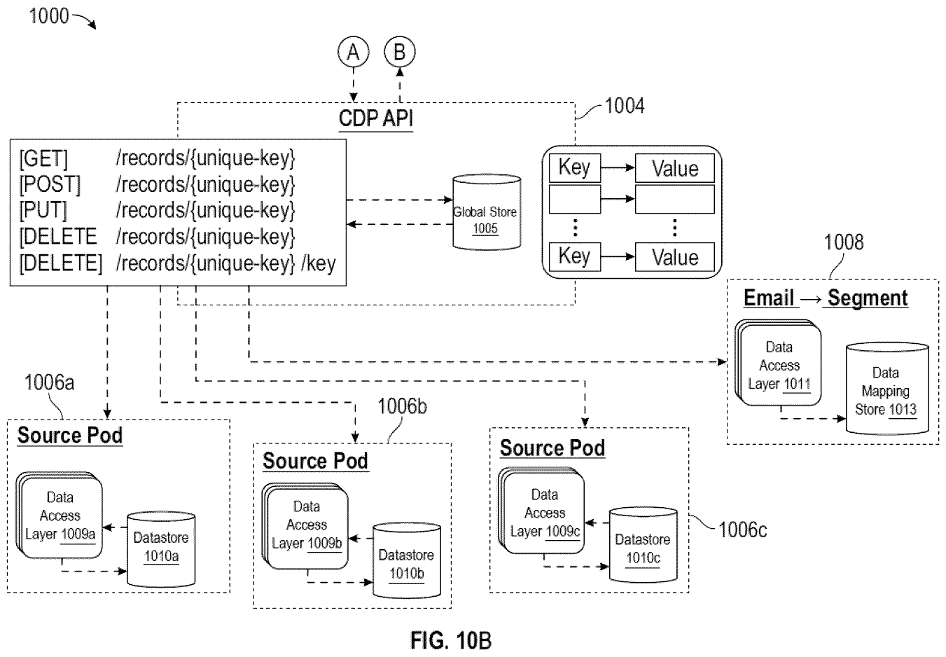

In some examples, the customer data platform implemented by the analytics server can identify target audiences to send both targeted marketing emails via programmatic and non-programmatic channels. In some embodiments, when new information is received by the customer data platform, third party data sources such as other analytics servers and/or other webservers can cause the analytics server to execute algorithms which can include machine learning models to predict which user and user ID to assign new messages communicated in both programmatic and non-programmatic channels. These algorithms and machine-learning models can be trained to identify a common audience for a particular marketing campaign using the information captured by the customer data platform and generate dynamic marketing content for distribution through the programmatic and non-programmatic channels. Machine learning models can be trained to identify lookalikes on top of the information captured by the customer data platform to distribute through programmatic channels or non-programmatic channels (e.g., based on contexts determined as described herein). An example environment 1000 for implementing one or more operations to establish a customer data platform is shown in FIG. 10, below.

At operation 204, the analytics server can extract a first set of feature vectors for each message of the first set of messages. For example, the analytics server can extract a first set of feature vectors based on the analytics server executing one or more operations involving manual feature extraction for each message of the first set of messages. In some examples, the analytics server can extract a first set of feature vectors based on the analytics server executing one or more operations involving statistical methods such as calculating a mean, median, model, standard deviation, or other statistical measures for each feature of the features represented by each message of the first set of messages. In some embodiments, the analytics server can extract the first set of feature vectors for each message using a machine learning (ML) model (e.g., a neural network and/or the like). For example, the analytics server can extract the first set of feature vectors based on the analytics server providing each message as an input to the ML model to cause the ML model to generate an output. In this example, the output can include the first feature vector and can represent one or more aspects of each of the messages.

When extracting the first set of feature vectors, the analytics server can determine one or more attributes for each message of the first set of messages. For example, the analytics server can determine the one or more attributes based on the interactions between the user devices and the webservers, as represented by the first activity data. In this example, the one or more attributes can identify portions of web pages that were selected, items that were selected, times at which the selections occurred, and/or the like.

At operation 206, the analytics server can receive second activity data associated with a second set of messages. For example, the analytics server can receive second activity data associated with a second set of messages communicated by a second device of the one or more networks. In this example, the second set of messages can be generated based on the communication of the second set of messages across the one or more networks described herein. In some embodiments, the second set of messages can be communicated between the one or more user devices and the one or more webservers. For example, the second set of messages can be communicated between the user devices and the webservers as individuals controlling the respective user devices provide input to the user devices when interacting with resources hosted by the webservers.

In examples, the webservers can track one or more attributes of the interactions between the user devices and the webservers (e.g., using tracking pixels and/or the like) and generate the second activity data. For example, the webservers can identify one or more fields that are selected (e.g., on a webpage and/or the like hosted by the server) based on the second set of messages communicated to the webservers by the user devices and generate the second activity data such that the second activity data includes information about the selection. Additionally, or alternatively, the webservers can include the one or more messages in the second activity data. In some embodiments, the webservers can include one or more user identifiers as described herein. For example, as a user provides input to a user device involved in one or more interactions with one or more webservers, the user device can include the one or more user identifiers in the messages. Once generated, the webservers can provide (e.g., transmit) the second activity data to the analytics server such that the second activity data includes non-programmatic data associated with (e.g., specifying) the user identifiers for each message. It will be understood that the webservers can generate the second activity data based on interactions involving individual users operating user devices, individual users operating multiple user devices, and/or multiple users operating multiple user devices.

In some embodiments, the second set of messages can be associated with a second channel involved in communicating non-programmatic data. For example, the second set of messages can be associated with a second channel that is configured to be monitored by the analytics server. In this example, each message of the second set of messages can be associated with the communication of non-programmatic data that is collected, processed, and utilized by the analytics server as described herein. This non-programmatic data can include one or more user identifiers stored by the user device to indicate an identity of a user interacting with the user device. For example, the non-programmatic data can include a user identifier such as an email address and/or the like that is stored by the user device in association with one or more cookies, and/or the like.

In some embodiments, the analytics server can receive the second activity data associated with a second set of messages, where the second set of messages are communicated between the user devices and the webservers during a second period of time. For example, the user devices and the webservers can communicate the second set of messages during the second period of time such that the second period of time at least partially overlaps with the first period of time. In some examples, the user device and the webservers can communicate the second set of messages during the second period of time where the second period of time does not overlap with the first period of time.

As described above, the analytics server can implement a customer data platform. In examples, the analytics server can also capture customer information as described herein. In some examples, the analytics server can determine the customer information based on the second set of messages and perform one or more operations as described herein. These operations can include generating one or more GUIs to cause display devices of respective user devices to display information relevant (e.g., based on the context as determined herein).

At operation 208, the analytics server can extract a second set of feature vectors for each message of the second set of messages. For example, the analytics server can extract a second set of feature vectors based on the analytics server executing one or more operations involving manual feature extraction, statistical methods, and/or the like as described herein. In some embodiments, the analytics server can extract the second set of feature vectors for each message using an ML model (e.g., a neural network and/or the like that can be the same as, or similar to, the ML model used to extract the first set of feature vectors). For example, the analytics server can extract the second set of feature vectors based on the analytics server providing each message as an input to the ML model to cause the ML model to generate an output. In this example, the output can include second feature vectors and can represent one or more attributes of each of the messages.

At operation 210, the analytics server can compare a first feature vector from the first set of feature vectors with a second feature vector from the second set of feature vectors. For example, the analytics server can compare the first feature vector with the second feature vector to generate or otherwise determine a correlation value. In this example, the correlation value can indicate a probability that a first message corresponding to the first feature vector is associated with a second message corresponding to the second feature vector. In examples, the first feature vector can indicate a selection of a website having a first context (e.g., selection of one or more portions of a website dedicated to a particular product or service), and the second feature vector can indicate a selection of a website having a second context (e.g., selection of one or more portions of a website dedicated to a different product or service). In these examples, where the first context and the second context are similar (e.g., associated with a common category of goods or services), the values of the first feature vector and the second vector can be compared and indicate a correlation value that satisfies a correlation threshold, such as a device or user correlation threshold. Additionally, or alternatively, where the first context and the second context are not similar (e.g., associated with different categories of goods or services), the values of the first feature vector and the second vector can be compared and indicate a correlation value that does not satisfy the correlation threshold. Thus, the analytics server can determine a degree of association between the interactions represented by the first feature vector and the second feature vector, respectively, and determine that the degree of association satisfies or does not satisfy the correlation value. In some embodiments, satisfying the correlation value can indicate that the user interacting with the user devices involved in the communication of the first message and the second message is the same (e.g., that the same user caused both interactions between the respective user devices and webservers).

In some embodiments, the analytics server can determine that the first message was transmitted by the first device before or after the second message was transmitted by the second device. For example, the analytics server can compare timestamps associated with the first message and the second message and determine that the first message was transmitted before or after the second message. In this example, the analytics server can compare the first feature vector and the second feature vector as described herein based on (e.g., in response to) the analytics server determining that the first message was transmitted before or after the second message and perform one or more of the operations described herein based on the first message was transmitted before or after the second message. In one example, where the first message is transmitted before the second message, the analytics server can cause the graphical user interface to be displayed by either the first device or the second device. In another example, where the first message is transmitted after the second message, the analytics server can cause the GUI to be displayed by either the first device or the second device.

In some embodiments, the analytics server can compare a first set of first feature values of the first feature vector with a second set of second feature values of the second feature vector to determine one or more correlations between the first message and the second message. For example, where the interaction represented by the first message and the second message is the same or similar (e.g., involves a common category of goods or services), the analytics server can compare the first set of first feature values of the first feature vector with the second set of second feature values of the second feature and determine that one or more corresponding feature values (e.g., representing a particular feature) match (e.g., satisfy a threshold value when compared). In this example, the analytics server can determine a first correlation between the first message corresponding to the first feature values and the second message corresponding to the second feature values. In examples, the first set of feature values and the second set of feature values that match can correspond to a single feature or a plurality of features.

At operation 212, the analytics server can provide display data associated with a graphical user interface (GUI) to the first device or the second device. For example, the analytics server can provide the display data based on the analytics server determining that the correlation value associated with two or more messages satisfies the correlation threshold. In this example, the analytics server can provide the display data to the first user device or the second user device to cause a first display device corresponding to the first user device or a second display device corresponding to the second user device to display the GUI. In some implementations, the analytics server may generate the display data for display via the GUI of at least one of the first device or the second device based on the correlation value satisfying a user correlation threshold, and then the analytics server may transmit the display data to at least one of the first device or the second device for display via the GUI of the first device or the second device.

In some embodiments, the analytics server can generate the display data based on a context that is associated with the first message and the second message. For example, the analytics server can determine a context based on the attributes corresponding to the first message and the attributes corresponding to the second message. Additionally, or alternatively, the analytics server can determine the context based on the programmatic data and/or the non-programmatic data associated with the first message and the second message. The analytics server can then generate the display data associated with the GUI based on the context and transmit the display data to either the first user device or the second user device. In this way, the analytics server can cause the first user device or the second user device (or any other user device determined to be associated with the user involved in the first message and the second message) to display the GUI regardless of whether the user identifier is available to be used when directing the display data.

In some embodiments, the context can be used to generate an advertisement. For example, where the context indicates that a user selected one or more items to be included in a virtual shopping cart managed by the web server (e.g., based on interactions with the first user device or the second user device), the analytics server can determine an identifier for the one or more items. In this example, the analytics server can cause a GUI to be displayed on the other of the first user device or the second user device. In this way, the analytics server can determine that a user that is using a first user device (e.g., a user device that is not associated with that user) is interacting with a web server and generate GUIs including advertisements that are relevant to the activity of the user (e.g., based on the programmatic data associated with the interactions involving the first user device). The analytics server can then provide the display data including the GUIs to the second user device that the analytics server knows is in control of the user (e.g., based on the non-programmatic data). Similarly, the analytics server can generate GUIs based on interactions between the user and the second user device and provide similar display data to the first device when the analytics server determines that the user is in control of the first user device. In this way, the analytics server can increase the chances of the GUI being displayed via the first user device or the second user device at a temporally relevant point in time.

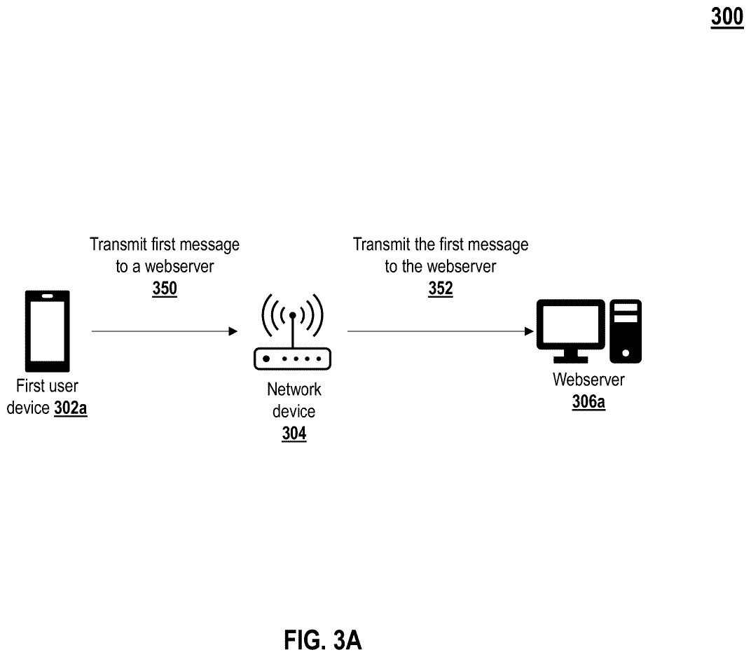

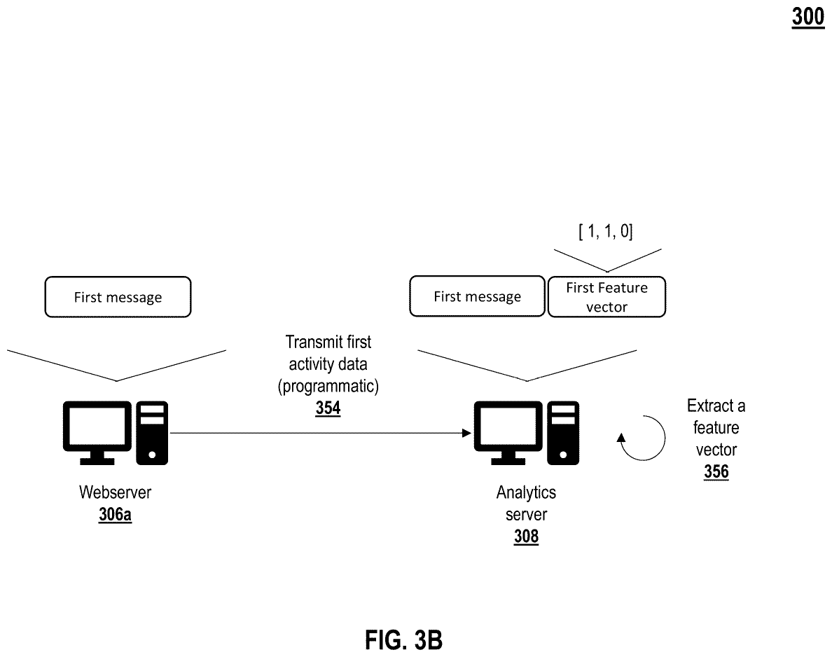

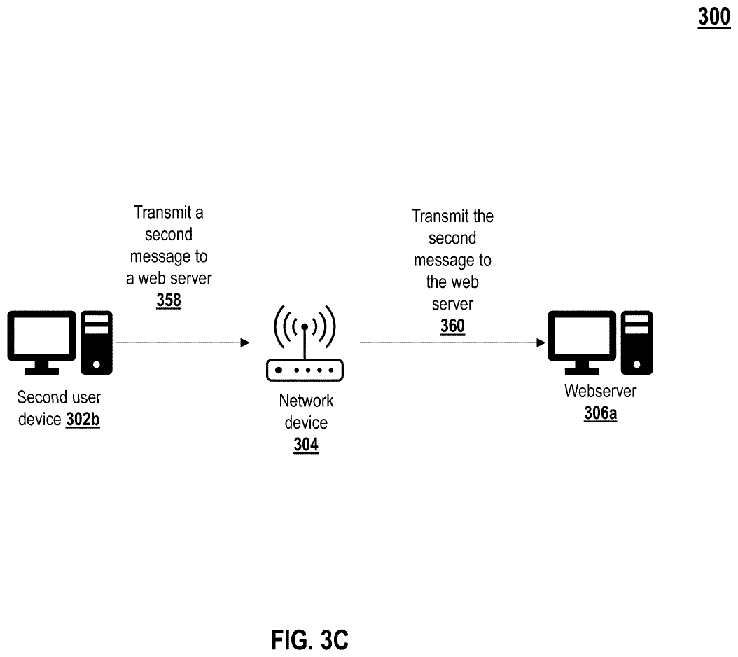

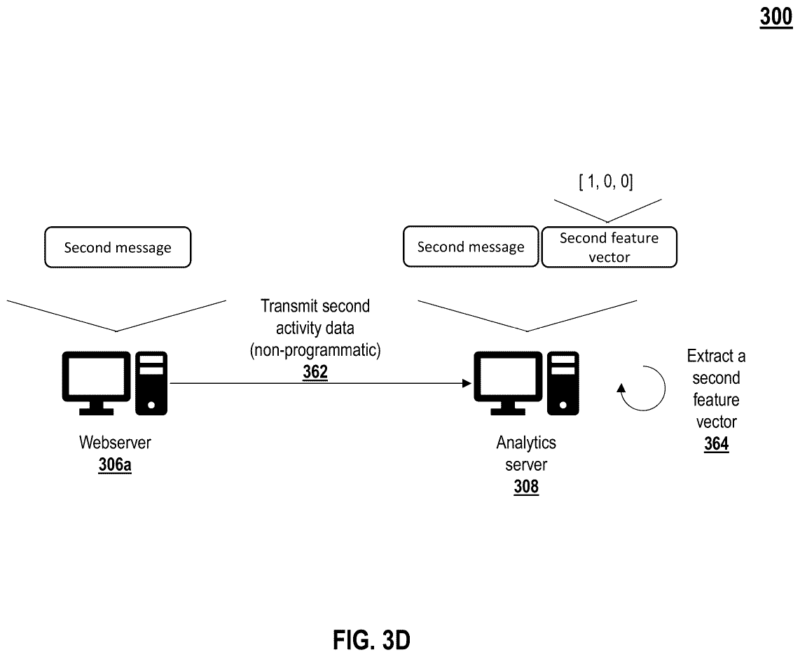

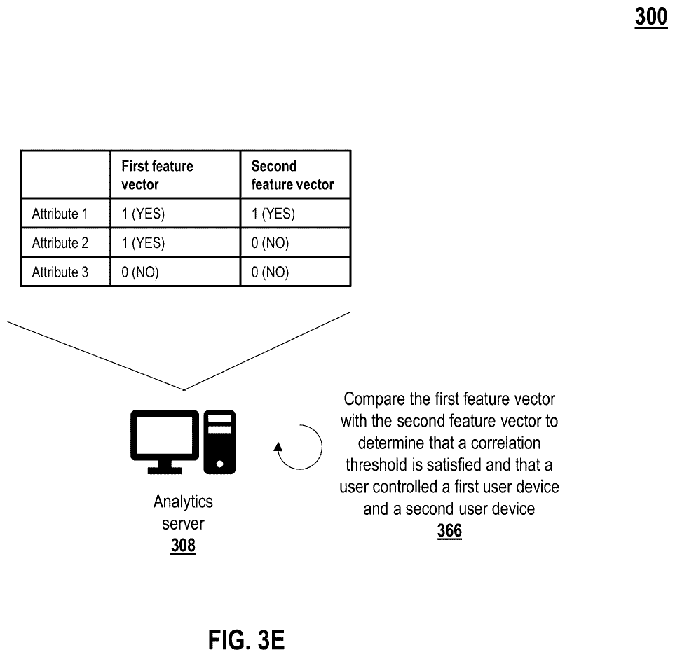

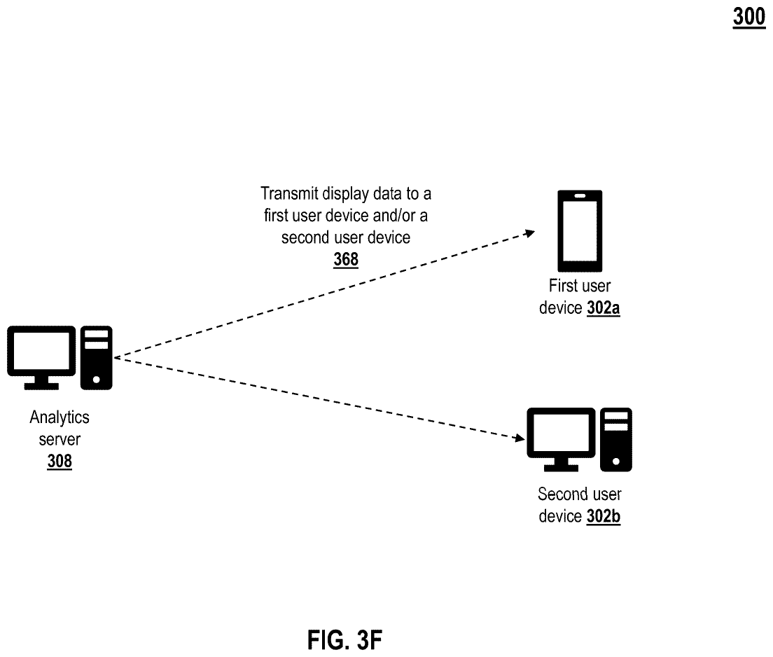

FIGS. 3A-3F illustrate a non-limiting example of an implementation 300 of systems and methods involved in determining identifying features across network operations. In some embodiments, one or more of the computing devices may be the same as, or similar to, one or more of the computing devices of FIG. 1. For example, one or more of the user devices 302 can be the same as, or similar to, the user devices 102 of FIG. 1, the network device 304 can be the same as, or similar to, the network device 104, and/or one or more webservers 306 can be same as, or similar to, the webservers 106 of FIG. 1.

Turning to FIG. 3A, as shown by operation 350, the first user device 302a can transmit a first message to a network device 304, to subsequently be transmitted to a web server 306a. In this example, a user can provide input to the first user device 302a to cause the first user device 302a to generate and transmit the first message. In some examples, the first user device 302a may not be associated with a user identifier of the user. As an example, a user can borrow a device from another user (e.g., a user that owns the user device) and provide input to the first user device 302a when interacting with a website hosted by the web server 306a. In this example, the first message can forgo including a user identifier or the first message can include a user identifier that does not correspond to the user operating the first user device 302a.

As shown by operation 352, the network device 304 can transmit the first message to the web server 306a. For example, the network device 304 can transmit the first message to the web server when distributing access across multiple user devices 302. In this example, the network can implement network address translation (NAT) or other similar functions to allow for multiple devices to obtain access to a network (e.g., a network that is the same as, or similar to, the network 110 of FIG. 1). As a result, the web server 306a and/or an analytics server 308 can experience difficulty when determining an identity of a user controlling the first user device 302a and implement one or more of the techniques described herein to correlate the activity involving the user device (represented as programmatic data) with a user identifier (represented as non-programmatic data) as described herein.

Turning to FIG. 3B, as shown by operation 354, the web server 306a can transmit the first activity data (e.g., programmatic data captured from interaction with a placed ad or a pixel on a website) to an analytics server 308. For example, the web server 306a can transmit the first activity data based on the web server 306a receiving the first message from the first user device 302a. In this example, the web server 306a can generate the first activity data based on one or more attributes of an interaction between the first user device 302a and the web server 306a as initiated and/or represented by the first message. In some examples, the first activity data can include programmatic data as described herein.

Turning to FIG. 3C, as shown by operation 356, the analytics server 308 can extract a feature vector from the first message. For example, the analytics server 308 can extract the first feature vector based on the analytics server 308 executing one or more operations involving statistical methods as described herein. In some examples, the analytics server 308 can extract the first feature vector from the first message using a machine learning (ML) model as described herein.

As shown by operation 358, the second user device 302b can transmit a second message to a network device 304, to subsequently be transmitted to a web server 306a. In this example, a user can provide input to the second user device 302b to cause the second user device 302b to generate and transmit the first message. In some examples, the second user device 302b can be associated with a user identifier of the user. As an example, a user can interact with the second user device 302b and provide one or more user identifiers (e.g., an email address and/or the like) that the second user device 302b stores in memory (e.g., in association with a cookie and/or the like). The second user device 302b can then provide that user identifier in one or more messages when interacting with a website hosted by the web server 306a (or any other web server in communication with the analytics server 308).

As shown by operation 360, the network device 304 can transmit the second message to the web server 306a. For example, the network device 304 can transmit the second message to the web server 306a when distributing access across multiple user devices 302a-302c as described herein. In this example, the network can again implement NAT or other similar functions to allow for multiple devices to obtain access to a network. As a result, the web server 306a and/or an analytics server 308 can experience difficulty when determining an identity of a user controlling the second user device 302b and rely on the user identifier included in the second message (represented as non-programmatic data) when performing one or more operations as described herein.

Turning to FIG. 3D, as shown by operation 362, the web server 306a can transmit the second activity data (e.g., non-programmatic data received from a third-party server such as the web server) to an analytics server 308. For example, the web server 306a can transmit the second activity data based on the web server 306a receiving the second message from the second user device 302b. In this example, the web server 306a can generate the second activity data based on one or more attributes of an interaction between the second user device 302b and the web server 306a as initiated and/or represented by the second message. In some examples, the second activity data can include non-programmatic data as described herein.

As shown by operation 364, the analytics server 308 can extract a second feature vector from the second message. For example, the analytics server 308 can extract the second feature vector based on the analytics server 308 executing one or more operations involving statistical methods as described herein. In some examples, the analytics server 308 can extract the second feature vector from the second message using an ML model as described herein.

Turning to FIG. 3E, as shown by operation 366, the analytics server 308 can compare the first feature vector with the second feature vector to determine that a correlation threshold is satisfied. In this example, the analytics server 308 can determine that a user controlled a first user device and a second user device based on the correlation threshold being satisfied. For example, analytics server 308 can compare one or more values of the first feature vector with corresponding values of the second feature vector to determine a correlation value and compare that correlation value to the correlation threshold. In this example, the analytics server 308 can determine that the first user device 302a and the second user device 302b at respective points in time were both used by the same user even though the first user device 302a may not have included programmatic data (e.g., the user identifier of the user) or may have provided incorrect programmatic data (e.g., a user identifier of another user) when transmitting the first message to the web server. Turning to FIG. 3F, as shown in operation 368, the analytics server 308 can transmit display data or instructions to the first user device 302a and/or the second user device 302b for display at a user interface. The display data can include, for example, web-based data, content data, or other types of resulting information in the one or more messages, among other types of data for display to the end-user as discussed herein.

FIG. 4 illustrates operations and dataflow of a system 400 for developing and hosting a platform 402 (e.g., CDP) within various hardware and software components, according to embodiments. The operations implemented within computing devices or other components of the system 100 (which may be similar to the components of system 100) for hosting the platform 402 that provides the infrastructure and services for the CDP 402 and associated software components. For example, the various software functions or operations of the system 400 may be components or operations of an analytics server 108, databases, or other computing devices.

The system 400 includes a platform 402 comprising computing hardware and software components configured to support operations of a customer data platform (CDP). The platform 402 includes a platform datastore 404, a feed engine 406, a status store 408, a personalization engine 416, an event integration datastore 418, source pods 420, a global store 422, an identity service 424, a content personalization service 426, a DCO cache 428, an event stream 430, a stats externalization service 432, a report store 434, a programmatic orchestration service 436, and an email orchestration service 438. Each component of the platform 402 may be implemented using one or more computing devices executing software programming for performing the operations described herein.

The platform 402 includes hardware and software components configured to host foundational infrastructure and services for a customer data platform (CDP). For example, the platform 402 may be implemented by an analytics server 108 or other computing devices of a system 100 of FIG. 1. The platform 402 orchestrates operations across ingestion, personalization, identity resolution, and downstream orchestration services and dataflow within the system 400.

The platform datastore 404 comprises a structured data repository configured to store and manage data ingested from multiple sources. The platform datastore 404 stores various types of data in non-transitory persistent storage, such as normalized user or operational records for use by components of the system 400 in personalization and analytics operations. The platform datastore 404 may be implemented in one or more databases hosted in various computing devices, such as the analytics server 108 or database coupled to the analytics server 108. The platform datastore 404 stores various types of data that may be ingested by other components of the system, such as a feed engine 406.

The feed engine 406 includes software routines for ingesting data from the platform datastore 404, the external integrations 410, user-uploaded data 412, and pixel integrations 414. The feed engine 406 is designed to operate as a central data ingestion hub, systematically collecting structured and semi-structured data from a variety of internal and external sources. The feed engine 406 may be implemented using backend services that apply schema mapping, transformation logic, and ingestion status tracking in coordination with a status store 408. In addition to basic ingestion, the feed engine 406 performs data normalization, validation, and enrichment to ensure consistency and quality across disparate data streams. The feed engine 406 executes processes for scheduling and monitoring of data ingestion from the various data sources. The feed engine 406 interfaces with downstream components, such as the personalization engine 416 and status store 408, by providing cleansed and structured datasets formatted for further processing.

The status store 408 includes a metadata repository configured to track operational status of data ingestion and integration processes. The status store 408 may be implemented in one or more databases hosted in various computing devices, such as the analytics server 108 or database coupled to the analytics server 108. The status store 408 maintains ingestion timestamps, error logs, and completion flags, and is coupled to the personalization engine 416 to support orchestration of downstream personalization operations.

The external integrations 410, user-uploaded data 412, and pixel integrations 414 represent data sources that supply structured and semi-structured records to the feed engine 406. These sources may include third-party APIs from third-party cloud-based services or vendors, CSV uploads, and pixel-based tracking systems. The external integrations 410 comprise connectors and interface modules, including internal APIs (e.g., CDP API 1004, third-party APIs), configured to retrieve data streams from external platforms, including software-as-a-service (Saas) providers, marketing platforms, and other cloud-based solutions. The user-uploaded data 412 includes records imported directly by users from user devices through file upload mechanisms, which may include uploaded data files (e.g., CSV, Excel, or other delimited formats) via one or more networks or the Internet. The pixel integrations 414 include software connectors for capturing and ingesting tracking data generated by software code of pixels embedded in web pages, emails, or applications to collect event-level data, such as page views, clicks, conversions, and user interactions. Each data source is ingested by the feed engine 406, which applies schema mapping, transformation logic, and ingestion status tracking data for generating and updating various types of data stored in the status store 408.

The personalization engine 416 includes software programming for personalization operations according to user data and event data. The personalization engine 416 receives input from the status store 408 and interacts with an event integration datastore 418 to generate personalized content and experiences. The personalization engine 416 includes software programming for executing personalization operations, content placement, and content generation that is tailored to user data and event data within the platform 402. The personalization engine 416 receives input from the status store 408, which provides operational metadata, such as ingestion timestamps, error logs, and completion flags related to data ingestion and integration processes. Using this metadata, the personalization engine 416 coordinates the orchestration of downstream personalization workflows. The personalization engine 416 exchanges various types of data with the event integration datastore 418, which aggregates event-level data from multiple internal and external sources. By interacting with the event integration datastore 418, the personalization engine 416 accesses structured datasets containing user interactions, behaviors, and event histories stored in the event integration datastore 418. The personalization engine 416 executes rules-based and algorithmic operations to analyze, segment, and interpret the data in the event integration datastore 418, and then generates contextually relevant content for placement and display to a end-user. These operations may include real-time content adaptation, targeted messaging, and recommendation logic based on user profiles, behavioral signals, and engagement patterns. The personalized outputs generated by the personalization engine 416 are subsequently routed to downstream components, such as the content personalization service 426, for delivery to users via various user interfaces and communication channels. In some embodiments, the personalization engine 416 may further leverage feedback mechanisms and analytics to continuously refine personalization strategies and improve user engagement over time.

The event integration datastore 418 comprises a structured data store configured to aggregate event-level data from multiple sources. The event integration datastore 418 may be implemented in one or more databases hosted in various computing devices, such as the analytics server 108 or database coupled to the analytics server 108. The event integration datastore 418 supports downstream personalization and analytics workflows and is communicatively coupled to source pods 420 and a global store 422. The event integration datastore 418 stores various types of event-level data, user interaction records, for personalization and analytics operations. Non-limiting examples of the event-level data or user interaction data include page views, clicks, conversions, and engagement activities across multiple channels. In some cases, the event integration datastore 418 stores various types of behavioral signals, event timestamps, device information, and contextual attributes related to each user event. The event integration datastore 418 may also aggregate event-level data or user interaction data from external sources, such as third-party APIs, pixel tracking systems, and user-uploaded files.

The source pods 420 (e.g., source pods 112, source pod deployable units 1006) include modular, deployable software containers configured to fetch, process, and internalize data from external or internal systems. Each source pod 420 may include a pod data access layer and a pod datastore and may operate as a logical host for ingestion and transformation logic.

The global store 422 includes a shared data repository configured to provide access to universal data used across the platform 402. The global store 422 may be implemented in one or more databases hosted in various computing devices, such as the analytics server 108 or database coupled to the analytics server 108. The global store 422 may store reference data, schema definitions, user data (e.g., user profile data objects 1003), and shared user attributes, among other types of data. The source pods 420 represent modular, deployable units that fetch, process, and internalize data from external or internal sources for particular source pods 420, while the global store 422 provides access to shared or universal data used by components across the platform 402.

The identity service 424 includes software routines for resolving and managing user identities across disparate data sources and channels. The identity service 424 supports identity linkage between user identifiers and other types of data (e.g., event data, user interaction data, audience tags), deduplication, and UID-based resolution logic, and is coupled to the content personalization service 426. The identity service 424 may be implemented in one or more computing devices, such as the analytics server 108 or a dedicated identity resolution module, and may execute a deterministic matching algorithm and/or a probabilistic matching algorithm to accurately associate multiple user identifiers with a unified user identifier (UUID) for a unified user profile. The identity service 424 is configured to ingest identity attributes and identifiers from various sources, including external integrations 410, user-uploaded data 412, pixel integrations 414, and event-level data stored in the event integration datastore 418.

The identity service 424 applies configurable rules and matching thresholds to identify and merge duplicate records, resolve conflicting identity attributes, and maintain persistent mappings between internal UIDs and external identifiers (e.g., email addresses, device IDs, cookies, platform-specific user IDs). In some embodiments, the identity service 424 maintains an identity data structure (e.g., database table indicating mappings, key-value store) within the global store 422 or in a distinct identity database, providing real-time access to unified identity records for downstream services. The identity service 424 continuously synchronizes identity states and propagates updates to coupled components, such as the content personalization service 426, such that personalized content and experiences are accurately targeted and rendered for each unique user across multiple touchpoints at disparate data sources having heterogenous types of user identifiers. In some implementations, the identity service 424 may expose APIs or data interfaces to facilitate integration with external identity providers, consent management platforms, and privacy compliance modules, thereby supporting secure and compliant identity management workflows within the platform 402.

The content personalization service 426 comprises a set of software components configured to deliver personalized content to users, leveraging outputs generated by the personalization engine 416 and the identity service 424. The content personalization service 426 interfaces with the personalization engine 416 to receive contextually relevant content, placement instructions, and personalization metadata derived from user data, event data, and operational metadata. Integration with the identity service 424 facilitates the association of personalized content with unified user identifiers, supporting accurate targeting and rendering of content across multiple user touchpoints. The content personalization service 426 retrieves creative assets, templates, and associated metadata from the DCO cache 428, enabling real-time selection and assembly of content elements for delivery. The content personalization service 426 generates various outputs and instructions for certain downstream components, such as the email orchestration services 438 and programmatic orchestration services 436, by transmitting personalized content payloads formatted for various delivery channels and user interfaces.

The DCO cache 428 comprises a structured data store configured to store creative components, personalization metadata, and rendering templates. The DCO cache 428 supports efficient retrieval of creative content assets for real-time content delivery to end-user devices (e.g., user devices 102) or third-party servers (e.g., webservers 106).

The event stream 430 includes a real-time data pipeline configured to propagate event data and personalization outputs between upstream and downstream services. The event stream 430 supports asynchronous communication and integration across the platform 402. The event stream 430 is implemented in one or more message queuing systems or streaming data frameworks deployed on various computing devices, such as the analytics server 108 or dedicated stream processing modules. The event stream 430 transmits event-level data, personalization instructions, and status updates generated by the personalization engine 416, content personalization service 426, and other services, enabling continuous data flow and orchestration of personalization operations.

The event stream 430 is coupled to both internal and external data sources, including external integrations 410, user-uploaded data 412, and pixel integrations 414, facilitating the ingestion and distribution of structured and semi-structured event records. The event stream 430 interacts with downstream components, such as the stats externalization service 432 and report store 434, to deliver event statistics, analytics data, and personalization logs for reporting and optimization workflows. The event stream 430 supports message routing, transformation, and filtering operations, allowing various platform services to subscribe to relevant event topics and process data in real time. The event stream 430 operates in conjunction with the event integration datastore 418 and the global store 422, providing a unified communication channel for propagating user interactions, behavioral signals, and personalization outcomes across the platform 402.

The stats externalization service 432 includes software programming configured to generate and export statistical data and analytics to external systems or reporting modules (e.g., report store 434). The stats externalization service 432 transmits metrics to a report store 434. The stats externalization service 432 receives event-level data, performance metrics, and analytics outputs generated by upstream components, such as the personalization engine 416, content personalization service 426, and event stream 430. The stats externalization service 432 formats, aggregates, and packages statistical datasets for compatibility with external reporting platforms, business intelligence tools, or third-party analytics services. The stats externalization service 432 supports synchronous and asynchronous data transfer operations, enabling integration with various downstream analytics operations. The stats externalization service 432 may execute transformation, filtering, and enrichment operations to statistical payloads prior to export, according to configuration settings or operational requirements specified within the platform 402. The stats externalization service 432 may store various types of generated metrics and analytics records into the report store 434.

The report store 434 comprises a non-transitory storage and software components configured to aggregate and store reports, analytics, and performance metrics generated by the stats externalization service 432 or other components of the system 400. The report store 434 supports downstream orchestration and optimization operations. The report store 434 is implemented as one or more relational or non-relational databases hosted on computing infrastructure associated with analytics server 108 or non-transitory storage devices. The report store 434 receives formatted statistical data, event logs, and analytics outputs from upstream components, including the stats externalization service 432 and event stream 430. For example, the programmatic orchestration services 436 and the email orchestration services 438 may access the report store 434 to retrieve relevant analytics and campaign performance metrics when generating relevant outputs to end-users, such as client users (e.g., campaign administrators) and customer-users.

The programmatic orchestration services 436 comprise software components configured to execute automated engagement operations via programmatic channels, such as web-based messaging platforms, push notifications, and API-driven communications. The programmatic orchestration services 436 receive input from the report store 434 and other upstream modules, including formatted statistical data, analytics outputs, and campaign performance metrics from the stats externalization service 432, or personalization payloads generated by the personalization engine 416 and content personalization service 426. The programmatic orchestration service 436 may receive and process incoming data streams, apply campaign logic, and generate outbound contact events formatted for delivery across multiple programmatic endpoints. The programmatic orchestration service 436 is configured to transmit instructions and output data to various delivery channel devices and third-party platforms, transmitting engagement payloads formatted according to channel specifications and operational requirements. The programmatic orchestration service 436 executes content delivery according to campaign configurations, rule-based targeting, and dynamic content generation, enabling orchestration of personalized user interactions in response to behavioral signals, segment membership, and state triggers. The programmatic orchestration services 436 may synchronize user data with source pods 420 and update campaign states in response to user actions and engagement outcomes.

The email orchestration services 438 include software components configured to execute automated engagement operations via non-programmatic channels, such as email. These services may interact with the personalization engine 416 and the content personalization service 426 to generate and deliver personalized email communications.

FIG. 5A and FIG. 5B show operations and data flow in processes 500a, 500b for orchestrating or managing outbound contact events to end-users via programmatic or non-programmatic contact channels for contact campaigns, according to an embodiment. The processes 500a, 500b illustrate orchestration operations executed by components of an analytics server 108 and manages outbound contact events across multiple channels. These processes 500a, 500b integrate data from, for example, a customer data platform (CDP), audience builder tools, and various programmatic and non-programmatic signals. The orchestration operations enable client-users (e.g., campaign administrators) to define campaign configurations and execute contact campaigns that respond to customer-user behavior, segment membership, and contextual triggers. For instance, the orchestration logic of the analytics server 108 includes a state management engine that captures and updates user “states” representing user sequences and expected operational conditions of user interactions, which include transitions between discrete states, each governed by rule groups (e.g., triggering events) and associated actions (e.g., user interactions).

In operation 501, a computer (e.g., analytics server 108) detects a triggering event or state transition indicating that a user has performed a triggering event or satisfies a state condition (e.g., user added a product to a cart).

In operation 503, the computer transitions the user to a first state and initiates a time-to-live or time window that functions as a time-based delay for monitoring subsequent user behavior, after the computer included the product into the user cart.

In operation 505, the computer monitors whether a second triggering event or state transition indicating the user has performed a second triggering event or satisfies a second state condition (e.g., user has completed a purchase operation in connection with the product in the user cart) within the time window.

In operation 507, the computer detects the second triggering event or state transition within the time window (as in operation 505) and, in response, executes downstream operations associated with a purchase state, including sending an email or other messages to the user device for related products and generating updated targeting information for the user for related products. The computer synchronizes user data with a source pod and finalizes the orchestration operations for the user.

In operation 509, the computer does not detect the second triggering event or state transition within the time window (as in operation 505) and, in response, executes downstream operations associated with the user failing to transition to the purchase state. For example, the computer may transmit a reminder email or generate updated targeting information for the user for the product in the user cart.

Turning to process 500b, in operation 511, the computer detects a triggering event or state transition indicating that a user has performed a triggering event or satisfies a state condition (e.g., user added a product to a cart). For example, the computer receives a signal indicating that a user has been added to a newsletter subscription group and transitions the user into a seed state.

In operation 513, computer generates and transmits an email or other message format to the user device indicating that the user has performed the triggering event or satisfies the state condition. For example, the computer sends an email to the user device confirming that the user subscribed to the newsletter.

In operation 515, the computer transitions the user to a first state and initiates a time-to-live or time window that functions as a time-based delay for monitoring subsequent user behavior, after the computer sent the email or other message format to user device.

In operation 517, the computer monitors for a second triggering event or state transition indicating the user has performed the second triggering event or satisfies a second state condition (e.g., user has completed a purchase operation in connection with the product in the user cart) within the time window.

In operation 519, the computer detects the second triggering event or state transition within the time window (as in operation 505) and, in response, executes downstream operations associated with an interaction state. For example, the computer detects a triggering condition or conditional interaction indicating that the user has opened the email or interacted with the message a threshold number of instances. In response, the computer generates and transmits an email or other message to the user device displaying information or promotion related to content of the newsletter (e.g., products from a manufacturer associated with the newsletter).

In operation 521, the computer does not detect the second triggering event or state transition within the time window (as in operation 505) and, in response, executes downstream operations associated with the user failing to transition to the interaction state. For example, the computer may determine that the user has not interact with the email or other message (as in operation 511) and generates updated campaign configurations to, for example, include the user in programmatic channel communications for the content provider.

FIG. 6 shows dataflow of a process 600 for operations of a state management engine (or similar computing software components) for orchestrating or managing outbound contact events to customer-users via programmatic or non-programmatic contact channels for contact campaigns, according to embodiments. The process 600 enables the orchestration of user journeys through a series of discrete states, each governed by event triggers, time-based conditions, and user actions. The state management engine facilitates the segmentation, targeting, and engagement of users based on their interactions with products and campaigns. The process 600 is implemented within computing devices or other components of a system 100. For example, the various software functions or operations of the process 600 may performed by the state management engine or other components of an analytics server 108, databases, or other computing devices.

The process 600 begins with a segment X 602 of various users, which may be defined based on audience attributes, behavioral criteria, or prior engagement history. Users in segment X 602 are evaluated in State_1 604, where the state management engine determines whether a user has performed an “Add to Cart” event or segment 618 for a product, with a filter value exceeding a specified threshold (e.g., filter value greater than threshold of thirty). The state management engine or other component of the system 100 may ingest event data 606 from various sources, such as user activity logs or external integrations, and is used to trigger state transitions.

Upon satisfying the criteria in State_1 604, users are advanced to State_2 608, which implements a time-based waiting period (e.g., three days). During this interval, the state management engine monitors for additional events 610, such as purchase completions or further engagement signals. The waiting period allows for natural user actions to occur before further segmentation or targeting.

At the conclusion of State_2 608, state management engine parses or bifurcates the users based on each user's actions during the waiting period. Users who have purchased the product are transitioned to State_3 612, where the state management engine may perform an inclusion function that adds such users to a “purchased” segment 613 for downstream engagement, such as loyalty campaigns or post-purchase communications.

Turning back to State_2 608, users who have not purchased the product after the waiting period are transitioned to State_4 614, in which the state management engine identifies such users as candidates for retargeting or abandoned cart campaigns.

In State_4 614, the state management engine may initiate additional operations, such as removing users from the active segment or advancing such users to State_5 616 upon successful synchronization of buyer-user data from a source pod 112.

State_5 616 represents the completion of the user's journey through the state management process, with successful synchronization indicating that the user's status has been updated in the system.

Throughout the process 600, the state management engine supports the creation of new audience segments 620, such as an “Add to Cart” segment 618, and the orchestration of downstream actions. These actions include the generation of email audiences 622, programmatic audiences 624, and the execution of targeted campaigns. For example, users may be added to a segment 626 and targeted with an email campaign featuring AI-generated suggestions 628 or included in a programmatic campaign with AI-based optimization 630.

Users who abandon a product in the user's cart may be targeted with specialized campaigns, such as an email campaign with the abandoned product 632 or a programmatic retargeting campaign 634. The state management engine enables dynamic audience creation and campaign orchestration, ensuring that users receive relevant communications based on the user's real-time behavior and state transitions.

FIG. 7 shows a dataflow amongst components of a system 700 for hosting and performing operations of an email communications service, according to embodiments. The system 700 may be implemented within various hardware and software components of any number of computing devices (e.g., analytics server 108, user devices 102) and may operate in coordination with other components including a customer data platform (CDP), audience segmentation tools, and orchestration services. The system 700 enables the execution of personalized email campaigns by integrating data ingestion, content personalization, delivery scheduling, and performance reporting within a unified platform architecture.

The system 700 includes a plurality of computing components configured to perform operations for orchestrating, personalizing, delivering, and reporting email communications. These components include a customer data platform (CDP) 702, a platform database 704, a user store 706, a content personalization service 708, an email scheduler 710, a notification service 712, a distributed caching datastore 714 (e.g., Aerospike), an email builder 716, an email sender 718, an email context store 720, a work queue 722, an email reporting module 724, a report store 726, and a stats externalization service 728. Each component may be implemented by one or more computing devices (e.g., analytics server(s) 108).

The email communications service of the system 700 may be configured to operate as both a standalone module and an integrated component of a broader orchestration framework. The system 700 may receive user profile data, campaign metadata, and personalization rules from upstream services, and may execute operations for composing, transmitting, and tracking email messages across programmatic and non-programmatic channels. The system 700 may support asynchronous task execution, real-time personalization, and scalable delivery operations, enabling dynamic engagement with end-users based on contextual signals and campaign objectives.

A CDP 702, a platform database 704, and a content personalization service 708 may ingest, host, and provide various data resources for downstream email operations performed by the system 700. The CDP 702 aggregates and manages customer data, and the platform database 704 stores structured information required for campaign execution. A user store 706 maintains user profiles, segmentation data, and audience attributes, supporting targeted communications. A content personalization service 708 supplies personalized content and creative assets to the CDP 702, user store 706, email scheduler 710, and an email builder 716.

An email scheduler 710 receives input from the platform database 704, user store 706, CDP 702, and content personalization service 708. The email scheduler 710 is responsible for orchestrating the scheduling of email delivery events, determining optimal send times, and managing campaign content placement or content configurations. The email scheduler 710 also interfaces with a notification service 712, which generates and transmits notifications or alerts related to email operations, such as delivery confirmations or failure reports. The email scheduler 710 coordinates with a datastore 714, which provides high-performance, distributed caching for rapid access to campaign and user data. The datastore 714 supports the efficient retrieval of audience segments and campaign metadata during scheduling and execution.

The email builder 716 assembles email messages by integrating personalized content, templates, and dynamic elements, such that each email is tailored to the recipient's profile and campaign objectives. The email builder 716 transmits constructed email messages to an email sender 718. The email sender 718 is responsible for transmitting emails to designated recipients, leveraging an email context store 720 to access contextual information related to each campaign and user interaction. The email sender 718 also interacts with a work queue 722, which manages and distributes email sending and processing tasks to ensure reliable and scalable delivery. In some embodiments, the email context store 720 comprises a structured or schema-less data repository configured to store campaign-level and user-level metadata. The email context store 720 may include fields such as campaign identifiers, user engagement history, personalization parameters, and delivery constraints.

The work queue 722 may be implemented as a distributed task scheduler or message queue configured to support asynchronous execution of email sending operations. The work queue 722 may include prioritization logic, retry policies, and deduplication mechanisms to manage delivery reliability and throughput. The email sender 718 may queue, push, or update email transmission tasks into the work queue 722, which may then be consumed by worker processes responsible for executing delivery and logging outcomes.

The email sender 718 may query the email context store 720 to retrieve contextual attributes for rendering and transmitting personalized email messages. The email context store 720 may support real-time access and caching mechanisms to reduce latency during high-volume delivery operations.

An email reporting module 724 collects and aggregates data on email delivery, engagement, and campaign performance. The email reporting module 724 receives input from the email sender 718 and the work queue 722, generating comprehensive reports on key metrics such as open rates, click-through rates, and delivery outcomes.

A report store 726 serves as a repository for storing generated reports and analytics data. The report store 726 enables long-term retention and retrieval of campaign performance data for auditing, optimization, and compliance purposes.

A stats externalization service 728 exports statistical and reporting data from the report store 726 to external systems or dashboards. The stats externalization service 728 facilitates integration with business intelligence tools, enabling stakeholders to access and analyze campaign metrics beyond the core platform. The stats externalization service 728 may expose one or more APIs or message interfaces for exporting statistical data from the report store 726 to external systems. The exported data may include campaign performance metrics, delivery outcomes, and engagement statistics formatted in JSON, CSV, or other machine-readable formats. The stats externalization service 728 may support both batch exports and real-time streaming, enabling integration with business intelligence platforms, dashboards, or external analytics engines.

FIG. 8 illustrates operations and dataflow of a system 800 for performing operations of an identity service (e.g., identity service 424) within various hardware and software components, according to embodiments. The operations may be implemented within computing devices or other components of a system 100, such as an analytics server 108, databases, or other computing devices. The system 800 enables the aggregation, resolution, and activation of user identities across heterogeneous data sources, supporting privacy-compliant targeting and measurement. The identity service may include an identity engine 818 and a private identity engine 826, each configured to ingest and resolve identifiers from multiple sources and support downstream activation and analytics.

The system 800 includes a CDP 802, a customer relation management (CRM) datastores 804, third-party data providers 806, clean rooms 808, data management platforms (DMPs) 810, repositories of identity identifiers 812, topics data 814, and contextual data sources 816. These components provide input to the identity engine 818, which ingests probabilistic identifiers 820 and deterministic identifiers 822. A private identity engine 826 ingests client pixel data 824 and operates in privacy-sensitive environments. Resolved identities are used by a targeting engine 828 and a measurement engine 830. Clean rooms 832 and third-party vendors 834 receive output from the measurement engine 830 for privacy-compliant collaboration and analytics. Each component of the system 800 may be implemented using one or more computing devices executing software programming for performing the operations described herein. The dataflow relationships depicted in the system 800 illustrate the integration of multiple data sources, the resolution of identities using both probabilistic and deterministic methods, and the activation of unified identity data for targeting and measurement.

The identity service includes an identity engine 818 that aggregates incoming data and resolves user identities according to an identity data structure (e.g., database table, key-value store) mapping heterogenous types of user identifiers and unified user identifiers. The identity engine 818 supports the unification of user profiles across disparate channels and devices to generate unified user identifiers corresponding to unified user profiles implemented and stored in the system 800 for the CDP 802.

The CDP 802 comprises a structured data repository configured to store user identifiers, event records, and entity metadata. The CDP 802 may be implemented by an analytics server 108 and may include hardware and software components for ingesting, storing, and querying data from programmatic and non-programmatic channels and data sources. The CDP 802 supports downstream identity resolution and audience activation operations by providing unified access to user-related data.

The CRM datastore 804 includes software and hardware components configured to store customer relationship data, such as contact records, engagement history, and account-level attributes. The CRM datastore 804 may be integrated with the CDP 802 and may supply deterministic identifiers to the identity engine 818 for resolution and enrichment.

The third-party data provider systems 806 include external systems or services configured to supply licensed data attributes, such as demographic, behavioral, or business-to-business (B2B) information. The third-party data provider systems 806 includes hardware and software for hosting a third-party data service or application offered by third-party service providers or vendors, which may implement heterogenous user identifier conventions. The identity engine 818 or other components of the analytics server 108 may ingest data from these third-party data providers 806 to enrich the user data of the CDP 802 and/or the user data in the identity data structure maintained by the identity engine 818. The clean rooms 808 comprise privacy-preserving computing environments configured to support secure data collaboration between entities. The clean rooms 808 may isolate sensitive identity data and allow for controlled execution of identity resolution and audience activation operations without exposing raw identifiers.

The data management platforms (DMPs) 810 include external systems configured to aggregate behavioral signals and contextual attributes from programmatic channels. The DMPs 810 may supply various types of behavioral signal data. The repositories of identity identifiers 812 include structured data stores configured to maintain first-party and third-party identifiers 812, such as hashed emails, MAIDs, IP addresses, platform-specific identifiers, and device fingerprints, among others. These repositories may be queried by the identity engine 818 and the private identity engine 826 to support resolution operations.

The topics data 814 comprises contextual signals derived from third-party targeting services. These signals may include inferred interests, browsing categories, or content engagement patterns for the targeting engine 828. The analytics server 108 may ingest topics data 814 to support enrichment and targeting operations using user identifiers mapped to the unified user identifiers. The contextual data sources 816 include systems or services configured to supply environmental or situational attributes, such as time of day, location, or device type. These attributes may be used by the identity engine 818 to identify unified identifiers corresponding to the heterogenous user identifiers, and then be fed to the targeting engine 828 to personalize content delivery.

The identity engine 818 comprises software routines and a database configured to ingest, resolve, and unify user identifiers across disparate data sources. The identity engine 818 may maintain the identity data structure of heterogenous user identifiers and unified user identifiers. The identity engine 818 supports downstream targeting and measurement operations by generating unified user identifiers and/or unified user profiles. The various types of user identifiers from the corresponding data sources may be ingested by the identity engine 818 and mapped to the corresponding unified user identifiers using, for example, deterministic matching algorithms between the user identifiers or the various types of input data received with the user identifiers.

In some implementations, the identity engine 818 of the system 800 implements a private identity engine 826. The private identity engine 826 includes software routines and a database configured to operate in privacy-sensitive environments, such as handling user identity information from clean rooms 808. The private identity engine 826 maintains a client-specific or user-specific identity data structure and supports resolution and activation operations without exposing raw identifiers to external systems. The client pixel data 824 comprises event-level data captured from user interactions with digital properties, such as page views, clicks, or conversions. The pixel data 824 may be ingested by the private identity engine 826 and used to construct client-specific identity data structures.

The targeting engine 828 comprises software components configured to activate audience segments for personalized content delivery. The targeting engine 828 may receive resolved user identities from the identity engine 818 and apply rule-based logic to select users for programmatic or non-programmatic channel engagement. The measurement engine 830 (e.g., stats externalization service 432) includes software routines configured to attribute and analyze campaign performance. The measurement engine 830 may ingest engagement data for content data placements and resolved identities to generate metrics, such as reach, conversion rate, and lift.

The outputs of the measurement engine 830 may be transmitted from the analytics server 108 to the devices hosting the clean rooms 832 and/or third-party vendors 834. The clean rooms 832 receive output from the measurement engine 830 and support privacy-compliant data collaboration and analysis. These environments may allow external partners to access aggregated metrics without exposing individual-level identifiers. The third-party vendors 834 include external systems or services configured to receive resolved identities or aggregated metrics for audience activation, enrichment, or analytics. These vendors may operate under contractual and privacy constraints and may integrate with the system 800 via secure APIs.

The identity engine 818 may store the user identifiers or unified user identifiers into a database (e.g., platform datastore 404, status store 408, global store 422) of the system 800 accessible to the identity engine 818, where the identity engine 818 may reference the user identifiers and unified user identifiers to facilitate user targeting and addressing across multiple channels of the system 800.

As an example, the identity engine 818 of the analytics server 108 may execute one or more deterministic identifier algorithms to associate a unified user identifier with input data received from multiple data sources that implement heterogenous user identifiers. The deterministic identifier algorithms may include logic for parsing and normalizing user identifiers, such as email addresses, hashed email addresses, CRM IDs, and platform-specific third-party identifiers 812 of third-party systems. The identity engine 818 may store these interrelated user identifiers and unified identifier into the identity data structure.

FIG. 9 illustrates operations and dataflow of a system 900 for performing audience segmenting and audience builder operations within various hardware and software components, according to embodiments. The operations may be implemented within computing devices or other components of a system 100, such as an analytics server 108, databases, or other computing devices. The system 900 enables the construction, management, and refresh of audience segments by orchestrating dataflows among multiple components, including streaming pipelines, condition evaluators, and metadata stores. The audience builder may include a segment refresh engine 924, a segment updater stream 918, and a segment metadata store 910, each configured to evaluate segment conditions, publish membership updates, and persist refresh status and audience size metrics.

The system 900 includes a CDP 902 that receives inputs from various CDP data sources 904a-904n, including a global store 904a and one or more source pods 906b. These components provide input to an event stream 908, which carries condition update messages and list membership updates. An identity service 912 resolves user identifiers and associates incoming data with internal user records. An audience builder 914 consumes messages from the event stream 908 and evaluates conditions to determine segment membership (e.g., audience membership). The audience builder 914 may access a user cache 916 to retrieve previously matched conditions and reduce redundant queries to source pods. Segment membership data is persisted in a segment store 920, which acts as the source of truth for segment-to-user associations. A user store 922 stores condition match data keyed by user identifier and supports TTL-based expiry. A segment refresh engine 924 initiates periodic refresh operations by querying source pods for updated condition matches and coordinating updates to the segment store 920 and user store 922.

A CDP 902 serves as the central repository for aggregating and managing customer data. The CDP 902 may include one or more computing devices configured to ingest and store user-related data from various CDP data sources 904. The global store 904a may act as a centralized repository containing, for example, user profile attributes, list membership, and other persistent data. Each source pod 904b may be configured to ingest or communication various types of event data and emit event-based updates, such as behavioral signals or condition matches, to downstream consumer components of the system 900. The CDP 902 may normalize and persist incoming data and produce update events to an event stream 908.

The event stream 908 may be a distributed messaging system (e.g., Kafka®), configured to carry condition update messages, list membership changes, and other user-related signals. The event stream 908 may partition messages by user identifier and support multiple consumer groups. The event stream 908 may serve as the primary transport layer for incremental updates from source pods 904b to downstream processors, including an audience builder 914.

A segment metadata store 910 may include one or more databases configured to persist metadata associated with audience segments and conditions. The segment metadata store 910 may store refresh timestamps, processing status indicators, audience size estimates, and cached condition evaluations. The segment metadata store 910 may be used to coordinate refresh operations, prevent redundant processing, and increase visibility into the segment update pipeline.

An identity service 912 may include software components configured to resolve external identifiers (e.g., email addresses, hashed emails) into internal unified user identifiers. The identity service 912 may be invoked during segment conversion operations and may interact with a resolution service to generate platform-specific identifiers, according to an identity data structure that indicates mappings between heterogenous user identifiers to a unified user identifier.

In some embodiments, the audience builder 914 may include one or more computing devices configured to evaluate segment conditions and determine user membership. The audience builder 914 may consume messages from the event stream 908 and apply condition evaluation logic to determine whether a user satisfies the criteria for one or more segments. The audience builder 914 may publish segment membership updates to a segment updater stream 918 and may interact with a user store 922 and a segment store 920 to persist evaluation results.

A user cache 916 or other database (e.g., global store 904a) may include a key-value store or message queue configured to temporarily hold query results from source pods 904b. The user cache 916 may be used during segment refresh operations to buffer large data volumes and preserve intermediate results. The user cache 916 may support TTL-based expiry and may be used to track completion status of refresh operations.

The segment updater stream 918 may be a distributed messaging system configured to carry segment membership updates from the audience builder 914 to downstream consumer components. Each message on the segment updater stream 918 may include a segment identifier and a user identifier. The segment updater stream 918 may be consumed by orchestration engines, analytics services, or other components requiring real-time segment data.

The segment store 920 may include one or more databases keyed by segment identifier and configured to persist associations between users and segments. The segment store 920 may act as the source of truth for segment membership and may support range scans, TTL-based expiry, and secondary indexing. The segment store 920 may be updated during streaming and batch processing operations and may store metadata describing matched conditions and segment versions.

In some embodiments, the user store 922 may include one or more databases keyed by user identifier and configured to cache matched conditions and other evaluation results. The user store 922 may reduce the frequency of queries to source pods 904b by storing previously matched conditions. The user store 922 may support compound condition evaluation, TTL-based expiry, and metadata storage in formats (e.g., JSON).

In some implementations, a segment refresh engine 924 may include one or more computing devices configured to initiate periodic refresh operations for audience segments. The segment refresh engine 924 may consume refresh messages from a message queue and query source pods 904b for updated condition matches. The segment refresh engine 924 may coordinate updates to the segment store 920 and user store 922 and may apply logic to determine whether a condition has been recently refreshed.

In one example use case, the system 900 operates to facilitate real-time audience segmentation and activation for a marketing campaign. The CDP 902 aggregates user-related data from multiple CDP data sources 904, including behavioral events, profile attributes, and list membership updates. The global store 904a persists normalized profile information and segment associations, while source pods 904b ingest event data and emit updates into the event stream 908. The event stream 908 partitions messages by user identifier and propagates incremental condition updates to downstream processors, including the audience builder 914.

The audience builder 914 evaluates segment conditions based on incoming event messages, determining user membership for one or more audience segments. Segment membership updates are published to the segment updater stream 918, which transmits segment identifiers and corresponding user identifiers to orchestration engines and analytics services. The segment metadata store 910 maintains metadata such as refresh timestamps, processing status, and audience size estimates, coordinating segment refresh operations and persisting evaluation results.

The identity service 912 resolves external identifiers to internal unified user identifiers during segment conversion and audience activation workflows. The segment store 920 persists associations between users and segments, supporting range scans, TTL-based expiry, and secondary indexing for segment membership queries. The user store 922 caches matched conditions and evaluation results, reducing query frequency to source pods 904b and supporting compound condition evaluation.

During periodic segment refresh operations, the segment refresh engine 924 consumes refresh messages from a message queue, querying source pods 904b for updated condition matches. Updates to the segment store 920 and user store 922 are coordinated, maintaining up-to-date segment membership information and metadata describing matched conditions and segment versions. The user cache 916 buffers large data volumes and preserves intermediate results during segment refresh operations, supporting TTL-based expiry and completion status tracking for refresh tasks.

FIGS. 10A-10B show an example computing environment 1000 of hardware and software components implementing operations to establish, host, query, and update a CDP, according to an embodiment. In some embodiments, the environment 1000 includes a software platform system 1002, a customer data platform (CDP) application programming interface (API) 1004 for handling user profile data objects 1003 and related profile search queries, a global datastore 1005, deployable units 1006a-1006c of source pods (generally referred to as deployable units 1006 of source pods), and an email module 1008. The deployable units 1006 comprise computing hardware and software components for hosting and performing operations of source pod instances, which include hardware and software programming for pod data access layers 1009a-1090c (generally referred to as pod data access layers 1009) and pod datastores 1010a-1010c (generally referred to as pod datastores 1010). Each deployable units 1006 is configured for communicating and handling various types of data for various internal or external data sources. For example, the environment 1000 includes a first deployable unit 1006a for handling data for a first external service of a third-party service vendor, a second deployable unit 1006b data for a second external service of another third-party service vendor, and a third deployable unit 1006c for handling data for an internal database or data file. The email module 1008 comprises hardware and software programming for handling user data and email communications, which includes hardware and software programming for an email data access layer 1011 and a data mapping store 1013. In some embodiments, one or more of the elements of FIG. 10 can be the same as, similar to, or implemented by, one or more of the devices described in FIG. 1 such as, for example, analytics servers (e.g., that are the same as, or similar to, the analytics server 108 of FIG. 1) and/or one or more webservers (e.g., that are the same as, or similar to, the webservers 106 of FIG. 1).

The software platform 1002 can include one or more devices and/or one or more software and/or hardware modules that allow for the development, deployment, and execution of software applications. For example, the software platform 1002 can include a combination of hardware and software components, including operating systems, runtime environments, development frameworks, APIs, and services that facilitate application integration and interoperability. By providing essential tools such as libraries, compilers, and user interfaces, a software platform 1002 can support developers in creating applications across various programming languages. Additionally, the software platform 1002 can allow for scalability and customization options to meet specific business needs, allowing multiple applications to operate cohesively within a unified ecosystem. Examples of software platforms 1002 can include cloud services, operating systems, and application framework (e.g., . NET, Java Enterprise).

The software platform system 1002 includes hardware and software components configured to provide application interfaces (e.g., CDP API 1004) and orchestration logic for CDP operations. The software platform system 1002 hosts user profile data objects 1003, which represent normalized identity records aggregated from multiple sources. Each user profile data object 1003 may include user attributes, such as email address, name, and nested source-specific fields. These user profile data objects 1003 are processed and stored in a global datastore 1005 (as shown in FIG. 10B) for unified access and query execution.

Turning to FIG. 10B, the CDP API 1004 can include a set of programming interfaces that allow operating computing devices to interact with a CDP (not explicitly illustrated by FIGS. 10A-10B) to facilitate integration, management, and utilization of customer data across various applications and systems (e.g., the source pods of the deployable units 1006). The CDP API 1004 can allow for data ingestion from multiple sources, such as CRM systems, web analytics, etc., allowing for real-time or batch processing of customer interactions. The CDP API 1004 can support operations like creating, updating, and retrieving unified customer profile objects 1003, which aggregate behavioral, demographic, and transactional data into a single data schema or view. The CDP API 1004 provides programmatic access to the global datastore 1005 and supports operations for creating, retrieving, updating, and deleting user profile data objects 1003. The CDP API 1004 exposes endpoints for handling profile search queries and schema mapping logic, enabling external systems and internal modules to interact with the CDP in a standardized data schema or operational library.

Additionally, the CDP API 1004 can allow for the segmentation of customer data and the activation of marketing campaigns by sending targeted audience segments to external marketing tools. By providing standardized access to customer data, the CDP API 1004 can enhance data governance and enforce compliance with privacy regulations while allowing organizations to deliver personalized customer experiences.

Each deployable unit 1006 comprises computing hardware and software components for hosting and performing operations of source pod instances. The deployable units 1006 are configured to communicate with internal or external data sources and handle heterogeneous data formats. For example, the first deployable unit 1006a may interface with a first external service of a third-party vendor, the second deployable unit 1006b may interface with a second external service, and the third deployable unit 1006c may handle data from an internal database or file-based source.

The deployable units 1006 include source pods of deployable software modules that encapsulate one or more containers, local or shared storage of pod datastores 1010, and other network resources, to facilitate efficient application deployment and management. Each source pod 1006 can operate as a logical host for various containers, which are coupled and can communicate with each other via localhost, sharing the same IP address and port space. In some embodiments, source pods 1006 can be configured to be ephemeral that can be created, scaled, or destroyed dynamically based on application needs. The source pods 1006 can be managed by controllers, which can allow for high availability and scalability by automatically replicating deployable units 1006 as necessary.

Each source pod deployable unit 1006 includes a pod data access layer 1009 and a pod datastore 1010. The pod data access layers 1009 provide executable logic for retrieving, transforming, and normalizing source-specific data into a format compatible with the CDP schema(s), such as the data formatting for the user profile data objects 1003 or CDP API 1004. The pod datastores 1010 store ingested data records from the internal or external data source and maintain intermediate states for data synchronization with other components of the software platform 1002 (e.g., global datastore 1005) and error recovery. These components enable asynchronous ingestion and schema mapping across multiple source systems.

The computing environment 1000 also includes an email module 1008 configured to handle user data and email communications. The email module 1008 comprises software components of an email data access layer 1011 for retrieving and processing user attributes relevant to email campaigns and a data mapping store 1013 for maintaining segment definitions and personalization rules. The email module 1008 interacts with the CDP API 1004 to access normalized user profiles and supports downstream orchestration of personalized email workflows.

In some embodiments, the email data access layer 1011 of the email module 1008 can include software programming designed to facilitate sending, receiving, and managing email communications within an application or system. The email data access layer 1011 can provide a set of APIs that enable developers to integrate email functionality, allowing users to compose, send, and track emails programmatically. The email data access layer 1011 or other components of the email module 1008 can support various email protocols, such as SMTP (Simple Mail Transfer Protocol) for sending emails and IMAP (Internet Message Access Protocol) or POP3 (Post Office Protocol) for retrieving messages. Features can include support for HTML and plain text formatting, attachment handling, and user authentication mechanisms to ensure secure communication.

The email data access layer 1011 provides executable logic and APIs for performing operations, such as composing, sending, receiving, and tracking email messages. The email data access layer 1011 supports the various email protocols, including SMTP for outbound transmission and IMAP or POP3 for inbound retrieval. The email data access layer 1011 may also support formatting operations for HTML and plain text content, attachment handling, and user authentication mechanisms.

The data mapping store 1013 of the email module 1008 maintains metadata used for audience segmentation and content personalization. In some embodiments, the data mapping store 1013 stores segment definitions, rule sets, and personalization logic that govern the selection and rendering of email content. These rule sets may include conditional logic for resolving creative placeholders, fallback operations for incomplete user profiles, and delivery optimization parameters. The data mapping store 1013 interacts with the email data access layer 1011 by supplying campaign-specific configurations and personalization rules that are applied during message assembly and transmission.

The email module 1008 interacts with the CDP API 1004 to retrieve normalized user profile data objects 1003 from the global datastore 1005. These user profile data objects 1003 include behavioral, demographic, and transactional attributes that are used by the email data access layer 1011 and the data mapping store 1013 to personalize email content. The email module 1008 also supports downstream orchestration operations by integrating with orchestration services executed by devices of the environment 1000, which may include an analytics server 108. For example, the analytics server 108 may invoke the email module 1008 to deliver personalized content to users based on state transitions managed by a state management engine or based on matched conditions received from source pod deployable units 1006 (e.g., source pods 112). The orchestration logic may reference segment definitions and personalization rules stored in the data mapping store 1013 to determine eligibility and content selection for each email communication.

In an example use case, the pod data access layers 1009 executes logic for retrieving and transforming source-specific data into a format compatible with the schema of user profile data objects 1003. The pod datastore 1010 stores the ingested data records and maintains intermediate states for synchronization with the global datastore 1005. For example, the first deployable unit 1006a may interface with an ecommerce platform operated by a third-party vendor, the second deployable unit 1006b may ingest behavioral signals from an external email service, and the third deployable unit 1006c may process internal data files from enterprise systems.

The CDP API 1004 accesses the normalized data stored in the global datastore 1005 and exposes endpoints for querying, updating, and segmenting user profile data objects 1003. These profile objects are constructed from the data ingested by the source pod deployable units 1006 and may include demographic attributes, behavioral indicators, and transactional metadata. The software platform 1002 (which may be hosted on an analytics server 108) may execute orchestration logic operations that trigger downstream operations based on the data received from the source pods 1006. For instance, upon receiving a matched condition from a source pod deployment unit 1006 indicating that a user has initiated a checkout event, the analytics server 108 may promote the user to a new state in a state-based orchestration engine and initiate a personalized email campaign using the email module 1008.

In another example, the email module 1008 of the computing environment 1000 operates as a downstream component for orchestrating and executing personalized email communications according to the instructions and data objects 1003 received at the software platform 1002 via the CDP API 1004. The email data access layer 1011 receives or retrieves user attributes from normalized user profile data objects 1003 via the CDP API 1004 and supports operations for composing, sending, and tracking email messages. The email data access layer 1011 exposes APIs for integrating email functionality and supports protocols such as SMTP, IMAP, and POP3 for message transmission and retrieval. The data mapping store 1013 maintains metadata used for segment targeting and personalization logic. This includes segment definitions, rule sets, and delivery parameters that govern how email content is selected and rendered. During operation, the email module 1008 accesses the data mapping store 1013 to apply personalization rules to each email message, ensuring that the content is tailored to the recipient's profile and campaign objectives.

The analytics server 108 may execute orchestration logic that triggers email delivery based on matched conditions or state transitions. For example, upon detecting a user action such as an abandoned cart event, the analytics server 108 may promote the user to a new state and initiate an email campaign using the email module 1008. The email module 1008 then retrieves the relevant user data and personalization rules, assembles the email content, and transmits the message to the designated recipient. This orchestration flow enables dynamic, data-driven personalization and delivery of email communications across programmatic and non-programmatic channels.

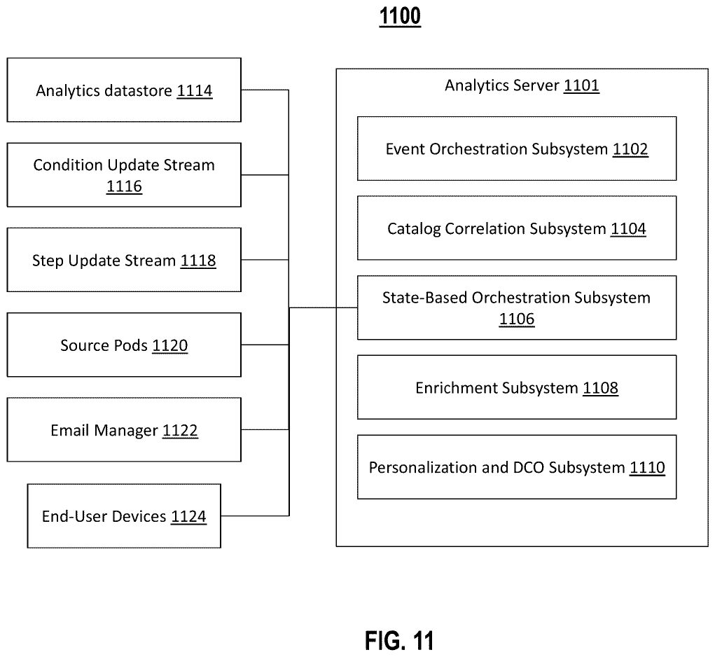

FIG. 11 shows components of a system 1100 for user-personalization and data enrichment using state-based operations using state-transition event triggers, according to embodiments. The system 1100 includes an analytics server 1101, an analytics datastore 1114, a condition update data stream 1116, a step update data stream 1118, source pods 1120, and an email manager server 1122. The analytics server 1101 includes an event orchestration engine 1102, a catalog correlation engine 1104, a state-based orchestration engine 1106, an enrichment engine 1108, and a personalization engine 1110 for dynamic creative optimization (DCO).

The analytics server 1101 may be implemented using the same or similar computing infrastructure as the analytics server 108 of FIG. 1. The analytics server 1101 includes hardware and software components configured to receive, process, and respond to data events originating from external sources (e.g., source pods 1120) and internal subsystems (e.g., orchestration logic). The analytics server 1101 orchestrates operations across multiple subsystems, including event ingestion, rule evaluation, catalog joining, enrichment, and personalization.

The event orchestration engine 1102 includes software routines for receiving event data from external systems, such as source pods 1120, and evaluating rule conditions associated with the event. The event orchestration engine 1102 may trigger operations based on matched conditions and supports universal event-based orchestration. The event orchestration engine 1102 receives condition update messages from the condition update data stream 1116 and step update messages from the step update data stream 1118. These messages may originate from user interactions tracked by webservers 106 or user devices 102 in FIG. 1.

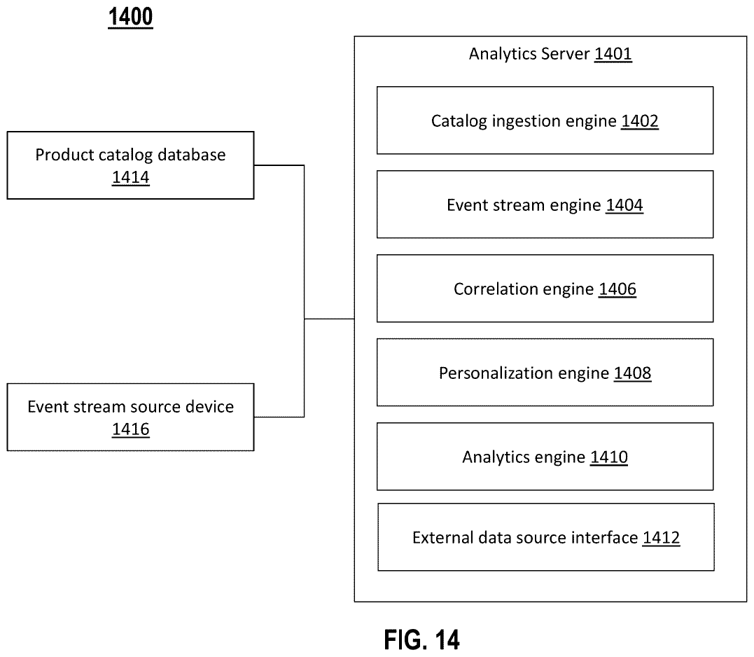

The catalog correlation engine 1104 includes software routines for joining behavioral event data with structured product catalog data. It receives product metadata from source pods 1120 and behavioral signals from the condition update data stream 1116. The engine applies rule-based logic to generate a composite user narrative that reflects cross-source engagement, which may be the same or similar to the catalog ingestion and correlation operations described in FIG. 14.

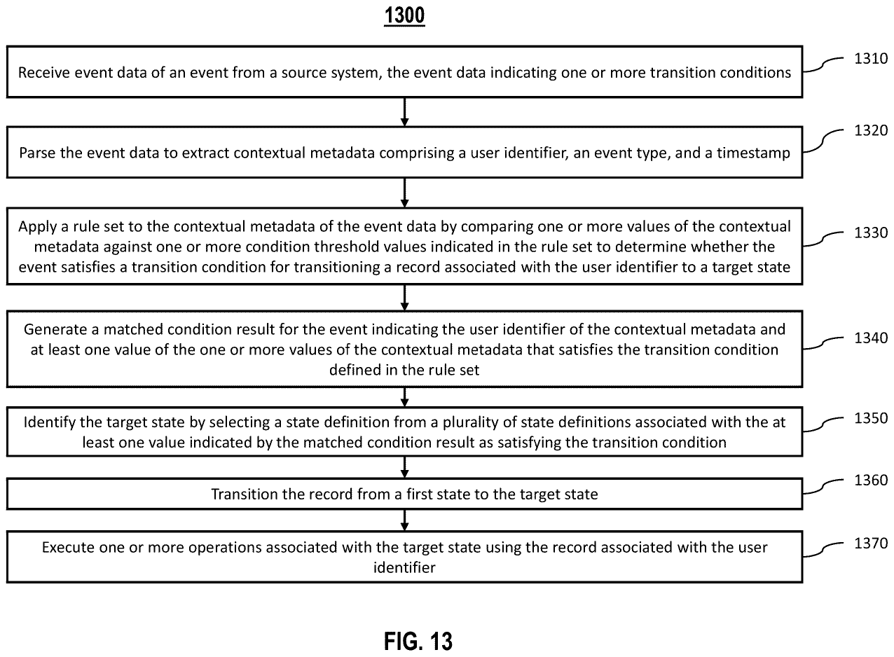

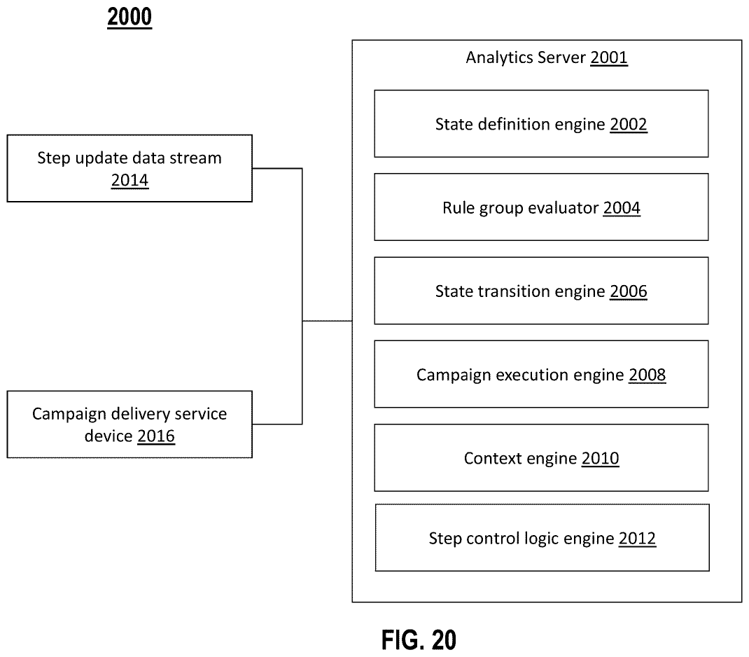

The state-based orchestration engine 1106 includes software routines for transitioning records between discrete states based on grouped rule conditions. The engine evaluates rule groups associated with a current state and promotes records to a next state when transition conditions are satisfied. This engine supports conditional branching, time-based delays, and frequency control logic, as described in FIG. 13 and FIG. 20.

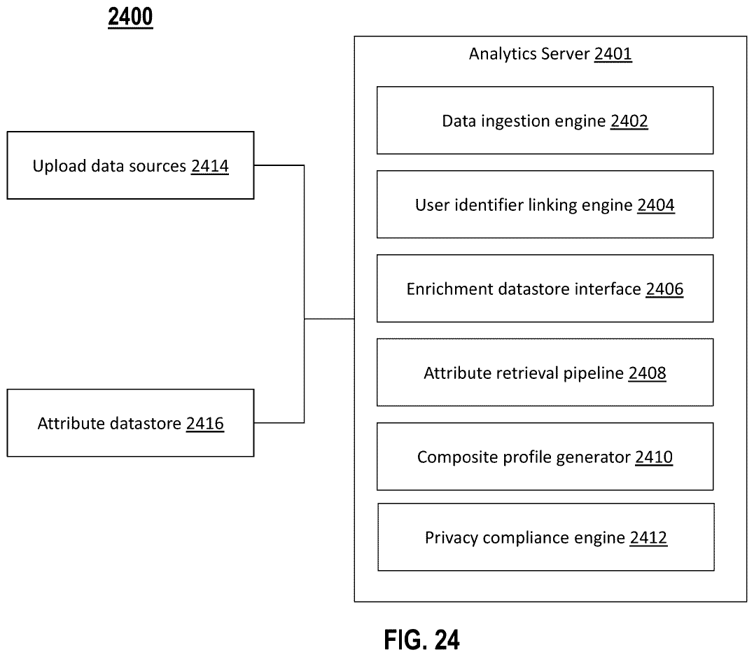

The enrichment engine 1108 includes software routines for linking uploaded data with third-party attribute datasets. It retrieves attributes from source pods 1120 and constructs composite profiles using a UID-based linkage pipeline. The engine applies time-bound logic to enforce privacy constraints and may interact with external data stores and enrichment APIs, as described in FIG. 24.

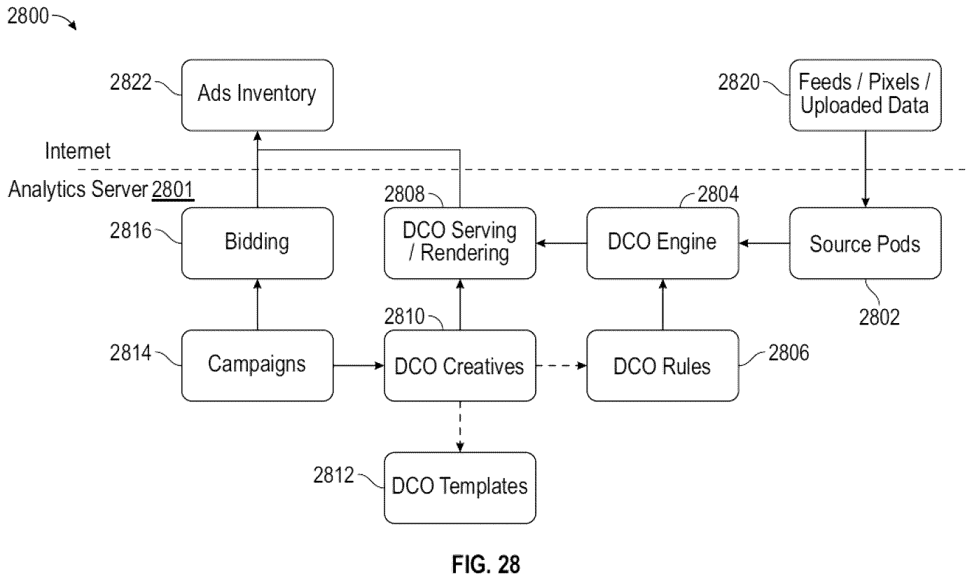

The personalization engine 1110 includes software routines for selecting and generating personalized creatives based on contextual signals. It receives user-specific, situational, and global signals from source pods 1120 and selects creative components using rule-based logic or machine learning models. The engine applies fallback logic and optimization strategies to deliver content via the email manager server 1122. These aspects of the personalization engine 1110 may be the same or similar to the personalization and DCO architecture described in FIG. 28.

The analytics datastore 1114 includes a persistent data store configured to receive and store metrics generated by the analytics server 1101. The database stores step-level performance metrics, rule evaluation outcomes, and delivery statistics. These metrics support downstream analytics and optimization.

The condition update data stream 1116 includes a message queue or event stream configured to receive condition update messages from source pods 1120. These messages may include matched condition results, contextual metadata, and trigger identifiers. The data stream transmits events to the event orchestration engine 1102 for evaluation and routing.

The step update data stream 1118 includes a message queue or event stream configured to receive step update messages from internal services. These messages may indicate state transitions, elapsed time, or external triggers. The data stream transmits step promotion events to the state-based orchestration engine 1106.

The source pods 1120 include external computing services configured to evaluate conditions and publish matched events. Each source pod 1120 may correspond to a distinct data origin, such as commerce platforms, email systems, or contextual signal providers. Source pods 1120 may operate in stateless or stateful configurations and support push-based or pull-based condition evaluation workflows. These pods may be the same or similar to the source pods 112 described in FIG. 1 and may transmit event data to the analytics server 1101 via the condition update data stream 1116.

The email manager server 1122 includes a computing service configured to deliver email messages based on instructions received from the analytics server 1101. The server enforces frequency caps, applies delivery constraints, and returns delivery status updates. It may operate as both an integrated and standalone component, supporting programmatic and non-programmatic delivery channels. Examples of these operations may include the email communications architecture described in FIG. 7.

### Universal Event-Based Orchestration Triggers

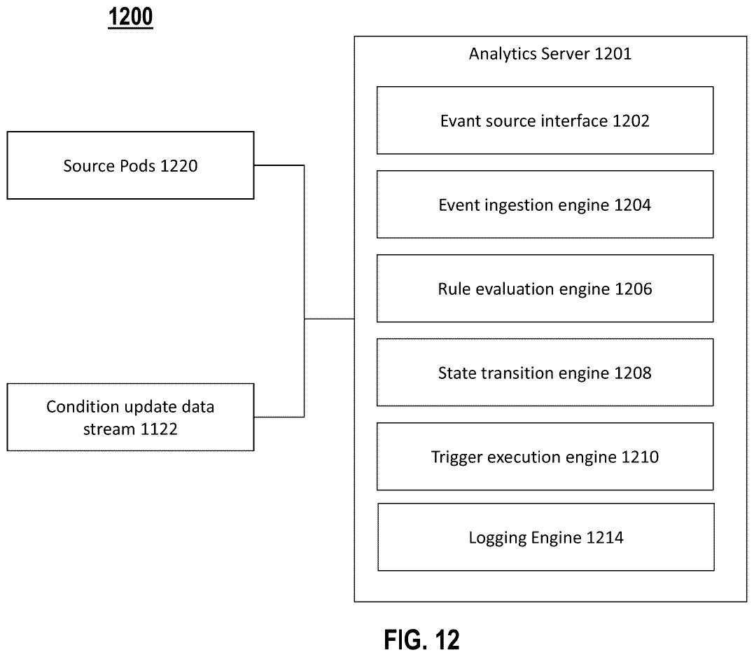

FIG. 12 shows dataflow amongst components of a system 1200, according to embodiments. The system 1200 includes an analytics server 1201, source pods 1220, and a condition update data stream 1222. The analytics server 1201 includes an event source interface 1202, an event ingestion engine 1204, a rule evaluation engine 1206, a state transition engine 1208, a trigger execution engine 1210, and a logging engine 1212.

The analytics server 1201 includes a computing device (e.g., analytics server 108) having various hardware and software processes for performing the operations described herein. The analytics server 1201 includes software and hardware configured to receive event data, evaluate rule conditions, transition records between states, execute triggers, and record audit logs.

The event source interface 1202 includes software programming routines for receiving event data from external sources, including source pods 1220. The event source interface 1202 may receive condition update messages formatted according to a predefined schema and may normalize the received data for downstream processing.

The event source interface 1202 includes software modules configured to receive condition update messages from various components of the system 1200, including source pods 1220 and data streams. The event source interface 1202 normalizes incoming messages according to a predefined schema and tags each message with metadata required for downstream orchestration. The interface supports both push-based and pull-based ingestion modes and may include logic for deduplicating events based on message identifiers derived from queues for messages and data sources, such as a queuing service.

The event ingestion engine 1204 includes software programming routines for parsing, validating, and queuing event data received via the event source interface 1202. The event ingestion engine 1204 may buffer event data in memory or a temporary store and may forward the data to the rule evaluation engine 1206 for further processing.

The event ingestion engine 1204 includes software routines for parsing, validating, and buffering normalized event data. The event ingestion engine 1204 stores incoming messages in a temporary queue and applies validation logic to confirm schema compliance and contextual completeness. The event ingestion engine 1204 may parse or shard messages across partitions based on a composite key comprising sub-advertiser ID, user ID type, and user ID, thereby enabling consistent consumption by downstream workers.

The rule evaluation engine 1206 includes software programming routines for evaluating rule conditions associated with the received event data. The rule evaluation engine 1206 may access rule groups stored in memory and may determine whether the event satisfies one or more conditions for triggering a state transition.

The rule evaluation engine 1206 includes software logic for evaluating rule groups associated with each event. The rule evaluation engine 1206 accesses rule definitions stored in memory and applies logical operators (e.g., AND, OR) to determine whether the event satisfies one or more conditions. The engine supports dynamic condition evaluation using contextual metadata, such as workflow start time or event-specific attributes, and may invoke external condition evaluation services when required.

The state transition engine 1208 includes software programming routines for promoting records between discrete states based on the outcome of rule evaluation. The state transition engine 1208 may update a state store and may propagate context data associated with the transition to downstream systems. The state transition engine 1208 supports conditional branching, time-based delays, and frequency control logic to regulate user progression.

The trigger execution engine 1210 includes software programming routines for executing one or more operations associated with a state transition. The trigger execution engine 1210 may invoke external services, initiate campaign delivery, or publish messages to other systems based on the current state of the record, such as publishing messages containing updates to various data streams. The trigger execution engine 1210 supports synchronous and asynchronous execution modes and may include retry logic with exponential backoff for fault tolerance. For example, the trigger execution engine 1210 may generate, queue, or reference an update to or from an event stream topic (e.g., Kafka topic) listing, or call an API exposed by a customer data platform (CDP) layer.

The logging engine 1212 includes software programming routines for recording audit logs associated with event ingestion, rule evaluation, state transitions, and trigger execution. The logging engine 1212 may write logs to a persistent store and may support querying and replay of historical events. Logged data may include workflow identifiers, step identifiers, condition match outcomes, and execution timestamps.

The source pods 1220 include external computing services configured to evaluate conditions and publish matched events. The source pods 1220 may include web-based or cloud-based third-party services, such as ecommerce websites or services, email delivery systems, or contextual signal providers. The source pods 1220 may transmit event data to the analytics server 1201 via the condition update data stream 1222.

The condition update data stream 1222 includes a message queue or event stream configured to transmit condition update messages from source pods 1220 to the analytics server 1201. The condition update data stream 1222 may support asynchronous communication and may deliver event data in real time or near real time.

FIG. 13 shows operations of a computer-implemented method 1300 for user-state orchestration based on event triggers, according to embodiments. The method 1300 may be executed by an orchestration engine of an analytics server or any other computer device configured to receive event data, evaluate rule conditions, and transition records between states based on matched conditions.

At operation 1310, the analytics server receives event data of an event from a source system, such as a source pod, a third-party integration service, or a data enrichment service device. The event may comprise a data upload, an enrichment operation, or a signal received from a contextual signal source device. The event data may include a trigger event identifier, a condition identifier, and contextual metadata. The event data may be transmitted via a condition update data stream configured to support asynchronous delivery and deduplication logic.

At operation 1320, the analytics server parses the event data to extract contextual metadata comprising a user identifier, an event type, and a timestamp. The parsing may be performed by an event ingestion engine that applies schema validation and normalization logic. The contextual metadata may include dynamic attributes such as workflow start time, product identifiers, behavioral tags, or uploaded attributes such as job title, company name, or other enrichment fields.

At operation 1330, the analytics server applies a rule set to the contextual metadata by comparing one or more values of the contextual metadata against one or more condition threshold values indicated in the rule set. The rule set may include a conditional operator, a data source identifier, and a comparison value. The orchestration engine may reference uploaded attributes to determine whether the event satisfies a transition condition for transitioning a record associated with the user identifier to a target state.

At operation 1340, the analytics server generates a matched condition result for the event. The matched condition result includes the user identifier and at least one value of the contextual metadata that satisfies the transition condition defined in the rule set. The orchestration engine may apply frequency control logic to exclude redundant entries into the target state. The matched condition result may be formatted for transmission to a step update data stream and may include metadata for downstream orchestration.

At operation 1350, the analytics server identifies the target state by selecting a state definition from a plurality of state definitions associated with the matched condition result. Each state definition may include rule groups, permissible operations, and transition metadata. The orchestration engine may execute conditional branching based on event metadata received from a source pod, and may select the target state based on a matched condition, a time delay, or a user action.

At operation 1360, the analytics server transitions the record from a first state to the target state. The first state may be a seed state, and the transition may be performed by promoting the record based on the matched condition. The orchestration engine may update a state store and propagate context data associated with the transition.

At operation 1370, the analytics server executes one or more operations associated with the target state using the record associated with the user identifier. The operations may include sending a message via a programmatic channel or a non-programmatic channel, updating a user profile, or modifying a segment membership. The orchestration engine may execute an event-triggering operation for either channel type and may log execution outcomes to a stats datastore or analytics datastore for performance tracking.

### Cross-Source Event and Entity Catalog Joining

FIG. 14 shows dataflow amongst components of a system 1400, according to embodiments. The system 1400 includes an analytics server 1401, a product catalog database 1414, and an event stream source device 1416. The analytics server 1401 includes a catalog ingestion engine 1402, event stream engine 1404, correlation engine 1406, personalization engine 1408, analytics engine 1410, and external data source interface 1412.

The analytics server 1401 includes a computing device (e.g., analytics server 108) having various hardware and software processes for performing the operations described herein. The analytics server 1401 includes software and hardware configured to receive structured product catalog data and behavioral event data, correlate the data using rule-based logic, generate user narratives, and output personalization and analytics metrics.

The catalog ingestion engine 1402 includes software programming routines for receiving structured product catalog data from the product catalog database 1414. The catalog ingestion engine 1402 may parse and normalize product metadata, including product identifiers, categories, and attributes, and store the data in a format suitable for correlation with behavioral events.

The event stream engine 1404 includes software programming routines for receiving behavioral event data from the event stream source device 1416. The event stream engine 1404 may process events such as page views, cart additions, and purchases, and may extract identifiers and contextual metadata for use in downstream correlation.

The correlation engine 1406 includes software programming routines for joining behavioral event data with structured product catalog data. The correlation engine 1406 may apply rule-based logic to associate events with catalog entities and may generate a user narrative that describes the user's interaction with products over time.

The personalization engine 1408 includes software programming routines for generating personalized content based on the user narrative produced by the correlation engine 1406. The personalization engine 1408 may select product recommendations, content modules, or creative components based on inferred user preferences and behaviors.

The analytics engine 1410 includes software programming routines for computing metrics based on correlated event and catalog data. The analytics engine 1410 may generate reports, dashboards, or real-time metrics describing user engagement, product performance, and conversion trends.

The external data source interface 1412 includes software programming routines for communicating with external systems, including the product catalog database 1414 and the event stream source device 1416. The external data source interface 1412 may support synchronous or asynchronous data exchange and may include authentication and data validation logic.

The product catalog database 1414 includes a structured data store containing product metadata. The product catalog database 1414 may include tables or documents describing product identifiers, categories, attributes, pricing, and availability. The product catalog database 1414 may be updated periodically or in real time.

The event stream source device 1416 includes a computing system configured to publish behavioral event data. The event stream source device 1416 may include third-party services (e.g., commerce platforms) and may transmit event data to the analytics server 1401 via a message queue or streaming protocol.

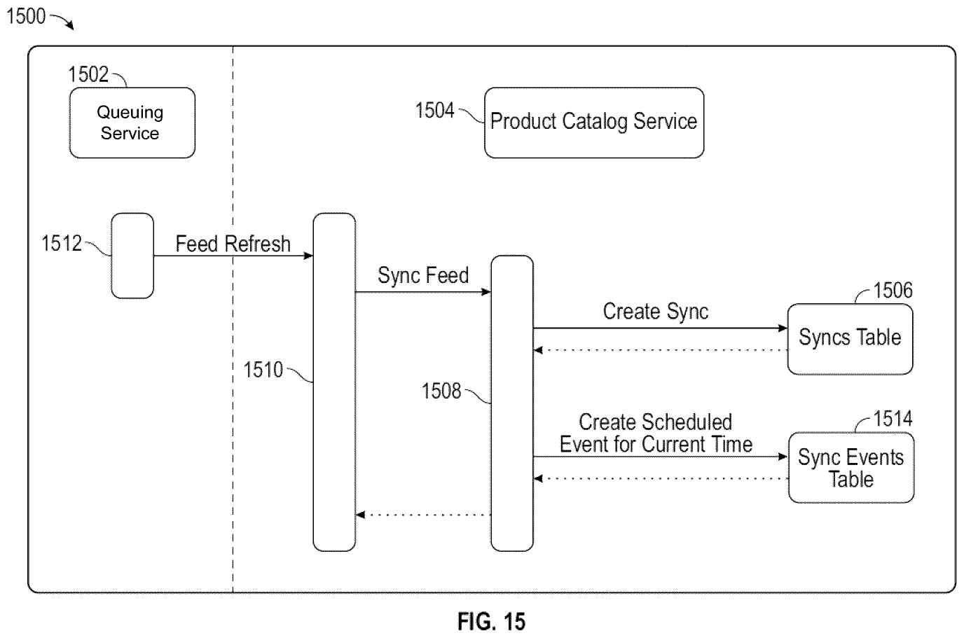

FIG. 15 shows dataflow amongst components of a system 1500 performing a feed refresh operation, according to embodiments. The system 1500 includes a queuing service message queue 1502 associated with and managed by software routines of a queuing service, a product catalog service 1504, a sync table 1506, a sync dispatcher 1508, a sync worker 1510, a product data normalizer 1512, and a products table 1514.

The queuing service message queue 1502 receives a refresh directive for a feed. The refresh directive may include metadata such as a feed identifier, sync frequency, and schema mapping information. The product catalog service 1504 interprets the directive and initiates a sync operation by creating a sync record in the sync table 1506. The product catalog service 1504 may also interface with a catalog ingestion engine 1402 of system 1400 to propagate updated feed metadata and schema mappings for downstream correlation operations.

The sync table 1506 stores metadata associated with the sync operation, including the feed identifier, scheduled execution time, and sync status. The sync dispatcher 1508 monitors the sync table 1506 and assigns the sync job to an available sync worker 1510. The sync dispatcher 1508 may apply concurrency limits, prioritization logic, and retry policies when dispatching jobs.

The sync worker 1510 retrieves product data from an external feed source. The product data may include structured metadata such as product identifiers, titles, image URLs, click URLs, and custom attributes. The sync worker 1510 may retrieve feed data via HTTP, FTP, or other supported protocols, and may apply authentication and schema validation logic prior to ingestion. The retrieved product data may be formatted to align with catalog entity records stored in a product catalog database 1414 of system 1400, enabling subsequent correlation with behavioral event data.

The product data normalizer 1512 transforms the retrieved product data into a format suitable for ingestion. The product data normalizer 1512 may apply schema mapping logic, field-level transformations, type coercion, and attribute filtering based on a schema defined at feed creation. The normalized data is stored in the products table 1514. The normalized product data may be structured to support join operations performed by a correlation engine 1406 of system 1400, which associates catalog entities with behavioral events to generate composite user narratives.

The products table 1514 stores normalized product records, including required fields such as product ID, title, image URL, and click URL, as well as optional fields such as category, brand, and price. The products table 1514 supports flexible schema definitions and includes a JSON field for custom attributes. The products table 1514 may be indexed by feed ID and product ID to support efficient lookup and join operations. The products table 1514 may be queried by an event stream engine 1404 of system 1400 to retrieve catalog attributes for personalization and analytics operations.

The system 1500 enables asynchronous, state-based orchestration of product catalog synchronization operations. The system 1500 supports scalable ingestion of external product data across heterogeneous feed formats and provides visibility into sync lifecycle, execution outcomes, and product-level transformations.

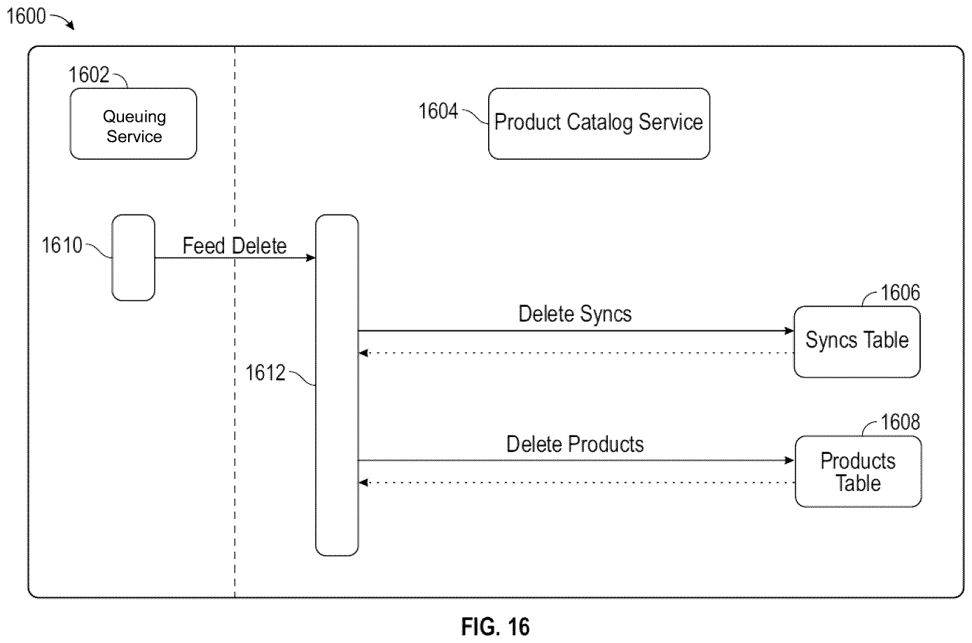

FIG. 16 shows dataflow amongst components of a system 1600 performing a feed deletion operation, according to embodiments. The system 1600 includes a queuing service message queue 1602, a product catalog service 1604, a sync table 1606, a products table 1608, an entity cache 1610, and a rule cache 1612.

The queuing service message queue 1602 receives a deletion directive for a feed. The deletion directive may include metadata such as a feed identifier, deletion scope, and purge flags. The product catalog service 1604 interprets the directive and initiates a deletion operation by removing the corresponding sync record from the sync table 1606. The product catalog service 1604 may also interface with a catalog ingestion engine 1402 of system 1400 to propagate deletion metadata and schema invalidation signals for downstream correlation components.

The sync table 1606 stores metadata associated with feed synchronization operations. During a deletion operation, the product catalog service 1604 removes sync records associated with the feed identifier, thereby disabling future ingestion and refresh operations for the deleted feed.

The products table 1608 stores normalized product records associated with one or more feeds. The product catalog service 1604 purges product records indexed by the deleted feed identifier. The purge operation may include deletion of required fields (e.g., product ID, title, image URL) and optional fields (e.g., category, brand, price), as well as removal of custom attributes stored in JSON format. The products table 1608 may be queried by an event stream engine 1404 of system 1400 to verify deletion completeness and to suppress personalization operations for the deleted feed.

The entity cache 1610 stores cached product entities used for low-latency personalization and analytics operations. The product catalog service 1604 invalidates entity cache entries corresponding to the deleted feed. The invalidation may be performed by a metadata service that tracks product usage and applies TTL-based expiration policies. In some embodiments, the metadata service updates a cached products table to reflect the deletion timestamp and purge status.

The rule cache 1612 stores precomputed rule evaluation results used for dynamic content rendering. A rule evaluation worker removes rule entries referencing the deleted feed from the rule cache. The rule evaluation worker may also update a rule_processing_statuses table to reflect the deletion state and suppress future refresh operations. The rule cache may be queried by a creative rendering engine to verify rule availability and to apply fallback logic when feed-specific rules are no longer valid.

The system 1600 enables asynchronous, state-based orchestration of feed deletion operations. The system 1600 supports scalable purging of feed-specific data across ingestion, normalization, caching, and personalization subsystems, and provides visibility into deletion lifecycle, propagation outcomes, and cache invalidation status.

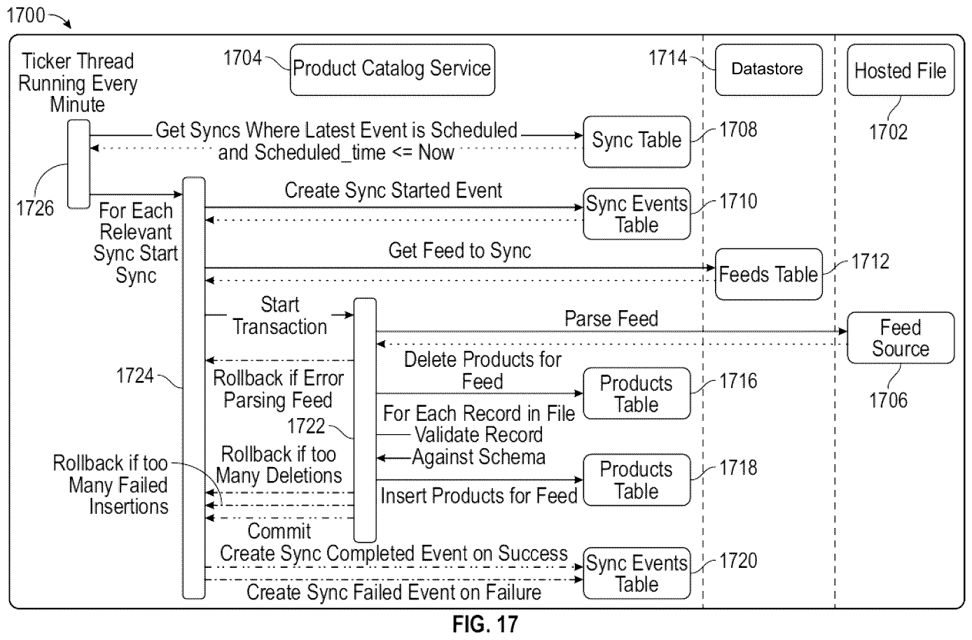

FIG. 17 shows dataflow amongst components of a system 1700 performing a feed synchronization operation, according to embodiments. The system 1700 includes a hosted file 1702, a product catalog service 1704, a feed source 1706, a sync table 1708, a sync events table 1710, a feeds table 1712, a datastore 1714, one or more products tables 1716, 1718, one or more sync events tables 1710, 1720, a feed metadata extractor 1722, a sync record generator 1724, and a sync event dispatcher 1726.

The hosted file 1702 stores structured product data uploaded by a user or retrieved from an external source. The feed source 1706 represents the origin of the feed, which may be a public URL, a partner integration, or a user-uploaded file. The feed metadata extractor 1722 parses the hosted file 1702 and extracts metadata such as feed identifier, schema mapping, and ingestion parameters. These metadata fields correspond to the schema mapping logic and feed identifiers described in system 1400 of FIG. 14.

The product catalog service 1704 receives the extracted metadata and invokes the sync record generator 1724 to create a sync record in the sync table 1708. The sync record includes scheduling information, ingestion status, and schema mappings. The product catalog service 1704 also inserts feed metadata into the feeds table 1712 and propagates schema definitions to the datastore 1714 for downstream correlation operations. These operations correspond to the catalog ingestion engine 1402 and product catalog database 1414 of system 1400.

The sync event dispatcher 1726 monitors the sync table 1708 and routes sync events to the sync events tables 1710, 1720. These sync events tables 1710, 1720 store event-level metadata associated with feed synchronization, including timestamps, status flags, and error codes. The sync events may be used to trigger downstream rule evaluation or cache refresh operations, as described in the event stream engine 1404 and correlation engine 1406 of the system 1400.

The products tables 1716, 1718 store normalized product records ingested from the hosted file 1702. These records include required fields such as product ID, title, image URL, and click URL, as well as optional fields such as category, brand, and price. The products tables 1716, 1718 support flexible schema definitions and include a JSON field for custom attributes. The products tables 1716, 1718 may be indexed by feed ID and product ID to support efficient lookup and join operations. These products tables 1716, 1718 may correspond to the product catalog database 1414 and the entity-level data storage used by the correlation engine 1406 in system 1400.

The system 1700 enables asynchronous, metadata-driven orchestration of feed synchronization operations. The system 1700 supports scalable ingestion of external product data across heterogeneous feed formats and provides visibility into sync lifecycle, schema propagation, and product-level transformations. The components of the system 1700 may operate in coordination with the components of the system 1400 to support rule evaluation, entity enrichment, and dynamic content personalization.

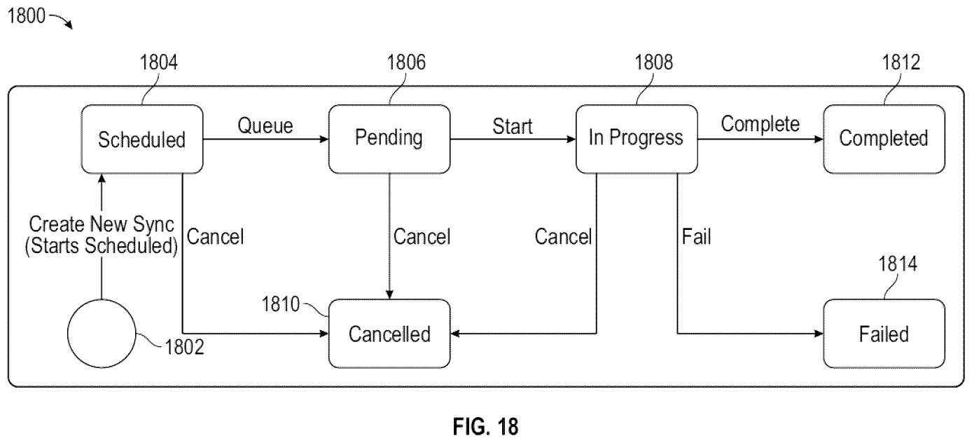

FIG. 18 illustrates a computer-implemented method 1800 for managing the lifecycle of a synchronization function within a data ingestion system. The method 1800 includes a sequence of operations executed by one or more computing devices, such as an analytics server or catalog ingestion service, configured to orchestrate feed synchronization tasks across distributed data sources.

At operation 1802, the computing device receives a request for a sync function. The request may originate from a message queue of a messaging service (e.g., notification service or queuing service topic or messaging non-transitory data storage), and may include metadata such as a feed identifier, sync frequency, and schema mapping configuration. The request may be formatted as a JSON payload and transmitted via an asynchronous protocol.

At operation 1804, the computing device generates and schedules the sync function. The sync function is instantiated in a scheduled state and assigned a designated execution time. The computing device may insert a sync record into a sync status table, which includes fields for feed ID, scheduled timestamp, execution status, and error flags. The sync record may be indexed for efficient lookup and retrieval.

At operation 1806, the computing device places the sync function into a queue for dispatch. The queue may be implemented using a distributed task scheduler or job dispatcher, which monitors the sync status table and assigns sync jobs to available workers. The dispatcher may apply concurrency limits, prioritization logic, and retry policies when dispatching jobs.

At operation 1808, the computing device executes a worker to retrieve and process the sync function. The worker may access external feed sources via HTTP, FTP, or other supported protocols, and may retrieve structured product data comprising product identifiers, titles, image URLs, click URLs, and custom attributes. The worker may apply schema validation and transformation logic prior to ingestion.

At optional operation 1810, the computing device cancels the sync function. Cancellation may be triggered by a user directive, error condition, or system shutdown. The computing device may update the sync status table to reflect a canceled state and may purge associated metadata from temporary storage.

At operation 1812, the computing device completes the sync function. Completion may include updating the sync status table to reflect a completed state, recording a timestamp of completion, and publishing a completion event to a message queue. The completion event may include metadata for downstream orchestration and analytics.

At optional operation 1814, the computing device fails to complete the sync function. Failure may result from a network error, schema mismatch, or data retrieval timeout. The computing device may update the sync status table to reflect a failed state and may reschedule the sync function for retry based on a retry policy or error classification. The system may log error codes and diagnostic metadata for auditing and debugging.

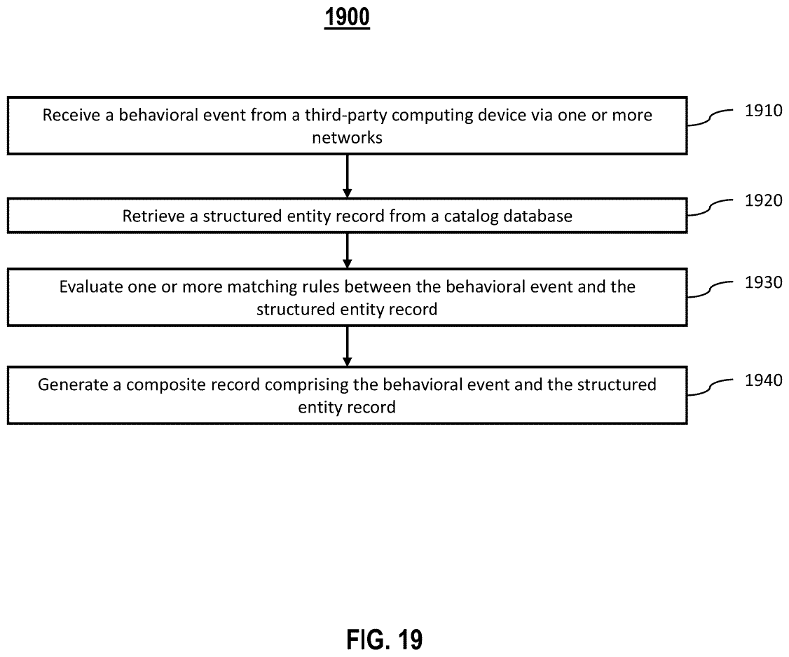

FIG. 19 shows operations of a computer-implemented method 1900 for generating personalized composite records for cross-source events using behavioral events and structured catalog data, according to embodiments. The method 1900 may be executed by a computing device, such as an analytics server, configured to correlate behavioral signals with structured metadata for downstream personalization and analytics.

At operation 1910, the analytics server receives a behavioral event from a third-party computing device via one or more networks. The behavioral event may comprise a product view, a cart addition, or a purchase action received via a pixel-based integration with a commerce platform. The behavioral event may include event attributes such as a timestamp, a user identifier, and a product identifier.

At operation 1920, the analytics server retrieves a structured entity record from a catalog database. The structured entity record may include a product identifier, a product image URL, a product category, and other catalog metadata. In some embodiments, the catalog database supports schema-less storage of product attributes in a key-value format, enabling flexible ingestion of heterogeneous catalog structures.

At operation 1930, the analytics server evaluates one or more matching rules between the behavioral event and the structured entity record. The analytics server may execute a rule engine configured to correlate event attributes with catalog metadata. In some cases, the analytics server performs a catalog joining operation using schema-less mapping logic to associate behavioral events with catalog entities. The catalog may include non-product entities such as course catalogs or service listings.

At operation 1940, the analytics server generates a composite record comprising the behavioral event and the structured entity record. The composite record may include a timestamp, a user identifier, and a reference to the matched entity. The composite record may be used to generate a personalized recommendation for a user or to identify trending entities based on real-time behavioral signals. In some embodiments, the structured entity record is retrieved from a remote feed, and the composite record is stored in a segment store for use by personalization engines or audience segmentation engines.

### State-Based Orchestration Engine with Rule Groups

FIG. 20 shows dataflow amongst components of a system 2000, according to embodiments. The system 2000 includes an analytics server 2001, a step update data stream 2014, and a campaign delivery service 2016. The analytic server 2001 includes a state definition engine 2002, rule group evaluator 2004, state transition engine 2006, campaign execution engine 2008, context propagation engine 2010, and step control logic 2012.

The analytics server 2001 executes software programming routines for transitioning records between discrete states based on grouped rule conditions, executing operations associated with state transitions, and propagating context across orchestration steps. The analytics server 2001 may receive step update messages from the step update data stream 2014 and may transmit delivery instructions to the campaign delivery service 2016.

The analytics server 2001 includes a computing device (e.g., analytics server 108) having various hardware and software processes for performing the operations described herein. The analytics server 2001 includes software and hardware configured to define orchestration states, evaluate rule groups, transition records between states, execute campaign operations, and propagate context across orchestration steps.

The state definition engine 2002 of the analytics server 2001 includes software programming routines for defining discrete orchestration states. The state definition engine 2002 may store metadata describing each state, including associated rule groups, transition conditions, and permissible operations.

The rule group evaluator 2004 of the analytics server 2001 includes software programming routines for evaluating grouped rule conditions associated with a current state. The rule group evaluator 2004 may determine whether a record satisfies the conditions for transitioning to a next state.

The state transition engine 2006 of the analytics server 2001 includes software programming routines for promoting records between states based on the outcome of rule evaluation. The state transition engine 2006 may update a state store and may trigger downstream operations associated with the new state.

The campaign execution engine 2008 of the analytics server 2001 includes software programming routines for executing operations associated with a current state. The campaign execution engine 2008 may transmit delivery instructions to the campaign delivery service 2016 and may record execution outcomes.

The context propagation engine 2010 of the analytics server 2001 includes software programming routines for propagating context data between orchestration steps. The context propagation engine 2010 may maintain continuity across state transitions and may support conditional logic based on prior state history.

The step control logic 2012 (e.g., step blocking logic, state resumption logic) of the analytics server 2001 includes software programming routines for controlling the execution of orchestration steps. The step control logic 2012 may block execution of a step until prerequisite conditions are satisfied and may invoke and resume execution when the conditions are met.

The step update data stream 2014 includes a message queue or event stream configured to transmit step update messages to the analytics server 2001. The step update data stream 2014 may include messages indicating elapsed time, external triggers, or completion of prerequisite steps.

The campaign delivery service 2016 includes a computing system configured to deliver content based on instructions received from the analytics server 2001. The campaign delivery service 2016 may include email servers, ad servers, or other delivery mechanisms and may return delivery status updates to the analytics server 2001.

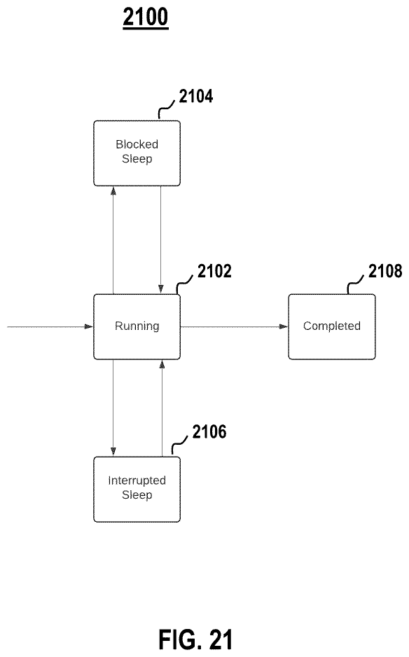

FIG. 21 is a diagram that shows internal states of a system 2100 for promoting a user between steps of a rule group. The system 2100 includes a running state 2102, a blocked state 2104, an interrupted state 2106, and a completed state 2108. In the running state 2102, the system 2100 executes step logic, such as evaluating a condition or invoking an external service. In the blocked state 2104, the system 2100 pauses execution of the step pending satisfaction of a time delay or external condition. In the interrupted state 2106, the system 2100 halts execution of the step due to an error or shutdown. In the completed state 2108, the system 2100 successfully executes the step and promotes the user to a subsequent step. The system 2100 may persist the blocked state 2104 and the interrupted state 2106 to a database to support fault-tolerant resumption. The running state 2102 and the completed state 2108 are included for logical completeness but are not persisted. Transitions between states may be triggered by internal timers, external signals, or retry logic.

The system 2100 may be implemented as part of a rule group orchestration engine described in FIG. 20, where rule groups are evaluated to determine user eligibility for promotion between steps. The state transitions shown in FIG. 21 may be invoked by the orchestration logic of FIG. 20 in response to rule evaluations, segment updates, or external events. Additionally, the system 2100 may operate in coordination with the analytics server 108 of FIG. 1, which may include a rule evaluation engine and a segment store. A rule evaluation engine may trigger transitions into the running state 2102 or the completed state 2108, while the segment store may persist blocked state 2104 or interrupted state 2106 for later resumption.

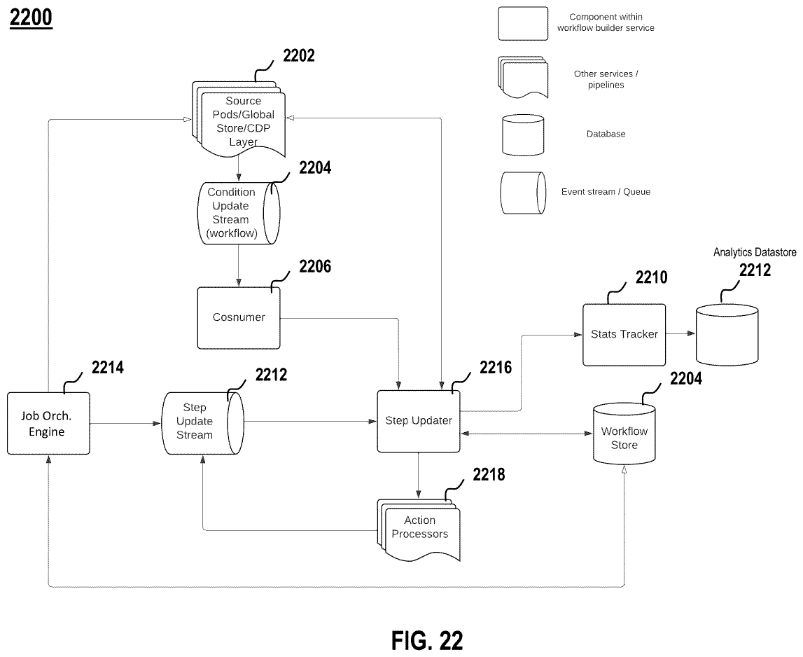

FIG. 22 illustrates a system 2200 comprising a modular orchestration architecture for transitioning records between discrete states based on grouped rule conditions and event triggers, according to embodiments. The system 2200 includes computing components configured to receive condition updates, evaluate rule logic, execute actions, and persist orchestration state. The system 2200 operates in an event-driven manner, enabling scalable and fault-tolerant orchestration across heterogeneous data sources and external services. In some embodiments, system 2200 may be implemented by or in coordination with an analytics server 108 of FIG. 1 and an analytics server 2001 of FIG. 20.

The system 2200 includes data sources 2202, which may include source pods 112 of FIG. 1, global datastores, and a customer data platform (CDP) layer. Each data source 2202 may be configured to evaluate one or more conditions associated with user activity, system events, or external signals. A data source 2202 may receive input data in the form of event payloads, user identifiers, contextual metadata, or dynamic attributes. In response to condition evaluation, a data source 2202 may transmit matched condition messages to a condition update data stream 2204. In some embodiments, a data source 2202 may operate in a stateless or stateful manner and may expose a shared API interface for condition evaluation, similar to the source pods 112 described in FIG. 1.

The condition update data stream 2204 comprises a message queue or event stream configured to receive condition update messages from the data sources 2202. Each message may include a matched condition identifier, a user identifier, and associated context data. The condition update data stream 2204 may correspond to the condition update data stream 1116 of FIG. 11. In some embodiments, the condition update data stream 2204 may support asynchronous communication, deduplication logic, and partitioning based on composite keys. The output of the condition update data stream 2204 may be consumed by a consumer function 2206.

The consumer function 2206 includes software programming routines for consuming condition update messages and constructing step update requests. A consumer function 2206 may parse incoming messages, validate schema compliance, and extract relevant metadata for orchestration. The consumer function 2206 may generate a step update request comprising a workflow identifier, a workflow instance identifier, a step identifier, and context data. The consumer function 2206 may transmit the step update request to a step update data stream 2216, which serves as an orchestration queue for promoting records between states. In some embodiments, the consumer function 2206 may operate in coordination with the event ingestion engine 1204 and rule evaluation engine 1206 of FIG. 12.

The step update data stream 2216 comprises a message queue or event stream configured to receive step update requests from the consumer function 2206 and a job orchestration engine 2214. Each step update request may include a user identifier, a workflow instance identifier, a current step identifier, and a rule type. The step update data stream 2216 may correspond to the step update data stream 1118 of FIG. 11. In some embodiments, the step update data stream 2216 may support synchronous or asynchronous delivery, retry logic, and partitioning based on user identifiers.

A step updater function 2208 consumes step update requests from the step update data stream 2216 and executes rule evaluation logic. The step updater function 2208 may evaluate grouped rule conditions, determine eligibility for state transitions, and promote records to subsequent steps. The step updater function 2208 may invoke one or more action process functions 2218 to execute operations associated with the current state. The step updater function 2208 may persist orchestration state to a workflow function datastore 2220 when a step is blocked or interrupted. In some embodiments, the step updater function 2208 may implement the rule group evaluator 2004, state transition engine 2006, and campaign execution engine 2008 of FIG. 20. Input data may include rule definitions, condition match results, and context metadata; output data may include updated state records, action execution requests, and metrics.

The action process functions 2218 include external computing services configured to execute operations associated with orchestration steps. Each action process function 2218 may expose an API or event interface for receiving execution instructions and returning completion status. Examples of action process functions 2218 include an email manager server 1122 as in the system 1100 of FIG. 11, a CDP list update service, or a programmatic campaign manager. Input data may include hashed user identifiers, workflow metadata, and action parameters; output data may include delivery confirmations, error codes, or matched condition events. Completion messages may be transmitted to the condition update data stream 2204 to trigger subsequent orchestration steps.

A job orchestration engine 2214 periodically queries or polls the workflow function datastore 2220 to identify workflow instances eligible for resumption. The job orchestration engine 2214 may evaluate time-based criteria, error recovery conditions, or external triggers to determine eligibility. Upon identifying an eligible instance, the job orchestration engine 2214 may issue a step update request to the step update data stream 2216. In some embodiments, the job orchestration engine 2214 may operate in coordination with the step control logic 2012 of FIG. 20 and may invoke and resume execution of steps in the blocked state 2104 or interrupted state 2106 of FIG. 21. Input data may include timestamps, workflow instance metadata, and state context; output data may include step update requests and audit logs.

A stats tracker function 2210 monitors orchestration activity and generates metrics describing workflow-level and step-level performance. The stats tracker function 2210 may track entry counts, completion counts, unique user counts, and point-in-time waiting counts. Metrics may be aggregated by workflow identifier, step identifier, and time granularity. The stats tracker function 2210 may transmit metrics to an analytics datastore 2212, which may correspond to the analytics datastore 1114 of FIG. 11. Input data may include step transition events, action execution results, and workflow metadata; output data may include structured metric records and performance dashboards.

The analytics datastore 2212 includes a structured database configured to store metrics generated by the stats tracker function 2210. The analytics datastore 2212 may support aggregation, filtering, historical analysis, and TTL-based expiry. In some embodiments, the analytics datastore 2212 may be implemented using a relational database, a time-series database, or a distributed key-value store. Stored data may include workflow identifiers, step identifiers, metric types, timestamps, and counts.

The workflow function datastore 2220 includes a persistent data store configured to maintain workflow instance metadata, current step identifiers, internal orchestration states, and context data required for condition evaluation and resumption. The workflow function datastore 2220 may store records in a format that supports atomic updates, fault-tolerant resumption, and dynamic context propagation. Input data may include workflow entry events, step transition results, and context metadata; output data may include state recovery records, context enrichment data, and eligibility flags. In some embodiments, the workflow function datastore 2220 may support indexing by user identifier, workflow identifier, and step identifier, and may operate in coordination with the orchestration engine 1106 of FIG. 11 and the analytics server 108 of FIG. 1.

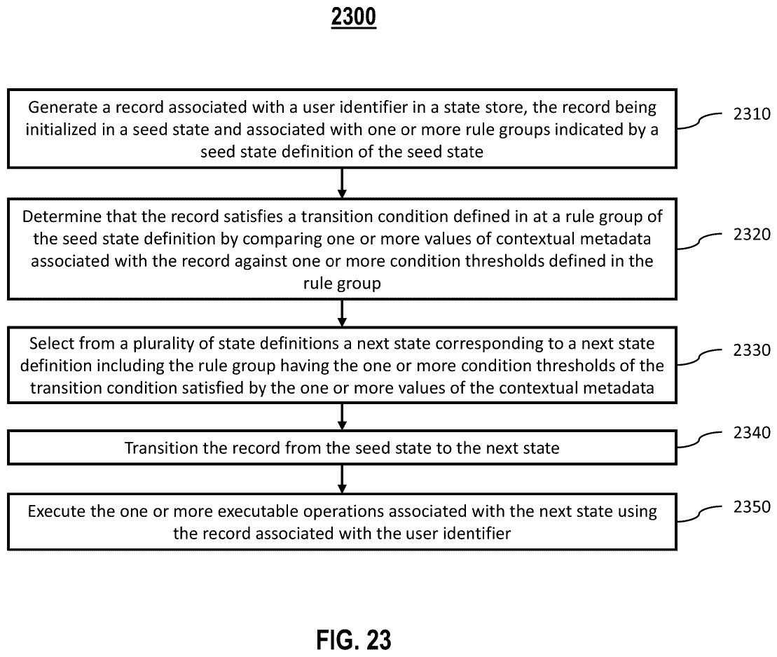

FIG. 23 shows operations of a computer-implemented method 2300 of automating state-based operational orchestration using state transitions, according to embodiments. The method 2300 may be executed by a compute device, such as an analytics server, configured to evaluate rule groups, promote records between states, and execute operations associated with state transitions.

At operation 2310, the analytics server generates a record associated with a user identifier in a state store. The record is initialized in a seed state and associated with one or more rule groups indicated by a seed state definition. Each rule group may include a plurality of conditions associated with user attributes, such as demographic tags, behavioral indicators, or contextual metadata.

At operation 2320, the analytics server determines that the record satisfies a transition condition defined in a rule group of the seed state definition. The analytics server compares one or more values of contextual metadata associated with the record against one or more condition thresholds defined in the rule group. The orchestration engine may apply rule evaluation logic to determine eligibility for state transition, including compound condition evaluation using cached matched data.

At operation 2330, the analytics server selects, from a plurality of state definitions, a next state corresponding to a next state definition that includes the rule group having the satisfied transition condition. The next state may be selected based on a matched condition, a time delay, or a user action. The orchestration engine may perform state promotion based on streaming event data received from one or more data stream devices.

At operation 2340, the analytics server transitions the record from the seed state to the next state. The transition may be executed by a state transition engine and may include updating the state store and propagating context data associated with the transition. The orchestration engine may support transitions across both programmatic and non-programmatic delivery channels.

At operation 2350, the analytics server executes one or more executable operations associated with the next state using the record associated with the user identifier. These operations may include updating a user profile, sending a message, or modifying a segment membership. The orchestration engine may publish segment membership updates to a segment update stream and may convert segment memberships into programmatic audience definitions. In some embodiments, the orchestration engine may execute operations referencing tags generated from user activity.

### User Data Enrichment via Multi-Source Attribute Linking

FIG. 24 illustrates a system 2400 for generating enriched user records by linking attributes from multiple data sources to a user identifier, according to embodiments. The system 2400 includes an analytics server 2401, one or more upload data sources 2414, and an attribute datastore 2416. The analytics server 2401 may include a data ingestion engine 2402, UID-based linkage engine 2404, enrichment datastore interface 2406, attribute retrieval pipeline 2408, composite profile generator 2410, and privacy compliance engine 2412. The analytics server 2401 may be implemented using the same or similar computing infrastructure as the analytics server 108 of FIG. 1 and the analytics server 1101 of FIG. 11. The system 2400 enables privacy-compliant enrichment operations by linking, rather than merging, third-party attributes to user identifiers, and supports downstream personalization, segmentation, and analytics.

The analytics server 2401 includes software and hardware components configured to execute enrichment operations. These operations may include receiving uploaded data, linking identifiers to third-party attributes, retrieving enrichment data, generating composite profiles, and applying privacy controls. In some embodiments, the enrichment engine 1108 of FIG. 11 may implement the enrichment logic described in FIG. 24. The analytics server 2401 may also interact with orchestration components such as the state-based orchestration engine 1106 of FIG. 11 and the identity engine 818 of FIG. 8 and executed by the analytics server 102 of FIG. 1 to support unified user profiling across programmatic and non-programmatic channels.

The upload data sources 2414 include computing systems configured to transmit user data to the analytics server 2401. These sources may include advertiser-controlled systems, CRM platforms, or third-party data providers. Data may be transmitted via batch upload, API, or streaming protocols. Input data may include hashed email addresses, device identifiers, derived user identifiers (DUIDs), or other forms of user identifiers. These identifiers may be consistent with those used in an identity data structure (e.g., database table, key-value store) for mapping or linking heterogenous user identifiers from disparate data sources to a unified identifier as described in FIG. 8.

The data ingestion engine 2402 of the analytics server 2401 includes software routines for receiving and processing uploaded data. The data ingestion engine 2402 may parse and validate input records, extract user identifiers, and prepare the data for inclusion into one or more databases (e.g., user database, identity data structure). This ingestion process may be coordinated with the event ingestion engine 1204 of FIG. 12, particularly when enrichment operations are triggered by external events.

The UID-based linkage engine 2404 includes software routines for linking user identifiers from uploaded data to corresponding records in the attribute datastore 2416. The linkage engine may apply deterministic matching logic and support time-bound linkage rules to maintain privacy compliance. These linkage operations may be coordinated with the identity resolution logic described and the UID-based linkage function of the identity engine 818 of FIG. 8.

The enrichment datastore interface 2406 includes software routines for querying the attribute datastore 2416. The attribute datastore 2416 may include records indexed by UID, email, or other identifiers and may support query operations for retrieving enrichment attributes. Attributes may include demographic data (e.g., job title, company name), behavioral indicators (e.g., purchase intent), and contextual metadata (e.g., location, industry vertical). The enrichment store interface 2406 may be implemented using the enrichment engine 1108 of FIG. 11.

The attribute retrieval pipeline 2408 orchestrates the retrieval of enrichment attributes. This pipeline may apply filtering logic, deduplication routines, and prioritization rules to construct a consistent attribute set for each linked record. The pipeline may operate asynchronously and may be triggered by data uploads, segment refreshes, or external directives. These operations may be coordinated with the trigger execution engine 1210 of FIG. 12 when enrichment is part of a broader orchestration flow.

The composite profile generator 2410 generates enriched user profiles by combining the user identifier with the retrieved attributes. These profiles may be formatted into a flexible key-value schema and stored in a segment store or user store. The composite profile generator 2410 may operate in coordination with the personalization engine 1110 of FIG. 11 and the audience builder operations described in FIG. 9.

The privacy compliance engine 2412 enforces privacy constraints during enrichment operations. This engine may suppress retrieval of sensitive attributes, apply time-bound linkage logic, and log enrichment activity for audit purposes. The privacy compliance engine 2412 may operate in coordination with the logging engine 1212 of FIG. 12 and the identity data structure of FIG. 8.

In some embodiments, the analytics server 2401 may expose an enrichment API that allows external systems to submit user identifiers and receive enriched records. The API may support synchronous and asynchronous modes and include parameters for specifying data sources, attribute types, and identifier mapping data or thresholds. The analytics server 2401 may also publish enrichment events to a message queue or event stream, enabling real-time integration with personalization engines, audience builders, and orchestration workflows, such as those in FIG. 6 and FIG. 20.

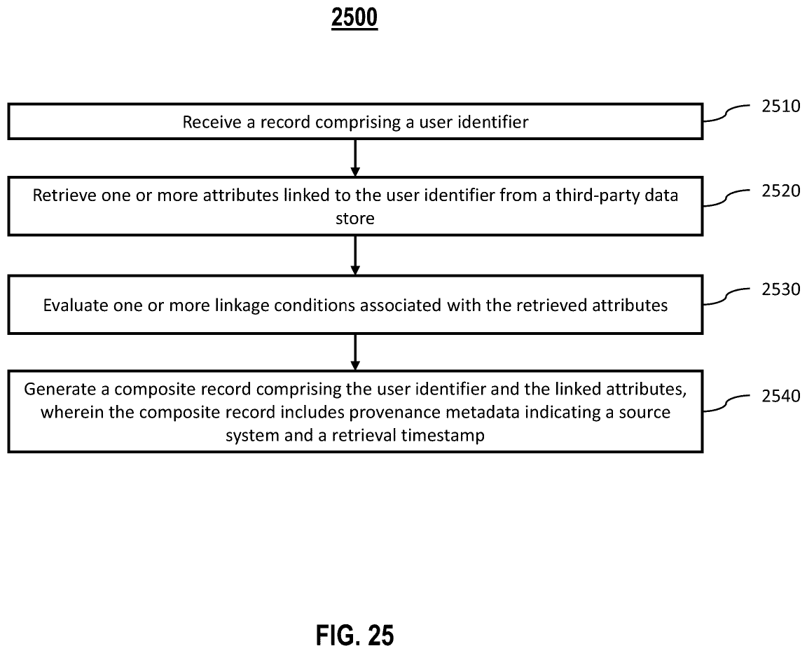

FIG. 25 shows operations of a computer-implemented method 2500 for enriching user data using linked attributes, according to embodiments. The method 2500 may be executed by an enrichment engine of a computing device, such as an analytics server, configured to retrieve third-party attributes, evaluate linkage conditions, and generate composite records for downstream personalization and segmentation.

At operation 2510, the analytics server receives a record comprising a user identifier. The user identifier may include an email address, a hashed identifier, platform-specific identifier of a third-party data source, or other form of user identifier. In some embodiments, the record is received via a batch pipeline triggered by a user data upload to a data hub.

At operation 2520, the analytics server retrieves one or more attributes linked to the user identifier from a third-party data store. The linked attributes may include a job title, a company name, a job function, and behavioral indicators such as purchase intent or engagement history. The enrichment engine may support linking a plurality of attributes from multiple enrichment stores via a common identifier.

At operation 2530, the analytics server evaluates one or more linkage conditions associated with the retrieved attributes. The linkage conditions may include a recency threshold, a confidence score, and a time-bound linkage rule to determine attribute eligibility. The enrichment engine may apply privacy-compliant logic to suppress retrieval of sensitive attributes or enforce TTL-based expiry.

At operation 2540, the analytics server generates a composite record comprising the user identifier and the linked attributes. The composite record includes provenance metadata indicating a source system and a retrieval timestamp. The composite record may be stored in a segment store configured to support TTL-based expiry and may be used by a personalization engine or audience segmentation engine. In some embodiments, the enrichment engine publishes one or more enrichment events to a message queue device for downstream orchestration.

### Combinational Personalization and DCO

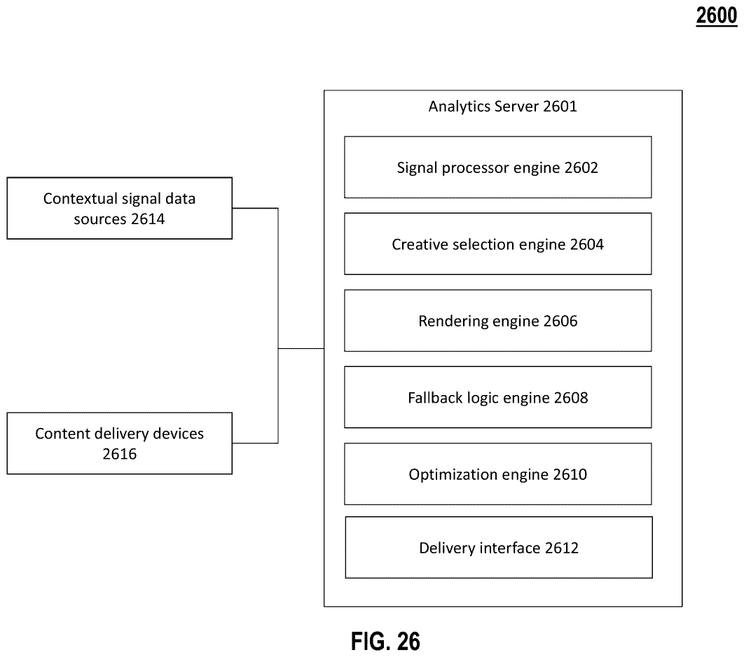

FIG. 26 shows dataflow amongst components of a system 2600 for combinational personalization of content delivery and dynamic creative optimization (DCO), according to embodiments. The system 2600 includes an analytics server 2601, contextual signal sources 2614 (e.g., weather API, time-of-day service), and content delivery devices 2618. The analytics server 2601 includes a signal processor 2602, creative selection engine 2604, rendering engine 2606, fallback logic engine 2608, an optimization engine 2610, and delivery interface 2612. The system 2600 may be configured to select and generate personalized creatives based on a combination of user-specific signals, situational signals, and global signals, and to deliver such creatives across programmatic and non-programmatic channels.

The analytics server 2601 includes a computing device (e.g., an analytics server 108 of FIG. 1 or an analytics server 1101 of FIG. 11) having one or more processors and non-transitory machine-readable storage media. The analytics server 2601 may execute software routines for receiving contextual signals, selecting creative components, rendering personalized content, applying fallback logic, optimizing delivery parameters, and transmitting content to one or more content delivery devices 2618. The analytics server 2601 may include or invoke a personalization engine (e.g., personalization engine 1110 of FIG. 11) for executing DCO operations. Structural variants may include containerized microservices, serverless functions, or monolithic deployments. Input data types may include JSON-formatted signal payloads, user identifiers, campaign metadata, and creative templates. Output data types may include rendered creatives, delivery instructions, and performance logs.

The signal processor 2602 includes software programming routines for receiving and processing contextual signals from one or more contextual signal sources 2614. The signal processor 2602 may normalize and classify signals such as weather conditions, time-of-day, user-specific attributes, or global market trends. Structural variants may include real-time stream processors (e.g., Apache Flink), batch processors, or edge computing nodes. Input data types may include timestamped sensor readings, API responses, or telemetry events. Output data types may include normalized signal vectors, classification tags, and signal confidence scores.

The creative selection engine 2604 includes software programming routines for selecting one or more creative components based on the contextual signals received by the signal processor 2602. The creative selection engine 2604 may apply rule-based logic, decision trees, or machine learning models (e.g., gradient boosting, neural networks) to determine which creative elements are most relevant to a given user context. Structural variants may include embedded inference engines, external model-serving APIs, or rule evaluation engines. Input data types may include signal vectors, user segmentation tags, and creative metadata. Output data types may include selected creative component identifiers, variant scores, and fallback flags.

The rendering engine 2606 includes software programming routines for generating a personalized creative by assembling selected creative components. The rendering engine 2606 may resolve placeholders in a creative template using selected content and may output a fully composed creative for delivery. Structural variants may include template engines (e.g., Mustache, Liquid), HTML/CSS renderers, or image composition services. Input data types may include creative templates, selected content elements, and layout rules. Output data types may include HTML creatives, AMP emails, image files, or JSON payloads for downstream delivery.

The fallback logic engine 2608 includes software programming routines for selecting default creative components when contextual signals are unavailable or incomplete. The fallback logic engine 2608 may enforce business rules or compliance constraints to ensure that a valid creative is always rendered. Structural variants may include rule-based fallback selectors, randomized fallback generators, or suppression logic modules. Input data types may include signal availability flags, creative eligibility rules, and user opt-out preferences. Output data types may include fallback creative identifiers and override instructions.

The optimization engine 2610 includes software programming routines for adjusting delivery parameters based on performance metrics, user engagement, or delivery constraints. The optimization engine 2610 may suppress delivery to low-propensity users, prioritize high-performing creatives, or adjust frequency caps. Structural variants may include real-time scoring engines, campaign pacing controllers, or bid suppression modules. Input data types may include historical engagement logs, bid response data, and campaign pacing metrics. Output data types may include delivery weights, suppression flags, and frequency control tokens.

The delivery interface 2612 includes software programming routines for transmitting rendered creatives to one or more content delivery devices 2618. The delivery interface 2612 may support synchronous protocols (e.g., HTTP POST, gRPC) and asynchronous protocols (e.g., poll-based queuing service, push-based notification service). Structural variants may include API gateways, message brokers, or edge delivery agents. Input data types may include rendered creative payloads, delivery metadata (e.g., recipient ID, channel type), and scheduling instructions. Output data types may include delivery acknowledgments, error codes, and engagement telemetry.

The contextual signal sources 2614 (e.g., weather API, time-of-day service) include one or more external computing systems configured to provide real-time or near-real-time contextual data. These sources may expose APIs, publish data streams, or push events to the analytics server 2601. Structural variants may include third-party data providers, internal telemetry services, or federated signal aggregators. Input data types may include XML, JSON, or proprietary binary formats. Output data types may include signal payloads, timestamps, and location metadata.

A creative asset datastore 2616 includes a structured data store containing creative components, templates, and metadata. The creative asset datastore 2616 may be implemented using a relational database (e.g., PostgreSQL), a document store (e.g., MongoDB), or a cloud-native object store (e.g., Amazon S3). Stored data types may include creative IDs, template markup, image URLs, localization variants, and targeting metadata. The creative selection engine 2604 and the rendering engine 2606 may query the creative asset datastore 2616 using indexed lookups or semantic search.

The content delivery devices 2618 (e.g., ad server, email server) include one or more computing systems configured to deliver personalized creatives to end users. These devices may include programmatic ad servers, email delivery platforms, SMS gateways, or push notification services. Structural variants may include cloud-hosted delivery platforms, edge delivery nodes, or on-premise servers. Input data types may include creative payloads, recipient identifiers, and delivery instructions. Output data types may include delivery confirmations, bounce reports, open/click telemetry, and downstream conversion signals.

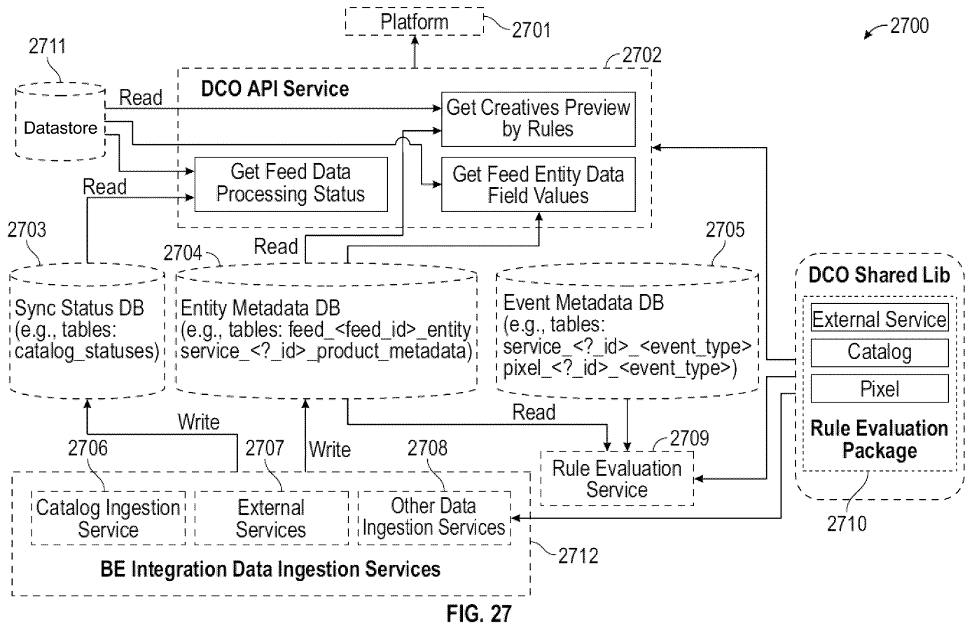

FIG. 27 shows dataflow amongst components of a system 2700 for content personalization, according to embodiments. The system 2700 includes a platform 2701, a DCO API service 2702, a sync status database 2703, an entity metadata database 2704, an event metadata database 2705, a catalog ingestion service 2706, external computing services 2707, other data ingestion services 2708, a rule evaluation service 2709, a rule evaluation package 2710, a datastore 2711, and BE integration data ingestion services 2712.

The platform 2701 may include one or more computing devices configured to transmit API requests to the DCO API service 2702 and receive structured responses for display to customer-users. In some embodiments, the platform 2701 may operate in coordination with orchestration components described in FIG. 6 and FIG. 20, where user-facing interfaces trigger backend personalization and rule evaluation operations.

The DCO API service 2702 may serve as a gateway layer for accessing backend services and databases. The DCO API service 2702 may invoke rule evaluation logic from the rule evaluation package 2710, which may be shared across the rule evaluation service 2709 and personalization engine 1110 of FIG. 11. The DCO API service 2702 may also query feed metadata from the entity metadata database 2704 and event metadata database 2705, which may correspond to the product catalog database 1414 and event stream source device 1416 of FIG. 14.

The sync status database 2703 may store metadata indicating the last processed timestamp, error messages, and completion status for each feed. In some embodiments, the sync status database 2703 may be queried by the DCO API service 2702 to retrieve processing status for catalog-based feeds or feeds sourced from public URLs. These operations may be coordinated with the sync lifecycle management described in FIG. 15 and FIG. 16.

The entity metadata database 2704 includes a structured data store configured to persist feed entity data used for personalization and rule evaluation. The entity metadata database 2704 may store product-level attributes, catalog metadata, and entity identifiers associated with one or more feed sources. In some embodiments, the entity metadata database 2704 may be queried by the DCO API service 2702 to retrieve entity attributes for previewing DCO creatives, or by the rule evaluation service 2709 to evaluate filtering conditions for rule-based personalization. The entity metadata database 2704 may correspond to the product catalog database 1414 described in FIG. 14 and may support the catalog ingestion operations shown in FIG. 15 and FIG. 17. The entity metadata database 2704 may also be accessed by the personalization engine 1110 of FIG. 11 to resolve creative placeholders using catalog-derived values and may operate in coordination with source pods 112 of FIG. 1 when ingesting external product data.

The event metadata database 2705 includes a structured data store configured to persist event-level data associated with user interactions, system signals, and external sources. The event metadata database 2705 may store records representing behavioral events such as product views, cart additions, purchases, or other tracked activities. These records may originate from integrations with commerce platforms, pixel-based tracking systems, or other external data sources. In some embodiments, the event metadata database 2705 may be queried by the rule evaluation service 2709 to evaluate conditions based on user behavior, or by the DCO API service 2702 to retrieve contextual signals for previewing personalized creatives. The event metadata database 2705 may correspond to the behavioral event stream sources described in FIG. 14 and may support the correlation and enrichment operations described in FIG. 17 and FIG. 24.

The BE integration data ingestion services 2712 include a set of backend services configured to perform scheduled ingestion jobs for feed entity data and feed event data. These services may operate asynchronously and may write to the entity metadata database 2704, the event metadata database 2705, or the sync status database 2703. The ingestion services 2712 may be responsible for orchestrating data refreshes, managing ingestion pipelines, and coordinating with external systems to retrieve updated feed content. These services may correspond to the ingestion and synchronization operations described in FIG. 15, FIG. 16, and FIG. 17.

The catalog ingestion service 2706 includes one or more backend services configured to receive structured product data from external computing services, such as a commerce computing service, and prepare that data for use in personalization and rule evaluation. The catalog ingestion service 2706 may parse incoming product feeds, apply schema normalization, and store the resulting entity records in the entity metadata database 2704. In some embodiments, the catalog ingestion service 2706 may operate in coordination with the BE integration data ingestion services 2712 to schedule and execute ingestion jobs. These operations may correspond to the feed synchronization and normalization processes described in FIG. 15 and FIG. 17 and may support the personalization engine 1110 of FIG. 11 by supplying catalog metadata used to resolve creative placeholders.

The external computing service ingestion layer 2707 includes one or more backend services configured to retrieve product metadata and behavioral event data from external computing services, such as commerce computing services. These services may support integrations with third-party platforms that expose product catalogs, user interaction logs, or other structured and semi-structured data. The external computing service ingestion layer 2707 may normalize incoming data and transmit the incoming data to the entity metadata database 2704 or the event metadata database 2705 for downstream use in rule evaluation and personalization.

The other data ingestion services 2708 include backend components configured to ingest entity and event data from sources other than commerce computing services. These sources may include user-uploaded files, public URLs, or pixel-based tracking systems. The ingestion services 2708 may apply schema mapping and transformation logic to harmonize incoming data formats and store the resulting records in the appropriate metadata databases. These services may operate in coordination with the catalog ingestion service 2706 and the BE integration data ingestion services 2712.

The rule evaluation service 2709 includes one or more computing devices configured to execute rule evaluation logic for content personalization. The rule evaluation service 2709 may evaluate filtering conditions, attribute constraints, or other rule definitions based on entity and event data stored in the metadata databases. In some embodiments, the rule evaluation service 2709 may operate in coordination with the personalization engine 1110 of FIG. 11 and the orchestration logic described in FIG. 6 and FIG. 20.

The rule evaluation package 2710 includes reusable software modules that implement rule evaluation logic for different types of feed sources. These modules may support evaluation of rules defined over catalog-based data, pixel-derived signals, or data from external computing services. The rule evaluation package 2710 may be invoked by both the rule evaluation service 2709 and the DCO API service 2702, and may support previewing personalized creatives, validating rule syntax, and resolving placeholder values.

The datastore 2711 includes a distributed database infrastructure configured to store feed metadata and support high-throughput queries. The datastore 2711 may be queried to resolve feed entity types, retrieve field mappings, and access feed-level configuration data. In some embodiments, the datastore 2711 may support abstraction logic for resolving the underlying data source associated with a feed identifier and may operate in coordination with the DCO API service 2702 and the BE integration data ingestion services 2712.

System 2700 beneficially enables centralized access to feed metadata, rule evaluation logic, and processing status across heterogeneous data sources. The system supports extensible integration with a catalog, ecommerce platform service, and pixel-based feeds, and provides a unified API layer for frontend consumption of DCO-related metadata. System 2700 may operate in coordination with the personalization and rendering components of system 2800 shown in FIG. 28, and may support orchestration logic described in FIG. 6, FIG. 20, and FIG. 22.

FIG. 28 shows dataflow amongst components of a system 2800 for combinational personalization and dynamic creative optimization (DCO), according to embodiments. The system 2800 includes an analytics system 2801, a data source feed 2820, and a campaign data inventory 2822. The analytics system 2801 may be implemented using one or more computing devices comprising processors and non-transitory machine-readable storage media and may include or invoke components described in FIG. 1 (e.g., analytics server 108), FIG. 11 (e.g., personalization engine 1110), and FIG. 6 (e.g., state management engine).

The analytics system 2801 includes source pods 2802, a DCO engine 2804, a DCO rules engine 2806, a DCO servicing and rendering engine 2808, a DCO creatives datastore 2810, a DCO template datastore 2812, a campaign datastore 2814, and a bidding engine 2816. The source pods 2802 may be implemented using the same or similar infrastructure as source pods 112 of FIG. 1 and source pods 1120 of FIG. 11. These source pods 2802 are configured to ingest and normalize contextual signals from the data source feed 2820, which may include user-specific attributes (e.g., behavioral history, segment membership), situational attributes (e.g., time of day, weather conditions), and global attributes (e.g., market trends, campaign performance metrics). The source pods 2802 may transmit matched condition messages to the analytics system 2801 via a condition update data stream, similar to condition update data stream 1116 of FIG. 11.

The DCO engine 2804 may invoke the personalization engine 1110 of FIG. 11 to evaluate contextual signals and select creative components for rendering. The DCO engine 2804 may apply rule-based logic, decision trees, or machine learning models to determine which creative elements are most relevant to a given user context. The DCO engine 2804 may retrieve creative metadata from the DCO creatives datastore 2810 and may query the DCO rules engine 2806 to evaluate placeholder resolution logic. The DCO rules engine 2806 may operate in coordination with the rule evaluation engine 1206 of FIG. 12 and the rule group evaluator 2004 of FIG. 20 to evaluate rule conditions associated with creative placeholders.

The DCO servicing and rendering engine 2808 may invoke rendering operations similar to those described in FIG. 7 and FIG. 11, and may assemble selected creative components into a personalized creative. The rendering engine 2808 may resolve placeholders using values returned by the DCO rules engine 2806 and may generate a final creative using a template retrieved from the DCO template datastore 2812. The rendering engine may support HTML, AMP, image, or JSON output formats and may transmit the rendered creative to a downstream delivery system, such as the email manager server 1122 of FIG. 11 or content delivery devices 2818 of FIG. 28.

The campaign datastore 2814 may store campaign metadata, including targeting parameters, pacing constraints, and performance metrics. The bidding engine 2816 may encode contextual metadata into bid responses and may generate DCO URLs for downstream rendering. These operations may be coordinated with the event orchestration engine 1102 of FIG. 11 and the trigger execution engine 1210 of FIG. 12.

The data source feed 2820 may include external or internal systems configured to provide contextual signals, such as weather APIs, time-of-day services, CRM systems, or telemetry services. The campaign data inventory 2822 may include a structured repository of available creatives, targeting rules, and delivery constraints, and may be queried by the DCO engine 2804 or the bidding engine 2816 during creative selection and delivery.

In some embodiments, the analytics system 2801 may apply fallback logic and optimization strategies, as described in FIG. 11 and FIG. 12. For example, the personalization engine 1110 may apply fallback logic when contextual inputs are unavailable or incomplete and may suppress delivery to low-propensity users based on historical engagement data. The analytics system 2801 may also log delivery outcomes and performance metrics to the analytics datastore 1114 of FIG. 11.

System 2800 beneficially enables real-time personalization across heterogeneous delivery channels by dynamically resolving creative placeholders using contextual inputs. The system supports extensible rule evaluation, fallback logic, and optimization strategies, and may operate in coordination with orchestration components described in FIG. 6, FIG. 20, and FIG. 22.

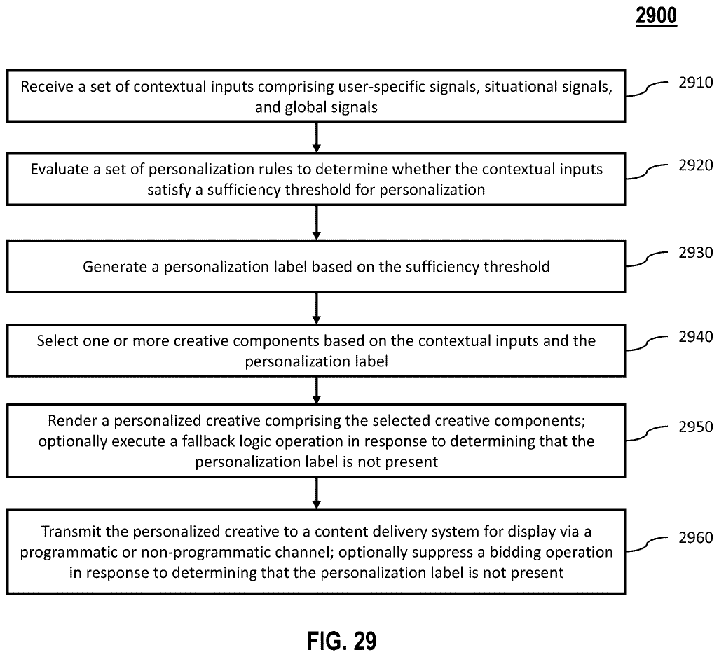

FIG. 29 shows operations of a computer-implemented method 2900 of generating personalized creatives using user-contextual inputs, according to embodiments. The method 2900 may be executed by a personalization engine and a rendering engine of a computer, such as an analytics server, configured to select and generate personalized creatives based on contextual signals.

At operation 2910, the analytics server receives a set of contextual inputs comprising user-specific signals, situational signals, and global signals. The user-specific signals may include a job title, a company name, and a recent product view. The situational signals may include a weather condition, a time-of-day value, and a geographic location. The global signals may include a market trend indicator and a campaign performance metric. The personalization engine may apply a rule set comprising user-specific, situational, and global conditions to evaluate the contextual inputs.

At operation 2920, the analytics server evaluates a set of personalization rules to determine whether the contextual inputs satisfy a sufficiency threshold for personalization. The sufficiency threshold may be defined by a rule set that includes minimum signal availability, recency, or relevance criteria.

At operation 2930, the analytics server generates a personalization label based on the sufficiency threshold. The personalization label may indicate whether the contextual inputs are sufficient to support personalized creative generation. The personalization label may be used to control fallback logic and bid suppression operations.

At operation 2940, the analytics server selects one or more creative components based on the contextual inputs and the personalization label. The personalization engine may use a machine learning model trained on engagement outcomes to select creative components. The model may evaluate historical performance metrics, segment membership, and contextual relevance to optimize creative selection.

At operation 2950, the analytics server executes a rendering engine for rendering a personalized creative comprising the selected creative components. The rendering engine may resolve creative placeholders using contextual inputs and apply fallback logic when the personalization label is not present. The fallback logic may include selecting a default creative component from a predefined set stored in a creative asset datastore or suppressing delivery entirely.

At operation 2960, the analytics server transmits the personalized creative to a content delivery system for display via a programmatic or non-programmatic channel. The analytics server may execute a delivery interface that supports synchronous and asynchronous transmission protocols. The delivery interface suppresses bidding operations by omitting a bid request when the personalization label is not present. The analytics server may also store delivery metadata and performance metrics associated with the personalized creative in a stats database or analytics datastore for downstream analytics and optimization.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

Some non-limiting embodiments of the present disclosure are described herein in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open ended terms. Further, the phrase “based on” is intended to mean “based at least partially on” unless explicitly stated otherwise.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A system for programmatic and non-programmatic communication, comprising:
one or more processors configured to:
receive first activity data associated with a first set of messages communicated by a first device via a first channel, and second activity data associated with a second set of messages communicated by a second device via a second channel, wherein the first channel represents a programmatic channel and the second channel represents a non-programmatic channel;
extract a first set of feature vectors for each message of the first set of messages based on one or more first attributes of each message;
extract a second set of feature vectors for each message of the second set of messages based on one or more second attributes of each message, the one or more second attributes comprising a user identifier associated with each message of the second set of messages;
generate a correlation value based upon comparing a first feature vector from the first set of feature vectors with a second feature vector from the second set of feature vectors, the correlation value indicating a probability that a first message corresponding to the first feature vector is associated with a second message corresponding to the second feature vector; and
generate and transmit display data for display via a graphical user interface (GUI) of at least one of the first device or the second device based on the correlation value satisfying a user correlation threshold.

2. The system of claim 1, wherein the one or more processors are further configured to determine that the correlation value satisfies the user correlation threshold, the user correlation threshold indicating that the first device and the second device are associated with a user corresponding to the user identifier.

3. The system of claim 1, wherein messages communicated over at least one of the first channel or the second channel includes identifying information associated with a user.

4. The system of claim 1, wherein the one or more processors is configured to receive the first activity data during a first period of time, and receive the second activity data during a second period of time.

5. The system of claim 1, wherein the one or more processors are further configured to determine that the first message was transmitted by the first device before the second message was transmitted by the second device; and
wherein the one or more processors are configured to compare the first feature vector with the second feature vector in response to determining that the first message was transmitted by the first device before the second message was transmitted by the second device.

6. The system of claim 1, wherein when comparing the first feature vector to the second feature vector, the one or more processors are configured to:
determine one or more correlations between the first message and the second message based upon comparing a first set of first feature values of the first feature vector with a second set of second feature values of the second feature vector; and
determine at least one match between the first set of first feature values and the second set of second feature values.

7. The system of claim 1, wherein the one or more processors are further configured to:
determine a context for the first message based on the one or more first attributes of the first message; and
generate the display data for the GUI based on the context for the first message.

8. A computer-implemented method for programmatic and non-programmatic communication, comprising:
receiving, by one or more processors, first activity data associated with a first set of messages communicated by a first device via a first channel, and second activity data associated with a second set of messages communicated by a second device via a second channel, wherein the first channel represents a programmatic channel and the second channel represents a non-programmatic channel;
extracting, by the one or more processors, a first set of feature vectors for each message of the first set of messages based on one or more first attributes of each message;
extracting, by the one or more processors, a second set of feature vectors for each message of the second set of messages based on one or more second attributes of each message, the one or more second attributes comprising a user identifier associated with each message of the second set of messages;
generating, by the one or more processors, a correlation value based upon comparing a first feature vector from the first set of feature vectors with a second feature vector from the second set of feature vectors, the correlation value indicating a probability that a first message corresponding to the first feature vector is associated with a second message corresponding to the second feature vector; and
generating and transmitting, by the one or more processors, display data for display via a graphical user interface (GUI) of at least one of the first device or the second device based on the correlation value satisfying a user correlation threshold.

9. The computer-implemented method of claim 8, further comprising:
determining that the correlation value satisfies the user correlation threshold, the user correlation threshold indicating that the first device and the second device are associated with a user corresponding to the user identifier.

10. The computer-implemented method of claim 8, wherein messages communicated over at least one of the first channel or the second channel include identifying information associated with a user.

11. The computer-implemented method of claim 8, wherein the one or more processors receives the first activity data during a first period of time, and receives the second activity data during a second period of time.

12. The computer-implemented method of claim 8, further comprising determining, by the one or more processors, that the first message was transmitted by the first device before the second message was transmitted by the second device,
wherein the one or more processors compares the first feature vector with the second feature vector in response to determining that the first message was transmitted before the second message.

13. The computer-implemented method of claim 8, wherein comparing the first feature vector to the second feature vector comprises:
determining, by the one or more processors, one or more correlations between the first message and the second message based upon a first set of first feature values of the first feature vector with a second set of second feature values of the second feature vector; and
determining, by the one or more processors, at least one match between the first set of first feature values and the second set of second feature values.

14. The computer-implemented method of claim 8, further comprising:
determining, by the one or more processors, a context for the first message based on the one or more first attributes of the first message; and
generating, by the one or more processors, the display data for the GUI based on the context for the first message.

15. A non-transitory, computer-readable medium storing instructions thereon for programmatic and non-programmatic communication that, when executed by one or more processors, cause the one or more processors to:
receive first activity data associated with a first set of messages communicated by a first device via a first channel, and second activity data associated with a second set of messages communicated by a second device via a second channel, wherein the first channel represents a programmatic channel and the second channel represents a non-programmatic channel;
extract a first set of feature vectors for each message of the first set of messages based on one or more first attributes of each message;
extract a second set of feature vectors for each message of the second set of messages based on one or more second attributes of each message, the one or more second attributes comprising a user identifier associated with each message of the second set of messages;
generate a correlation value based upon comparing a first feature vector from the first set of feature vectors with a second feature vector from the second set of feature vectors, the correlation value indicating a probability that a first message corresponding to the first feature vector is associated with a second message corresponding to the second feature vector; and
generate and transmit display data for display via a graphical user interface (GUI) of at least one of the first device or the second device based on the correlation value satisfying a user correlation threshold.

16. The non-transitory, computer-readable medium of claim 15, wherein the instructions further cause the one or more processors to determine that the correlation value satisfies the user correlation threshold, the user correlation threshold indicating that the first device and the second device are associated with a user corresponding to the user identifier.

17. The non-transitory, computer-readable medium of claim 15, wherein messages communicated over at least one of the first channel or the second channel include identifying information associated with a user.

18. The non-transitory, computer-readable medium of claim 15, wherein the instructions that cause the one or more processors to receive the first activity data and the second activity data cause the one or more processors to receive the first activity data during a first period of time, and receive the second activity data during a second period of time.

19. The non-transitory, computer-readable medium of claim 15, wherein the instructions further cause the one or more processors to determine that the first message was transmitted by the first device before the second message was transmitted by the second device, and wherein the one or more processors compare the first feature vector with the second feature vector in response to determining that the first message was transmitted before the second message.

20. The non-transitory, computer-readable medium of claim 15, wherein the instructions that cause the one or more processors to compare the first feature vector to the second feature vector cause the one or more processors to:
determine one or more correlations between the first message and the second message based upon comparing a first set of first feature values of the first feature vector with a second set of second feature values of the second feature vector; and
determine at least one match between the first set of first feature values and the second set of second feature values.

21-82. (canceled)
